(19) United States
(12) Patent Application Publication
(10) Pub. No.: US 2024/0051272 A1
(43) Pub. Date: Feb. 15, 2024

(54) LAMINATED STRUCTURES WITH COMPOSITE ADHESIVE POLYMERIC INTERLAYER COMPRISING COHESIVE DEBONDING ZONES FOR ENHANCED PERFORMANCE

(71) Applicant: KURARAY EUROPE GMBH, Hattersheim (DE)

(72) Inventors: Charles Anthony Smith, Vienna, WV (US); Stephen John BENNISON, Wilmington, DE (US)

(73) Assignee: KURARAY EUROPE GMBH, Hattersheim (DE)

(21) Appl. No.: 18/267,533

(22) PCT Filed: Nov. 24, 2021
(86) PCT No.: PCT/US2021/060814

§ 371 Date: Jun. 15, 2023

Related U.S. Application Data
(60) Provisional application No. 63/126,135, filed on Dec. 16, 2020.
(60) Provisional application No. 63/191,518, filed on May 21, 2021.
(60) Provisional application No. 63/191,447, filed on May 21, 2021.
(60) Provisional application No. 63/155,009, filed on Mar. 1, 2021.
(60) Provisional application No. 63/191,486, filed on May 21, 2021.
(60) Provisional application No. 63/191,545, filed on May 21, 2021.
(60) Provisional application No. 63/191,557, filed on May 21, 2021.

(51) Int. Cl. B32B 17/10; B32B 7/05; B32B 7/10; B32B 7/022; B32B 7/027

(52) U.S. Cl. CPC B32B 17/10761; B32B 7/05; B32B 7/10; B32B 17/10688; B32B 7/022; B32B 7/027; B32B 2307/72; B32B 2307/704; B32B 2307/30; B32B 2307/558

(57) ABSTRACT

The present invention relates to a laminate structure comprising a composite adhesive polymeric interlayer (CAPI) comprising at least two layers: (i) a submicron-thick superbonding layer and/or a top adhesive polymeric interlayer (TAPI) and (ii) a bulk adhesive polymeric interlayer (BAPI). If the TAPI is present, it comprises cohesive substantially discrete and/or continuous debonding zones. Such debonding zones are located preferably within the 10% thickness of CAPI from the interface of said CAPI and the glass substrate. These zones allow for a unique combination of modified API-glass debonding, laminate toughness, and laminate durability. Various spatial patterns and densities of debonding are described, as well as the resulting material properties.

### CROSS REFERENCE TO RELATED APPLICATIONS

This application claims the benefit of U.S. Provisional Application No. 63/126,135, filed Dec. 16, 2020, U.S. Provisional Application No. 63/155,009, filed Mar. 1, 2021, U.S. Provisional Application No. 63/191,486, filed May 21, 2021, U.S. Provisional Application No. 63/191,447, filed May 21, 2021, U.S. Provisional Application No. 63/191,518, filed May 21, 2021, U.S. Provisional Application No. 63/191,545, filed May 21, 2021, and U.S. Provisional Application No. 63/191,577, filed May 21, 2021, the entireties of which are incorporated herein for any and all purposes.

### FIELD OF THE INVENTION

The present invention relates to rigid substrate-laminates comprising polymeric interlayers that provide enhanced properties to rigid substrates using controlled debonding zone treatments.

### BACKGROUND OF THE INVENTION

Laminated glass is generally made by laminating two pieces of glass onto a polymeric interlayer (FIG. 1). One particular advantage of laminated glass versus solid glass sheets is impact and shatter resistance due to adhesion of the glass to the interlayer sheet.

In safety glass laminates, optimal adhesion of the interlayer to glass is a balance. Too much adhesion detracts from the ability of the laminate to absorb and dissipate energy during an impact event, and too little adhesion can result in optical defects (at the time of lamination and later upon environmental exposure and weathering), and can also detrimentally affect the ability of the interlayer to retain glass shards on impact.

Many publications disclose techniques for adjusting the adhesion between the interlayer and the glass substrate that enables the laminated structure to absorb and dissipate high energy events (e.g. impacts). For example, U.S. Pat. No. 3,607,178 describes washing the glass prior to lamination with water containing calcium and magnesium salts, and U.S. Pat. No. 4,292,372 describes incorporating calcium and/or magnesium carboxylates into the interlayer sheeting to reduce adhesion.

Many different materials have been used as the polymeric interlayer. For example, sheets containing a polyvinyl acetal, also known as polyvinyl butyral, and a plasticizer are widely utilized as an interlayer for laminated glass because they have excellent adhesion-to-glass properties. Laminated glass containing such interlayers can be made with good transparency, mechanical strength, flexibility, acoustic damping, and shatter resistance.

At least partially neutralized ethylene acid copolymers (ionomers) have also been used as interlayers for preparing laminated safety glass, for example, as disclosed in U.S. Pat. Nos. 3,404,134; 3,344,014; 7,445,683; 7,763,360; 7,951,865; 7,960,017; 8,399,097; 8,399,098; U.S. Pat. App. Pub. Nos. 2018/0117883, and 2019/0030863; Int. Pat. App. Nos. WO2016/076336A1; WO2016/076337A1; WO2016/076338A1; WO2016/076339A1; and WO2016/076340A1; and U.S. patent application Ser. No. 16/781,787.

While ionomer resins can be chosen to produce interlayers having excellent flexural strength and optical properties, the adhesion properties to glass may not be optimal. In particular, because ionomers are generally neutralized acid copolymers, they may develop lamination defects, particularly in high moisture environments.

For example, when using ionomer resins as interlayers for float glass, adhesion is often satisfactory on the “tin side” but not on the “air side” of the glass, so special precautions need to be taken into account during the lamination process to properly orient such glass sheets to ensure contact of the “tin side” to the interlayer.

Other resins can also be used as interlayers or portions of interlayers for float glass, including polyvinyl butyral and thermoplastic elastomers. These, too, can exhibit difficulties with adhesion, laminate toughness, and durability.

Patent references also discuss approaches on enhancing adhesion through the use of primers. For example, U.S. Pat. No. 3,445,423 discloses using a solution of gamma-aminopropyltriethoxysilane as a primer for bonding the outside marginal portion of a windshield to a metal receiving member using a polyurethane composition.

U.S. Pat. No. 3,881,043 discloses the application of an adhesion primer to the perimeter of a windshield to reduce the tendency for premature delamination. Another embodiment involves the application of the adhesion promoting composition to be applied in a pattern of dots throughout the extent of the interfacial surface to increase the overall magnitude of adhesion.

U.S. Pat. Nos. 5,342,653; 5,478,412; and 5,547,736 disclose a method of applying antiadhesion projections to the surface of the sheet to counteract the high adhesion of the sheet to glass between the projections. These projections are said to operate on a physical blocking of adhesion means and by preference, do not rely on chemical means.

U.S. Pat. No. 10,022,908 discloses application of a primer to the surface of the interlayer which raises the adhesion between the interlayer and glass surface and can provide increased adhesion retention under exposure to high humidity conditions.

U.S. Pat. No. 3,505,160 discloses the application of an adhesion reducing substance (“a poor adhesive”) in the interior portion of a windshield to increase the impact performance in a region where occupant impact could likely occur in an accident scenario.

U.S. Pat. App. Pub. No. 2019/0030863 discloses that a certain class of silanes can successfully and advantageously be used in very specific amounts and under limited conditions as glass adhesion promoters for sodium-neutralized ionomers, allowing the optimal use of such ionomers in the preparation of interlayers and glass laminates having enhanced interlayer-to-glass adhesion properties.

Most of the prior art involves approaches where the overall adhesion is monotonic across the laminate interface. Additionally, the combination of improved adhesion, laminate toughness, and laminate durability is not disclosed therein.

### SUMMARY OF THE INVENTION

The present invention addresses the above-described problems by providing a means where the integrity of the laminate prepared with the multi-modal bonding robustness of the interlayer/glass laminate assembly is improved while retaining adequate laminate integrity and durability but providing improved impact performance. This is carried out by providing a substantially cohesive discrete debonding region within the interlayer near the glass substrate.

In the description below, fluorinated-ethylene-propylene (FEP) is used as an example of the substantially cohesive discrete regions that form the debonding zone.

In one embodiment, this invention relates to a composite adhesive polymeric interlayer (CAPI) comprising:
(I) a first stack comprising a first top adhesive polymeric interlayer (TAPI) and a bulk adhesive polymeric interlayer (BAPI) adhered to each other; or
(II) a second stack comprising a first a submicron-thick superbonding layer and a BAPI adhered to each other; or
(III) a third stack comprising a first submicron-thick superbonding layer, a first TAPI layer, and a BAPI; wherein the first submicron-thick superbonding layer adheres to the first TAPI layer on one side; the first TAPI layer adheres to the first superbonding layer on one side and the BAPI layer on the other side;
   wherein each of the CAPI, the TAPI, the BAPI and the sub-micron superbonding layer comprise a first surface and a second surface;
   wherein the TAPI comprises a first polymeric material and the BAPI comprises a second polymeric material;
   wherein the TAPI and/or the BAPI comprise discrete and/or continuous debonding zones; wherein, the first submicron-thick superbonding layer substantially covers the respective TAPI or the BAPI surface;
   wherein the cohesive debonding zones comprise a first debonding zone that is discrete or continuous and having a maximum mean peel strength;
   wherein the cohesive debonding zones comprise a second cohesive debonding zone that is discrete or continuous with a minimum mean peel strength greater than about 0.01 kJ/m²; and
   wherein the maximum mean peel strength is at least about 2 times greater than the minimum mean peel strength.

In another embodiment, this invention relates to the composite adhesive polymeric interlayer (CAPI) as recited in above, wherein:
the debonding zones are located within 10% thickness of the CAPI from the first and/or the second surface of the CAPI, and
the first debonding zone and the second debonding zone are within the 10% thickness of the API proximate to the first surface.

In yet another embodiment, this invention relates to the composite adhesive polymeric interlayer (CAPI) as recited in above, wherein one of the first or second debonding zones comprises the first polymeric material or the second polymeric material, and the other of the first and second debonding zones comprises a first material chemically and/or physically different from the first polymeric material and/or the second polymeric material.

In one embodiment, this invention relates to the composite adhesive polymeric interlayer (CAPI) as recited in above, wherein the first material is characterized by:
(i) a molecular weight different than that of the first polymeric material and/or the second polymeric material,
(ii) a crystallinity different than that of the first polymeric material and/or the second polymeric material,
(iii) a density different than that of the first polymeric material and/or the second polymeric material,
(iv) a glass transition temperature different than that of the first polymeric material and/or the second polymeric material,
(v) a melt flow index different than that of the first polymeric material and/or the second polymeric material,
(vi) a Young's modulus different than that of the first polymeric material and/or the second polymeric material, or
(vii) a combination of one or more of said characteristics.

In another embodiment, this invention relates to the composite adhesive polymeric interlayer (CAPI) as recited in above, wherein at least one of the first debonding zone and the second debonding zone is coplanar to the CAPI, the TAPI, or the BAPI.

In yet another embodiment, this invention relates to the composite adhesive polymeric interlayer (CAPI) as recited in above, wherein the first debonding zone and the second debonding zone are discrete, and are located in one plane or in more than one plane.

In one embodiment, this invention relates to the composite adhesive polymeric interlayer (CAPI) as recited in above, wherein the cohesive discrete debonding zones are distributed in an ordered pattern.

In another embodiment, this invention relates to the composite adhesive polymeric interlayer (CAPI) as recited in above, wherein the cohesive discrete debonding zones are distributed stochastically.

In yet another embodiment, this invention relates to the composite adhesive polymeric interlayer (CAPI) as recited in above, wherein at least one of the first debonding zone or the second debonding zone is characterized by:
(i) a regular shape,
(ii) a stochastic/random shape,
(iii) one-dimensional patterns, and/or
(iv) a cluster of regular, random, and/or one-dimensional patterns.

In one embodiment, this invention relates to the composite adhesive polymeric interlayer (CAPI) as recited in above, wherein the effective diameter of the regular shaped discrete debonding zone, the random shaped discrete debonding zone, or the cluster discrete zone is from about 1 multiple to about 150,000,000-multiples of the thickness of the discrete debonding zone.

In another embodiment, this invention relates to the composite adhesive polymeric interlayer (CAPI) as recited in above, wherein the weight content of one of said first and second debonding zones as a percentage of the total of the API is in the range of from about 0.00001% to about 30%.

In yet another embodiment, this invention relates to the composite adhesive polymeric interlayer (CAPI) as recited in above, wherein the first debonding zone with maximum mean peel strength has a mean peel strength that is from about 2 times to about 250 times greater than a mean peel strength of the second debonding zone with minimum mean peel strength.

In one embodiment, this invention relates to the composite adhesive polymeric interlayer (CAPI) as recited in above, wherein the API comprises at least two zones, wherein at least one of the zones has a mean peel strength of from about 0.01 to about 12.0 kJ/m².

In another embodiment, this invention relates to the composite adhesive polymeric interlayer (CAPI) as recited in above, wherein the first polymeric material or the second polymeric material comprises a polyvinylacetal, an ionomer, a thermoplastic elastomer, an ethyl vinylacetate, or combinations thereof.

In yet another embodiment, this invention relates to the composite adhesive polymeric interlayer (CAPI) as recited in above, wherein the first material comprises a polyvinylacetal, an ionomer, a thermoplastic elastomer, a silane, an ethyl vinylacetate, a fluoropolymer, a polyvinyl-alcohol, or combinations thereof.

In one embodiment, this invention relates to the composite adhesive polymeric interlayer (CAPI) as recited in above, wherein at least one of the cohesive debonding zones comprises the ionomer, wherein the ionomer resin is a sodium-neutralized ethylene-α,β-unsaturated carboxylic acid copolymer.

In another embodiment, this invention relates to the composite adhesive polymeric interlayer (CAPI) as recited in above, wherein the polyvinylacetal is a polyvinylbutyral.

In yet another embodiment, this invention relates to the composite adhesive polymeric interlayer (CAPI) as recited in above, wherein the second debonding zone is the first polymeric material or the second polymeric material, and the first polymeric material or the second polymeric material is an ionomer resin.

In one embodiment, this invention relates to the composite adhesive polymeric interlayer (CAPI) as recited in above, wherein the first debonding zone is the first polymeric material or the second polymeric material, and the first polymeric material or the second polymeric material is a polyvinylacetal.

In another embodiment, this invention relates to the composite adhesive polymeric interlayer (CAPI) as recited in above, wherein the first material is an adhesion modifying agent.

In yet another embodiment, this invention relates to the composite adhesive polymeric interlayer (CAPI) as recited in above, wherein the adhesion modifying agent is present in a range of from about 0.001% to about 75% by weight of the first polymeric material.

In one embodiment, this invention relates to the composite adhesive polymeric interlayer (CAPI) as recited in above, wherein one of the first or second debonding zones has a thickness of from about 0.001 mm to about 10.0 mm.

In another embodiment, this invention relates to the composite adhesive polymeric interlayer (CAPI) as recited in above, wherein the adhesion modifying agent is a silane, an alkali metal salt, an alkaline earth metal salt or a carboxylic group-containing olefinic polymer.

In yet another embodiment, this invention relates to the composite adhesive polymeric interlayer (CAPI) as recited in above, wherein the adhesion modifying agent is a silane.

In one embodiment, this invention relates to the composite adhesive polymeric interlayer (CAPI) as recited in above, wherein the adhesion modifying agent is present in a range of from about 0.001% to about 75% by weight of the first polymeric material.

In another embodiment, this invention relates to the composite adhesive polymeric interlayer (CAPI) as recited in above, wherein each discrete debonding zone is shaped as a dot, a circle, a partial circle, an oval, a partial oval, a triangle, a square, a rectangle, a pentagon, a hexagon; a heptagon, a polygon, or is amorphous shaped.

In yet another embodiment, this invention relates to the composite adhesive polymeric interlayer (CAPI) as recited in above, wherein an effective diameter of the discrete zone debonding is in a range of from about 0.1 mm to about 50 mm.

In one embodiment, this invention relates to the composite adhesive polymeric interlayer (CAPI) as recited in above, wherein the peel strength ratio of the zone with maximum peel strength (Zₘₐₓ) to the zone with the minimum peel strength (Zₘᵢₙ), that is, (Zₘₐₓ/Zₘᵢₙ) is greater than or equal to 5.

In another embodiment, this invention relates to the composite adhesive polymeric interlayer (CAPI) as recited in above, wherein:
all debonding zones have different peel strength;
one or more debonding zones have the same peel strength; or
one or more debonding zones have different peel strength.

In yet another embodiment, this invention relates to a laminate structure, comprising a stack of:
(i) a first rigid substrate; and
(ii) a composite adhesive polymeric interlayer as recited above;
   wherein the first rigid substrate adheres to the composite adhesive polymeric interlayer (CAPI).

In one embodiment, this invention relates to a laminate structure as described above, comprising a stack of:
(i) a first rigid substrate;
(ii) an adhesive polymeric interlayer as recited above; and
(iii) a second rigid substrate;
   wherein the first rigid substrate adheres to the second rigid substrate through the composite adhesive polymeric interlayer (CAPI).

In another embodiment, this invention relates to a laminate structure as described above, wherein at least one the first rigid substrate and the second rigid substrate is a glass substrate.

In yet another embodiment, this invention relates to a laminate structure as described above, wherein the discrete debonding zones have a surface area on one side that is:
(i) from about 1% to about 80% of the surface areas of one of the glass substrate;
(ii) from about 10% to about 60% of the surface areas of one of the glass substrate;
(iii) from about 20% to about 50% of one of the glass substrate;
(iv) from about 30% to about 40% of the surface areas of one of the glass substrate
(v) from about 5% to about 25% of the surface areas of one of the glass substrate; or
(vi) from about 1% to about 35% of the surface areas of one of the glass substrate.

In one embodiment, this invention relates to a laminate structure as described above, wherein the composite adhesive polymeric interlayer comprises at least two zones, wherein at least one of the zones has a mean peel strength of:
(i) from about 0.01 to about 12.0 kJ/m²;
(ii) from about 0.1 to about 4.0 kJ/m²;
(iii) from about 0.5 to about 3.0 kJ/m²;
(iv) from about 8.0 to about 12.0 kJ/m²; or
(v) from about 9.0 to about 11.0 kJ/m².

In yet another embodiment, this invention relates to a laminate structure as described above, wherein the composite adhesive polymeric interlayer (CAPI) comprises from 2 to 100 zones per cm².

In one embodiment, this invention relates to a laminate structure as described above, wherein the thicknesses on either side of the composite adhesive polymeric interlayer (CAPI) in which the cohesive debonding zones are located are independently from about 0.01% to about 10% of the total thickness of the API.

In another embodiment, this invention relates to a laminate structure as described above, wherein the first superbonding layer has a substantially higher adhesion to the rigid substrate than to the TAPI or the BAPI surface.

In yet another embodiment, this invention relates to a laminate structure as described above, wherein the first submicron-thick superbonding structure is in the range of 0.1% to 0.0001% of the weight of the API and

wherein the first submicron-thick superbonding structure is made from PVA.

Surprisingly, interlayer and laminate performance is enhanced by providing a debonding region within the composite adhesive polymeric interlayer (CAPI) near the interface of the composite adhesive polymeric interlayer and the glass substrate, which allows for controlled debonding, as exemplified by employing less adhesion-promoting material. Additionally, nonuniform, controlled adhesion produces unique combinations of debonding region-glass adhesion, laminate tear resistance, and laminate post-breakage durability. The enhanced performance is measured by different methods, including ball-on-ring, cyclic weathering, and other tests as described herein. The improved adhesion leads to improved durability of the laminates comprising such debonding regions.

Controlled debonding zone treatments (CDZT) have been found to allow further optimization of laminate performance characteristics; primarily laminate tear resistance at a given unit thickness of the debonding region at the interface of the glass and the CAPI within the CAPI compared with conventional art. The durability of laminates can also be optimized to balance aspects of laminate integrity with that of energy absorbing capability under impact or other extreme applied forces acting to breach the laminate.

The CDZT approach involves defining both a range and boundary limits for the energy required to effectuate a debonding ‘event’ at or near the interface between the debonding region and the top adhesive polymeric interlayer (TAPI) beneath the region in the TAPI. These boundary conditions would have at least a lower limit and an upper limit. Each lower and upper limit would be generated through the application of a treatment such that at least a bimodal or multi-modal adhesion level is created, wherein the cohesion/debonding characteristics are defined by the applied treatment. The CDZT technology has been found to provide superior laminate performance over that of the conventional art. This can be accomplished in various modes and possessing some or all of the characteristics listed herein.

The CDZT technology, while not wanting to be held to theory, in one aspect can be one of a chemical nature, not physical nature. A treatment can alternatively consist of the application of an energetic ‘beam’, such as electron beam, gamma, plasma, electron discharge, laser, ion-beam or other energetic means such as, plasma, flame-treatment, UV/VIS/IR radiation, microwaves or chemical alteration, via, coating techniques, chemical vapor deposition, and the like. Combinations of a chemical substance(s) with energetic sources can also be employed as a treatment. The treatment may be of an infinitesimally small dimension (i.e. only surface atomic or molecular monolayer affected by the treatment or the treatment may be of a finite thickness (approaching up to 30%) of the API layer thickness. The treatment may be applied to the rigid substrate.

Although the debonding zone treatments and/or cohesive treatments can be made to be invisible or nearly imperceptible so as to not interfere with the clarity and transparency of said laminate, these techniques can be combined with other features of the resulting laminate structure; these would not be limited to the creation of decorative, gradients, visible patterns, obscuration, tinting/coloration, alteration of transparency and reflectiveness (for example, creation of translucency or opaqueness), energy management, solar control, photovoltaic generation and passive and active systems.

The design of the applied treatment can be defined by various descriptors. The surface coverage (or volume fraction) is one aspect that can be adjusted to achieve a desired effect or outcome. The CZDT provides for enhanced laminate performance with respect to the energy level required to breach the laminate and/or the durability of the laminate to withstanding various harsh environmental factors (wide-temperature swings/exposures and high moistures) or imposed stress (flexure, dead or live loads, lamination stress, etc.). Additionally, it can provide improved robustness in performance over a broad range of manufacturing variations; such as, rigid substrate composition, substrate surface cleanliness (e.g. glass washing conditions), moisture conditions, improper lamination temperature and dwell time, etc.

These and other embodiments, features and advantages of the present invention will be more readily understood by those of ordinary skill in the art from a reading of the following detailed description and associated drawings.

### BRIEF DESCRIPTION OF THE DRAWINGS

FIG. 1 shows a standard laminate structure with two glass substrates and an interlayer.

FIG. 2 shows a schematic construction of the present invention with one glass substrate and a composite adhesive interlayer (CAPI) with the 10%-thickness regions comprising cohesive discrete debonding zones within the top adhesive interlayer (TAPI)

FIG. 3 shows a schematic construction of the present invention with two glass substrates and a composite adhesive interlayer (CAPI) with the 10%-thickness regions comprising cohesive discrete debonding zones within the top adhesive interlayer (TAPI).

FIG. 4 shows a schematic construction of the present invention with one glass substrate and a composite adhesive interlayer (CAPI) with the 10%-thickness regions comprising cohesive continuous debonding zones within the top adhesive interlayer (TAPI).

FIG. 5 shows a schematic construction of the present invention with two glass substrates and a composite adhesive interlayer (CAPI) with the 10%-thickness regions comprising cohesive continuous debonding zones within the top adhesive interlayer (TAPI).

FIG. 6 shows a schematic construction of the present invention with one glass substrate and a composite adhesive interlayer (CAPI) with the 10%-thickness regions comprising cohesive continuous debonding zones and a submicron-thick superbonding layer covering the bulk API.

FIG. 7 shows a schematic construction of the present invention with two glass substrates and a composite adhesive interlayer (CAPI) with the 10%-thickness regions comprising cohesive continuous debonding zones and a submicron-thick superbonding layer covering the bulk API.

FIG. 8 shows a schematic construction of the present invention with one glass substrate and a composite adhesive interlayer (CAPI) with the 10%-thickness regions comprising cohesive discrete debonding zones and a submicron-thick superbonding layer covering the bulk API.

FIG. 9 shows a schematic construction of the present invention with two glass substrates and a composite adhesive interlayer (CAPI) with the 10%-thickness regions comprising cohesive discrete debonding zones and a submicron-thick superbonding layer covering the bulk API.

FIG. 10 shows a schematic construction of the present invention with one glass substrate and a composite adhesive interlayer (CAPI) with the 10%-thickness regions comprising cohesive discrete debonding zones within the top adhesive interlayer (TAPI) with a submicron-thick superbonding layer covering the TAPI.

FIG. 11 shows a schematic construction of the present invention with two glass substrates and a composite adhesive interlayer (CAPI) with the 10%-thickness regions comprising cohesive discrete debonding zones within the top adhesive interlayer (TAPI) with a submicron-thick superbonding layer covering the TAPI.

FIG. 12 shows a schematic construction of the present invention with one glass substrate and a composite adhesive interlayer (CAPI) with the 10%-thickness regions comprising cohesive continuous debonding zones within the top adhesive interlayer (TAPI) with a submicron-thick superbonding layer covering the TAPI.

FIG. 13 shows a schematic construction of the present invention with two glass substrates and a composite adhesive interlayer (CAPI) with the 10%-thickness regions comprising cohesive continuous debonding zones within the top adhesive interlayer (TAPI) with a submicron-thick superbonding layer covering the TAPI.

FIG. 14 shows a schematic construction of the present invention with one glass substrate and a composite adhesive interlayer (CAPI) with the 10%-thickness regions comprising cohesive discrete and continuous debonding zones within the top adhesive interlayer (TAPI).

FIG. 15 shows a schematic construction of the present invention with two glass substrates and a composite adhesive interlayer (CAPI) with the 10%-thickness regions comprising cohesive discrete and continuous debonding zones within the top adhesive interlayer (TAPI).

FIG. 16 shows a schematic construction of the present invention with one glass substrate and a composite adhesive interlayer (CAPI) with the 10%-thickness regions comprising cohesive discrete and continuous debonding zones with a submicron-thick superbonding layer covering the bulk API.

FIG. 17 shows a schematic construction of the present invention with two glass substrates and a composite adhesive interlayer (CAPI) with the 10%-thickness regions comprising discrete and cohesive continuous debonding zones with a submicron-thick superbonding layer covering the bulk API.

FIG. 18 shows a schematic construction of the present invention with one glass substrate and a composite adhesive interlayer (CAPI) with the 10%-thickness regions comprising cohesive discrete and continuous debonding zones within the top adhesive interlayer (TAPI) with a submicron-thick superbonding layer covering the TAPI.

FIG. 19 shows a schematic construction of the present invention with two glass substrates and a composite adhesive interlayer (CAPI) with the 10%-thickness regions comprising cohesive discrete and continuous debonding zones within the top adhesive interlayer (TAPI) with a submicron-thick superbonding layer covering the TAPI.

FIG. 20 shows a typical peel strength measurement. With uniform adhesion control methods, a steady-state peel force is attained after an interfacial crack initiates.

FIG. 21 shows a typical load-displacement trace. The tear energy of the laminate, U_{T}, is defined as the area under the load-displacement curve up to the peak load, F* (δ*) at which a tear in the laminate initiates, U_{T}=∫₀^{δ*} F(δ).

FIG. 22 shows a ‘ball on ring’ apparatus used for the measurement of laminate tear energy.

### DETAILED DESCRIPTION OF THE INVENTION

In the ensuing disclosure, glass substrate has been used as an example of rigid substrate. Rigid substrate has been discussed infra in later sections.

The present invention relates to a laminate structure comprising at least one glass substrate and an adhesive polymeric interlayer (API) that comprises cohesive debonding zones that are substantially discrete and/or substantially continuous in their layout. Such debonding zones are located preferably within the 10% thickness of API from the interface of said API and the glass substrate. These zones allow for a unique combination of modified API-glass debonding, laminate toughness, and laminate durability. Also, a submicron-thick superbonding layer is attached to the API at the API-glass interface, such that the peel strength of the glass-superbonding layer is much higher than that of the superbonding layer to the API. In one embodiment, the API is a bi-layer composite, the top adhesive polymeric interlayer (TAPI) and the bulk adhesive polymeric interlayer. In case of the presence of the TAPI, the debonding zones substantially reside within the TAPI. In case of this bi-layer composite, the superbonding layer is attached to the TAPI.

Various spatial patterns and densities of debonding are described, as well as the resulting material properties.

### Definitions

API

By API, generally, is meant the adhesive polymeric interlayer. The API comprises a top adhesive interlayer (TAPI) and the bulk adhesive interlayer (BAPI) or the API comprises only the bulk or the base adhesive interlayer (BAPI).

BAPI

By BAPI, generally, is meant the bulk adhesive polymeric interlayer. The TAPI layer (see below) adheres at the top of the BAPI layer and is generally in between the BAPI and a glass substrate.

TAPI

TAPI refers to the top adhesive interlayer, which is different from the BAPI and the superbonding layer, and the debonding zones are substantially contained in the top adhesive polymeric interlayer (TAPI).

CAPI

By CAPI, generally, is meant a composite adhesive interlayer that comprises a stack of the superbonding layer, the TAPI layer, and the BAPI layer, in that order. Depending upon the context, the CAPI can also refer to a stack comprising only the TAPI and the BAPI, devoid of the superbonding layer. Also depending upon the context, the CAPI can also refer to a stack comprising the superbonding layer and the BAPI, devoid of the TAPI. In other words the CAPI comprises the BAPI and at least one of the superbonding layer and the TAPI.

Controlled Debonding

By controlled debonding is meant a zonal variability in the generally planar direction, in cohesion, in the vicinity of the interfacial region and the top adhesive interlayer (TAPI) of the composite adhesive interlayer (CAPI). Stated another way, the cohesion strength within the region comprising the debonding zones varies generally in the planar direction in the vicinity of the interface of the glass substrate and the TAPI. This variation is described in the multiple exemplary embodiments, infra.

### Controlled Debonding Zone Treatment

A treatment which alters the debonding fracture energy of the debonding zone preferably within 10% thickness near the interface of the composite adhesive polymeric interlayer (CAPI), that is within the top adhesive interlayer (TAPI). Energy release rates/work at separation will be reported as kJ/m² for adhesion measurements carried out using a peel test.

### Debonding Zones

By “debonding zones” is meant that if the glass substrates and the composite adhesive interlayer (CAPI) debond, there is substantial likelihood that the debonding is primarily within the “debonding zones.”

### Cohesive Discrete Debonding Zones

By “cohesive discrete debonding zones” is meant that the debonding zones are substantially contained in the top adhesive polymeric interlayer (TAPI); and the debonding zones are substantially discrete, that is, the zones, which may or may not cover generally the entire area of the TAPI, in the planar direction, are substantially separate from each other with defined boundaries. The likely random imperfections in discreteness of the zones given the limitations of the materials, and/or the process of making the materials—for example, two zones that are substantially discrete may “bleed into” each other, de minimis—are acknowledged in the present invention. The discrete zones may be co-planar or may not be co-planar. The discrete zones in a given plane may be coplanar to at least one of the glass substrate, the CAPI, the TAPI, or the bulk adhesive interlayer (BAPI). While this invention envisions the TAPI, substantially, as the loci of the debonding zones, a nominal distribution of the debonding zones in the BAPI and/or outside of the preferred 10% thickness of the CAPI is also within the scope of the present invention.

### Cohesive Continuous Debonding Zones

By “cohesive continuous debonding zones” is meant that the debonding zones are substantially contained in the top adhesive polymeric interlayer (TAPI); and the debonding zones are substantially continuous, that is, the zones cover generally the entire area of the TAPI in the planar direction. The likely random imperfections in continuity of the zones given the limitations of the materials, and/or the process of making the materials are acknowledged in the present invention. The continuous debonding zones may be co-planar or may not be co-planar. The continuous zones may be co-planar to at least one of the glass substrate, the CAPI, the TAPI, or the bulk adhesive interlayer (BAPI). While this invention envisions the TAPI, substantially, as the loci of the debonding zones, a nominal distribution of the debonding zones in the BAPI and/or outside of the preferred 10% thickness of the CAPI is also within the scope of the present invention.

### Adhesive and Cohesive Fracture

It is rare to get 100% adhesive fracture at an interface between two dissimilar materials, for example, the CAPI and the glass surface herein. In adhesive fracture nominally crack path resides at or near the interface, the crack area substantially being within 100 nm of the interface.

Similarly, in cohesive fracture, nominally, the crack path resides within the bulk material, defined here as a substantial portion of the crack area being at a distance greater than 100 nm from the interface, for example, a glass substrate-API interface, or a superbonding layer API interface. In one embodiment, from about 51% to about 100% of the crack area is found at a at a distance greater than 100 nm from the interface. Stated differently, the crack area percentage is selected from a range defined by any one number below, including the endpoints:

51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

### Patterned Cohesion

By “patterned cohesion” is meant that the debonding treatment is arranged in some geometric fashion with the disposition within the TAPI layer. There is some regularity with a patterned treatment. This treatment will create debonding discontinuities that differ from the interstitial spaces adjoining the pattern. There may be more than one pattern treatment applied, either differing in pattern type, geometry parameters and can be made to be overlapping or imposed upon the underlying pattern treatment or falling within the interstitial space or any combination thereof.

### Stochastic

By “stochastic” is meant that an item or pattern is randomly determined and generally cannot be predicted precisely. Therefore, as used herein, a stochastic pattern is a random one.

### Stochastically Varying Cohesion

By “stochastically varying cohesion” is meant that the debonding treatment is approaching a ‘random-like’ disposition within the debond region of the top adhesive polymeric interlayer (TAPI). This treatment will create debonding discontinuities from that of a more uniform field of cohesion/debonding.

### Superbonding Layer

By “superbonding layer” is meant a sub-micron thick layer, on average, that is interposed between the API and the glass substrate. Stated differently, depending upon the embodiments described infra, the superbonding layer is interposed between a glass substrate and the TAPI layer, or the glass substrate and the BAPI layer. The superbonding layer is substantially continuous. The likely random imperfections in spreading of the superbonding layer, given the limitations of the materials, and/or the process of making the materials are acknowledged in the present invention.

By “substantially” is meant either greater than 50% and up to 100%, or in words, an outcome, a parameter, or a characteristic happening more likely than not.

### Uniform Cohesion

By uniform cohesion is meant that the debonding in the near-interfacial region between the TAPI and the glass substrate, but within the TAPI, occurs substantially in a manner that does not vary more than +/−10% from location-to-location as measured on an interfacial area basis. In one embodiment, the uniform cohesion covers from 5% to 100% of the near-interfacial region thickness.

### Universal Positioning

By “universal positioning” is meant the cohesion modifier is applied to either the glass or the composite adhesive polymeric interlayer (CAPI) or both, in a manner that allows the glass panels to be laid out onto the without regard to orientation, thus allowing the CAPI to be cut with a minimal amount of waste.

### Circularity

Circularity, C, is defined as the degree to which the zone is similar to a circle, taking into consideration the smoothness of the perimeter, length P. This means circularity is a measurement of both the zone and roughness. Thus, the further away from a perfectly round, smooth circle a zone becomes, the lower the circularity value. Circularity is a dimensionless value. Where A is the feature area, ISO9276-6 defines circularity as:

$$C = \sqrt{\frac{4 π A}{{P}^{2}}}$$

### Solidity

Solidity, S, is the measurement of the overall concavity of a zone. It is defined as the image area, A, divided by the convex hull area, Ac, as given below. Thus, as the zone becomes more solid, the image area and convex hull area approach each other, resulting in a solidity value of one. However, as the zone digresses from a closed circle, the convex hull area increases and the calculated solidity decreases. Solidity is a dimensionless value.

$$S = \frac{A}{{A}_{c}}$$

### Effective Diameter

By “effective diameter” is meant the diameter of a circle with an area equivalent to the area of a zone having any shape as described herein.

In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units would be gauge, and pressures expressed in kPa units would be absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 15 weight % of acrylic acid”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

The term “dipolymer” refers to polymers consisting essentially of two monomers, and the term “terpolymer” refers to polymers comprising at least three monomers.

The term “acid copolymer” as used herein refers to a copolymer comprising copolymerized units of an α-olefin, an α,β-ethylenically unsaturated carboxylic acid, and optionally other suitable comonomer(s) such as, for example, an α,β-ethylenically unsaturated carboxylic acid ester.

The term “(meth)acrylic”, as used herein, alone or in combined form, such as “(meth)acrylate”, refers to acrylic or methacrylic, for example, “acrylic acid or methacrylic acid”, or “alkyl acrylate or alkyl methacrylate”.

The term “ionomer” as used herein generally refers to a polymer that comprises ionic groups that are carboxylate salts, for example, ammonium carboxylates, alkali metal carboxylates, alkaline earth carboxylates, transition metal carboxylates and/or combinations of such carboxylates. Such polymers are generally produced by partially or fully neutralizing the carboxylic acid groups of precursor or parent polymers that are acid copolymers, as defined herein, for example by reaction with a base. The alkali metal ionomer as used herein is a sodium ionomer, for example a copolymer of ethylene and methacrylic acid, wherein all or a portion of the carboxylic acid groups of the copolymerized methacrylic acid units are neutralized, and substantially all of the neutralized carboxylic acid groups are in the form of sodium carboxylates.

For convenience, many elements of the present invention are discussed separately, lists of options may be provided and numerical values may be in ranges; however, for the purposes of the present disclosure, that should not be considered as a limitation on the scope of the disclosure or support of the present disclosure for any claim of any combination of any such separate components, list items or ranges. Unless stated otherwise, each and every combination possible with the present disclosure should be considered as explicitly disclosed for all purposes.

Although methods and materials similar or equivalent to those described herein can be used in the practice or testing of the present disclosure, suitable methods and materials are described herein. The materials, methods, and examples herein are thus illustrative only and, except as specifically stated, are not intended to be limiting.

### Superbonding Layer Characteristics

This invention provides a superbonding layer interposed between the glass substrate and the adhesive polymeric interlayer (API). In a preferred embodiment, the superbonding layer has a substantially higher adhesion to the glass substrate compared to its adhesion with the API. As a result, a potential the fracture is likely to occur within the API, i.e., a cohesive failure. In a preferred embodiment, in the 10% thickness of the API starting from the glass substrate, are found discrete and/or continuous debonding zones, which are explained supra. The debonding zones act as reservoirs to dissipate fracture energy, for example, upon impact. Because the debonding zones reside in the 10% thickness of the API, the fracture is likely to be a cohesive failure, being guided or controlled by the debonding zones.

With the superbonding layer in place, the API becomes substrate-agnostic. Stated differently, no matter what the glass substrate is, what its surface treatment is, what its surface properties are, what its physical characteristics are, what its contours are, the superbonding layer directs the laminate failure to a cohesive failure, that is, within the API.

The superbonding layer, in one embodiment is sub-micron in the average thickness. The superbonding layer, thickness is any one of the following numbers expressed in microns or is within the range defined by any two numbers below, including the endpoint of such range:

0.1, 0.2, 0.3, 0.4, 0.5, 0.6, 0.7, 0.8, 0.9, and 1.0.

The superbonding layer is prepared from the same materials as described herein for the API. However, the superbonding layer's adhesion to the glass substrate is substantially more than its adhesion to the API. The ratio of the adhesion strength between the two surfaces (superbonding layer/glass and superbonding layer/API) is at least any one of the following numbers or is within the range defined by any two numbers below, including the endpoints of such range:

2, 3, 4, 5, 6, 7, 8, 9, 10.

The ratio can be higher than 10 also.

In one embodiment, the superbonding layer is PVA. While the superbonding layer may be made from the same materials as the API, the API and the superbonding layer are chemically and/or physically different.

A superbonding material can be prepared from polyvinyl alcohol, ethylene vinyl alcohol, polyvinyl butyral, polyvinyl acetal, ethylene vinyl acetate, polyacrylic acid, polyurethanes, ethylene acrylic acid copolymers and ethylene methacrylic acid copolymer and their ionomers may be used. Additional resins can include styrene acrylates, polysiloxanes, fluorinated polymers, polyesters.

Additives for the superbonding material may include surfactants which can may nonionic, anionic, cationic or amphoteric. Surfactants may further comprise alcohol ethoxylates, ethoxylated polyamines, ethoxylated polysiloxanes, alkyl carboxylates and alkylaryl sulfonates, alpha-olefin sulfonates, alkyl ether sulfonates or combinations thereof.

Other additives may be included and through diffusion and interaction with the interface between the rigid substrate and the superbonding layer, modify the adhesiveness (debonding behavior). Any of these polymers may further be combined with silanes, titanates and zirconates for further modification of adhesiveness (and debonding behavior) to both the API substrate and the rigid substrate (for example, glass). These and other polymers can also be grafted or formulated with additional moieties for modification of adhesiveness (debonding behavior) with maleic anhydride, epoxy groups or silanol groups. Mixtures of polymers may be also used to optimally modify the adhesiveness response, and while not being held to theory, micelle formation, stratification and selective adsorption/interaction can be designed into the superbonding layer as a means for enhancing performance. These materials can be applied in a form of aqueous or solvent-based solutions, emulsions, dispersions and the like.

Various process techniques can be used to apply such materials, examples include slot-die coating, spraying, printing, and roll transfer methods. Other energetic means (examples include, thermal, laser, UV-curing, ion beam, electron beam, plasma, corona, flame-treatment) may also be used alone or in combination with the above materials. The materials and methods above are examples of various means to adjust the debonding behavior and direct the nature of debonding event as whether it dissipates energy by decoupling in zonal regions which might be described as adhesive, cohesive, or mixed-mode but are not limiting.

### TAPI Layer Characteristics

The CAPI layer comprises a stack of the superbonding layer, the TAPI layer, and the BAPI layer, in that order. Depending upon the context, the CAPI can also refer to a stack comprising only the TAPI and the BAPI, devoid of the superbonding layer. The debonding zones are substantially contained within the TAPI layer. While the TAPI, substantially, is the loci of the debonding zones, a nominal distribution of the debonding zones in the BAPI and/or outside of the preferred 10% thickness of the CAPI is also within the scope of the present invention. The TAPI layer is made from the same materials as the BAPI, described infra, but the TAPI layer is physically or chemically distinct from the BAPI layer as well as from the superbonding layer, if present. The TAPI is adhered to the BAPI. The TAPI, in the aggregate, is different from the BAPI, in the aggregate, in at least one physical and/or one chemical characteristic. The TAPI includes cohesive debonding zones that are substantially discrete and or substantially continuous in their layout. Preferably, substantially all of the cohesive discrete and/or continuous debonding zones are located within the TAPI.

### Controlled Debonding Zones Characteristics

### Peel Strength Difference Between Debonding Zones

In an embodiment of the invention, the top adhesive interlayer (TAPI) within the composite adhesive polymeric interlayer (CAPI) comprises more than one controlled debonding zones, alternatively called debonding zones, such that the difference in mean peel strength between the zone with minimum peel strength (Zₘᵢₙ) and the zone with maximum peel strength (Zₘₐₓ) is at least about 2 multiples. Stated differently, (Zₘₐₓ/Zₘᵢₙ)≥2. In an embodiment of the invention, a laminate comprises the TAPI region within the CAPI with multiple debonding zones, such that the difference in peel strength or mean peel strength between any two zones Z₁ and Z₂ is greater than or equal to 0, or their ratio is greater than or equal to 1. In other words, Z₁−Z₂≥0, or Z₁/Z₂≥1. However, in this embodiment, the (Zₘₐₓ/Zₘᵢₙ)≥2 condition is maintained. In one embodiment, the peel strength ratio of the zone with maximum peel strength (Zₘₐₓ) to the zone with the minimum peel strength (Zₘᵢₙ), that is, (Zₘₐₓ/Zₘᵢₙ) is greater than or equal to 5. In one embodiment, all zones have different peel strengths; one or more zones have the same peel strength; or one or more zones have different peel strengths.

To elaborate further, this invention encompasses the embodiment, wherein more than one discrete and/or continuous zones demonstrate different peel strength, but the (Zₘₐₓ/Zₘᵢₙ)≥2 condition is maintained. For example, in interfacial region within the API with four zones, Z₁; Z₂; Z₃; and Z₄; Z₁ is the zone with maximum peel strength and Z₃ is the zone with minimum peel strength. Zones Z₁, Z₂, Z₃, and Z₄ have different peel strengths. In an equation form:

(Z₁/Z₃)≥2; and

Z₁≠Z₂≠Z₃≠Z₄.

In an embodiment of the invention, the TAPI layer within the CAPI layer comprises more than one discrete and/or continuous zones substantially planar to each other but in different planes that demonstrate the same peel strength, or different peel strength, but the (Zₘₐₓ/Zₘᵢₙ)≥2 condition is maintained. For example, in a fluorinated-ethylene-propylene (FEP) layer with ten zones in the interfacial region within the TAPI, Z₁, Z₂, Z₃, Z₄, Z₅, Z₆, Z₇, Z₈, Z₉, and Z₁₀, Z₄ is the zone with maximum peel strength and Z₈ is the zone with minimum peel strength. Zones Z₂, Z₆, and Z₉ have the same peel strength. Zones Z₁, Z₂, and Z₇ have different peel strengths. In an equation form:

Z₂=Z₆=Z₉;

(Z₄/Z₈)≥2; and

Z₁≠Z₂≠Z₇.

### Shape Difference Between Controlled Debonding Zones

In one embodiment, the top adhesive polymeric interlayer (TAPI) comprises more than one debonding zones, such that the debonding zones have regular shapes. The debonding zone is defined according to the peel strength. Stated another way, to a normal eye an interlayer may appear homogeneous and uniform, but for the purposes of the present invention, the debonding zones are defined by the difference in their peel strengths.

Regular shapes include for example, circles, triangles, square, rectangles, trapezoid, rhombus, pentagons, hexagons, heptagons, and other polygons that may or may not approximate a circle, ovals, and such other shapes, with an effective area generally greater than the thickness of the interlayer in one embodiment. This invention also envisions irregular-shaped debonding zones for example, circles, triangles, square, rectangles, trapezoid, rhombus, pentagons, hexagons, heptagons, and other polygons that may or may not approximate a circle, ovals, and such other shapes. Irregular shapes include random shapes with closed boundaries, with effective area generally greater than the thickness of the interlayer in another embodiment. In one embodiment, the debonding zones are spaced adjacent one another. In another embodiment, the debonding zones are separated by interstitial space. In one embodiment, some debonding zones are spaced adjacent one another, and other debonding zones are separated by interstitial space. Other shapes include one-dimensionally oriented patterns such as gridlines, crisscross lines, lattice, interweave, random lines, concentric and eccentric circles, spaghetti patterns, flat strips, etc. In one embodiment, a cluster of smaller shapes would form a zone, with a second cluster of smaller shapes that would form a second zone. In such embodiments, the aggregate peel strength of each cluster is measured, and the cluster of shapes is considered a debonding zone. The shapes within the cluster could be random shapes, regular, mixed regular shapes, mixed random shapes, or mixed random and regular shapes. The debonding zones as clusters could also comprise one-dimensionally oriented patterns such as gridlines, crisscross lines, random lines, concentric and eccentric circles, spaghetti patterns, flat strips, etc.

In case of gridlines, and such other one-dimensionally oriented shapes in the TAPI layer, the difference in peel strength between a gridline and the adjacent debonding zone may be measured by preparing a separate interlayer debonding zone with the strength of the gridline, and comparing it with the debonding zone in the interlayer of interest in between two gridlines, that is, in the interstitial spaces between two gridlines. Even in case of one-dimensionally oriented patterns, the area of such shapes may determine the peel-strength difference between a controlled debonding zone and the interstitial spaces or the difference between two adjacent controlled debonding zones.

The debonding zone is defined according to the peel strength. Stated another way, to a normal eye the interfacial region within the TAPI may appear homogeneous and uniform, but for the purposes of the present invention, the debonding zones are defined by the difference in their peel strengths.

### EMBODIMENTS

In the present disclosure, when a laminate structure is referenced, glass substrates are used as exemplars. But the present invention applies also to rigid substrates. Rigid substrates include conventional glasses, such as soda lime and borosilicate glass, typically manufactured using the float process, crystalline materials such as aluminum oxynitride (AlON), single crystal aluminum oxide (Sapphire), spinel (MgAl₂O₄), and glass-ceramic materials, such as TransArm™, and lithium disilicate glass-ceramic.

Furthermore, materials that could be utilized as the rigid substrate (or glass) as cited in this disclosure may include for example, commercial plate glass, float or sheet glass compositions, annealed glass, tempered glass, chemically strengthened glass, quartz and fused silica, borosilicate glasses, lithium containing glasses, PYROCERAM®, lithium containing ceramics, and nucleated ceramics. Glass compositions that can be produced as glass-ceramic materials include lithium zinc silicates, lithium aluminosilicates, lithium zinc aluminosilicates, lithium magnesium silicates, lithium magnesium aluminosilicates, magnesium aluminosilicates, calcium magnesium aluminosilicates, magnesium zinc silicates, calcium magnesium zinc silicates, zinc aluminosilicate systems calcium phosphates, calcium silicophosphates and barium silicate. As rigid substrates, other high-performance materials can consist of, aluminum oxide, zirconium oxide, silicon carbide, silicon nitride, aluminum nitride and machinable glasses.

Rigid substrates such a glass may also contain a variety of surface coatings and treatments to afford solar control properties, reflectivity, decorative features, frit coatings, opacifying treatments, gradients or masking. The patent art herein can be employed as a universal feature for these and all broad and contemplated anticipations.

A variety of polymeric materials that have a modulus suited for the for rigid substrate purpose and sufficient mechanical performance can include, polycarbonates, acrylic or polymethyl methacrylate, polyethylene, polypropylene, polyethylene terephthalate, polyvinyl chloride, acrylonitrile-butadiene-styrene, polyamides, polyaramids, polyvinyl chloride, polystyrene, polylactic acid, polyoxymethylene, polyetheretherketone, and thermosets, such as phenolics, polyesters, epoxies and crosslinked systems such as vulcanized rubber.

In one embodiment of the first set, this invention relates to a laminate structure, comprising a stack of at least one glass substrate and a composite adhesive polymeric interlayer (CAPI). The glass substrate adheres to the CAPI. The CAPI comprises at least two layers: (i) a superbonding layer and/or a top adhesive polymeric interlayer (TAPI) and (ii) a base adhesive polymeric interlayer (BAPI).

Stated differently, the present invention envisions the following embodiments:
(I) The CAPI interlayer comprising a stack of a first TAPI layer and a BAPI layer; wherein the first TAPI layer interfaces the first glass substrate on one side and the BAPI layer on the other side; and the BAPI layer interfacing the first TAPI layer on one side and a second TAPI layer, a superbonding layer, or a second glass substrate on the other side; and
(II) The CAPI interlayer comprising a stack of a first superbonding layer and a BAPI layer; wherein the first superbonding layer interfaces a first glass substrate on one side and the BAPI layer on the other side; and the BAPI layer interfacing the first superbonding layer on one side and a TAPI layer, a second superbonding layer, or a second glass substrate on the other side.
(III) The CAPI interlayer comprising a stack of a first superbonding layer, a first TAPI layer, and a BAPI layer; wherein the first superbonding layer interfaces a first glass substrate on one side and the first TAPI layer on the other side; the first TAPI layer interfacing the first superbonding layer on one side and the BAPI layer on the other side; and the BAPI layer interfacing the first TAPI layer on one side and a second TAPI layer, a second superbonding layer, or a second glass substrate on the other side.

### A1. First Set of Embodiments

In this set, the present invention relates to an interlayer and a laminate structure comprising the CAPI interlayer comprising a stack of a first TAPI layer and a BAPI layer; wherein the first TAPI layer interfaces the first glass substrate on one side and the BAPI layer on the other side; and the BAPI layer interfacing the first TAPI layer on one side and a second TAPI layer, a superbonding layer, or a second glass substrate on the other side.

In one embodiment of the first set of embodiments, this invention relates to a laminate structure comprising a stack of at least one glass substrate and a composite adhesive polymeric interlayer (CAPI). The glass substrate adheres to the CAPI. The CAPI comprises two layers: (i) a top adhesive polymeric interlayer (TAPI) and (ii) a bulk or base adhesive polymeric interlayer (BAPI).

In this embodiment, the TAPI is adhered to the BAPI. The TAPI, in the aggregate, is different from the BAPI, in the aggregate, in at least one physical and/or one chemical characteristic. The TAPI includes cohesive debonding zones that are substantially discrete and/or substantially continuous in their layout. Preferably, substantially all of the cohesive debonding zones are located within the TAPI.

In another embodiment of the first set, this invention relates to a laminate structure that comprising a stack of a first glass substrate; a composite adhesive polymeric interlayer (CAPI); and a second glass substrate. The first glass substrate adheres to the second glass substrate through said composite adhesive polymeric interlayer (CAPI). The CAPI comprises two layers: a top adhesive polymeric interlayer (TAPI) and a base adhesive polymeric interlayer (BAPI). The TAPI is adhered to the BAPI. The TAPI, in the aggregate, is different from the BAPI, in the aggregate, in at least one physical and/or one chemical characteristic. The TAPI includes cohesive debonding zones that are substantially discrete and or substantially continuous in their layout. Preferably, substantially all of the cohesive discrete debonding zones are located within the TAPI.

In yet another embodiment of the first set, this invention relates to the laminate structures described above, wherein substantially all of the cohesive discrete and/or continuous debonding zones are located within about a 10% thickness of the composite adhesive polymeric interlayer (CAPI) from the interface of said CAPI and the first glass substrate and/or the second glass substrate, if present. These zones allow for a unique combination of API-glass debonding, laminate toughness, and laminate durability. Various spatial patterns and densities of debonding are described, as well as the resulting material properties.

The core embodiment of the first set of the present invention includes the glass substrate and the composite adhesive polymeric interlayer (CAPI). This invention also envisions a stack comprising one or more than one of each layer, the glass substrate and the CAPI. In one embodiment, the stack comprises the two layers, that could be alternating or placed in a random fashion, with the number of each layer being same or different. So, for example if the glass substrate is represented as An, and the CAPI as Bn, the following exemplary structures and their logical equivalents are envisioned:

A1/B1; A1/B1/A2; A1/B1/B2; A1/B1/B2/A2; A1/B1/A2/B2; A1/B1/B2/B3/A2; A1/B1/B2/A2/B3/A3, and so on and so forth.

In one embodiment, of the multi-layer stack, the end layers of the stack are glass substrates. In another multi-layer stack, the end-layer on one side is the glass substrate and the other side is a CAPI. One such embodiment is described above.

In one embodiment, this invention relates to a laminate structure comprising a stack of at least one glass substrate adhered to a composite adhesive polymeric interlayer (CAPI). The CAPI interlayer comprises two layers, a top adhesive polymeric interlayer (TAPI) and layer and a bulk adhesive polymeric interlayer (BAPI). The top adhesive polymeric interlayer, which is a component of the CAPI, comprises discrete and/or continuous debonding zones, optionally coplanar to the CAPI, TAPI, BAPI, and/or to one or more of the glass substrates. The TAPI layer is different from the BAPI in at least one physical and/or one chemical characteristic.

In one embodiment, this invention relates to a laminate structure comprising a stack of two glass substrates adhered to each other through an adhesive polymeric interlayer. The interfacial region or zone of the adhesive polymeric interlayer (API) comprises cohesive debonding zones discrete and/or continuous. In one embodiment, such cohesive discrete and/or continuous debonding zones are coplanar to the API or to both glass substrates. The cohesive discrete and/or continuous debonding zones are different from the API in at least one physical and/or one chemical characteristic. Embodiments described below use a two-glass substrate with one API layer, but only as an example. It is understood that the description applies to multiple glass substrates with corresponding multiple API layers.

As discussed previously, the cohesive discrete debonding zones are substantially discrete, that is, the zones, which may or may not cover generally the entire area of the top adhesive polymeric interlayer (TAPI), in the planar direction, are substantially separate from each other with defined boundaries. The likely random imperfections in discreteness of the zones given the limitations of the materials, and/or the process of making the materials—for example, two zones that are substantially discrete and/or continuous may “bleed into” each other, de minimis—are acknowledged in the present invention. The discrete zones may be co-planar or may not be co-planar. The cohesive discrete debonding zones are different from the API in at least one physical and/or one chemical characteristic.

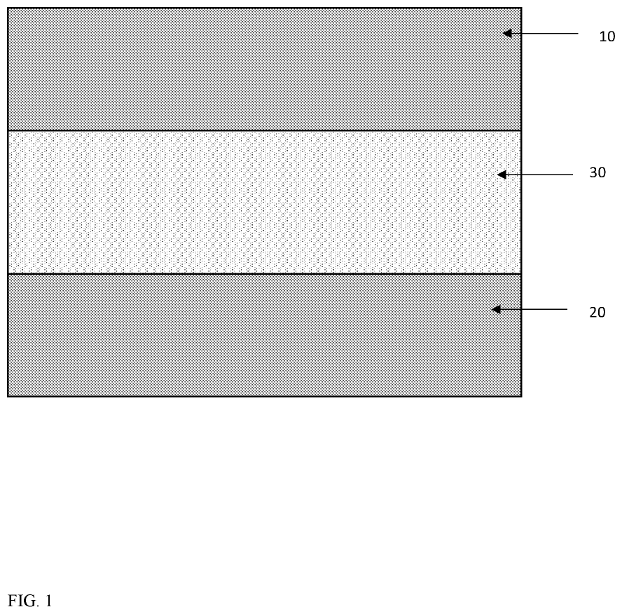

FIG. 1 depicts a general laminate structure with two glass substrates (10 and 20) with an adhesive polymeric interlayer or API (30) in between the two glass substrates.

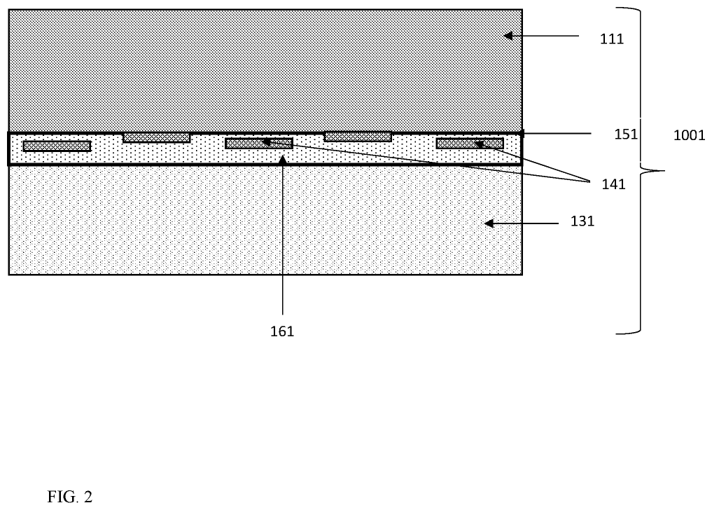

FIG. 2 depicts an embodiment of the present invention wherein only one glass substrate (111) adheres to the composite adhesive polymeric interlayer, which comprises the top adhesive interlayer (TAPI; 161) and the bulk adhesive interlayer (BAPI; 131) to form the stack (1001). Generally speaking, the TAPI layer thickness is much lower than the thickness of the BAPI. The top adhesive polymeric interlayer (TAPI; 161) comprises discrete debonding zones (141) and begins at the interface (151) of the TAPI (161) and the glass substrate (111) and extends about 10% in thickness into the API. The debonding zone's (141) thickness is much lower than the thickness of the API (TAPI+BAPI; 162+132).

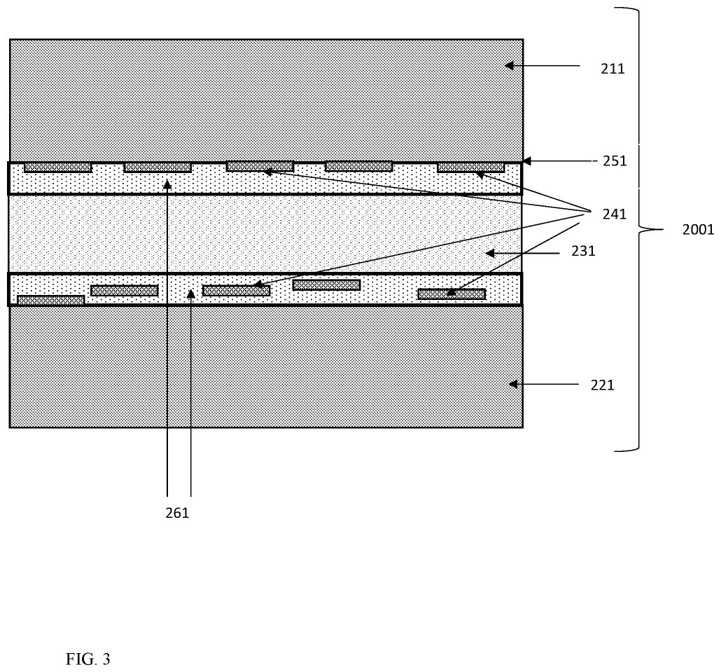

FIG. 3 depicts an embodiment of the present invention wherein two glass substrates (211 and 221) adhere to the composite adhesive polymeric interlayer, which comprises the top adhesive interlayer (TAPI; 261) and the bulk adhesive interlayer (BAPI; 231) to form the stack (2001). Generally speaking, the TAPI layer thickness is much lower than the thickness of the BAPI. The top adhesive polymeric interlayer (TAPI; 261) comprises discrete debonding zones (241) and begins at the interface (251) of the TAPI (261) and the glass substrate (211 and 221) and extends about 10% in thickness into the API. The debonding zone's (241) thickness is much lower than the thickness of the API (TAPI+BAPI). FIG. 3 shows two TAPIs and correspondingly, discrete debonding zones in each. Each TAPI can be 10% or less in thickness of the CAPI and the two TAPIs.

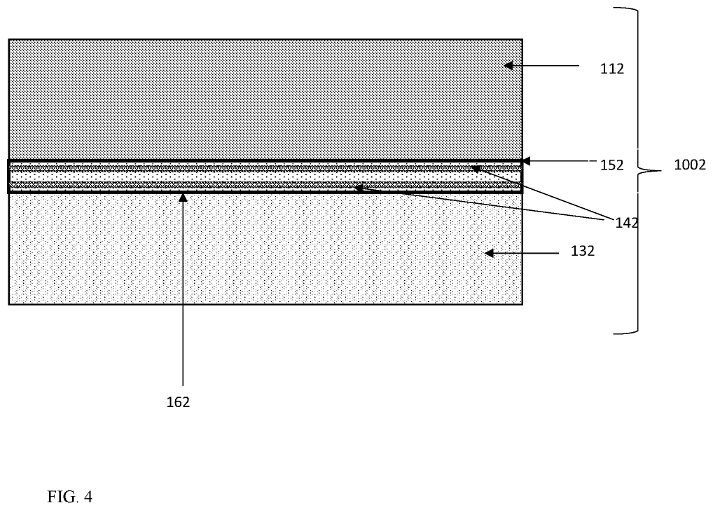

FIG. 4 depicts an embodiment of the present invention wherein only one glass substrate (112) adheres to the composite adhesive polymeric interlayer, which comprises the top adhesive interlayer (TAPI; 162) and the bulk adhesive interlayer (BAPI; 132) to form the stack (1002). Generally speaking, the TAPI layer thickness is much lower than the thickness of the BAPI. The top adhesive polymeric interlayer (TAPI; 162) comprises continuous debonding zones (142) and begins at the interface (152) of the TAPI (162) and the glass substrate (112) and extends about 10% in thickness into the API. The debonding zone's (142) thickness is much lower than the thickness of the API (TAPI+BAPI; 162+132).

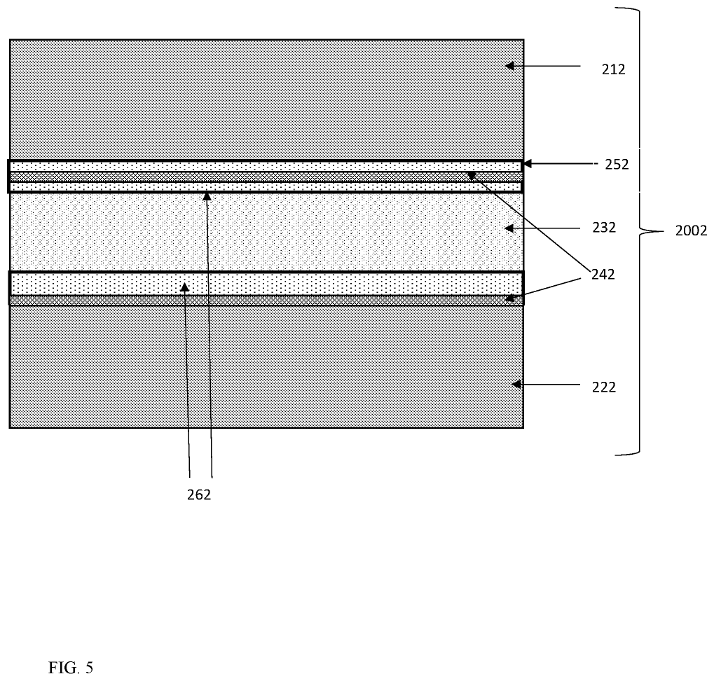

FIG. 5 depicts an embodiment of the present invention wherein two glass substrates (212 and 222) adhere to the composite adhesive polymeric interlayer, which comprises the top adhesive interlayer (TAPI; 262) and the bulk adhesive interlayer (BAPI; 232) to form the stack (2002). Generally speaking, the TAPI layer thickness is much lower than the thickness of the BAPI. The top adhesive polymeric interlayer (TAPI; 262) comprises continuous debonding zones (242) and begins at the interface (252) of the TAPI (262) and the glass substrate (212 and 222) and extends about 10% in thickness into the API. The debonding zone's (242) thickness is much lower than the thickness of the API (TAPI+BAPI; 162+132). FIG. 5 shows two TAPIs and correspondingly, continuous debonding zones in each. Each TAPI can be 10% or less in thickness of the CAPI and the two TAPIs.

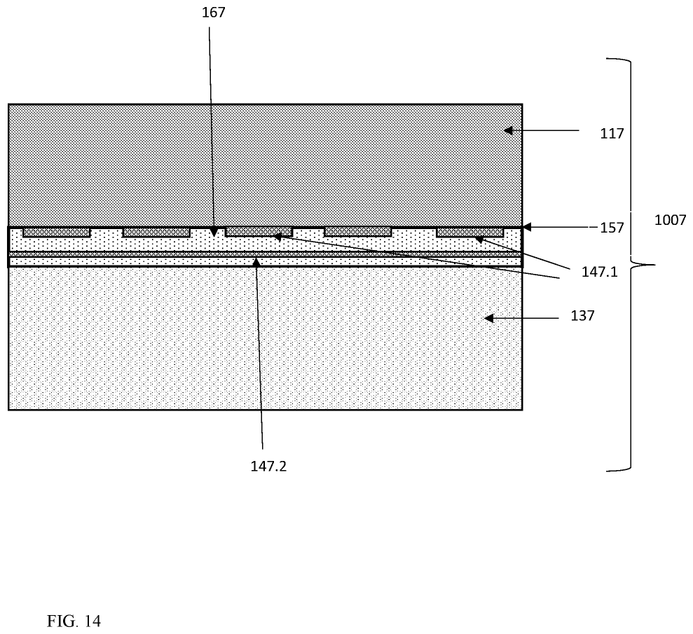

FIG. 14 depicts an embodiment of the present invention wherein only one glass substrate (117) adheres to the composite adhesive polymeric interlayer, which comprises the top adhesive interlayer (TAPI; 167) and the bulk adhesive interlayer (BAPI; 137) to form the stack (1007). Generally speaking, the TAPI layer thickness is much lower than the thickness of the BAPI. The top adhesive polymeric interlayer (TAPI; 167) comprises discrete (147.1) continuous debonding zones (147.2) and begins at the interface (157) of the TAPI (167) and the glass substrate (117) and extends about 10% in thickness into the API. The debonding zone's (147) thickness is much lower than the thickness of the API (TAPI+BAPI; 167+137).

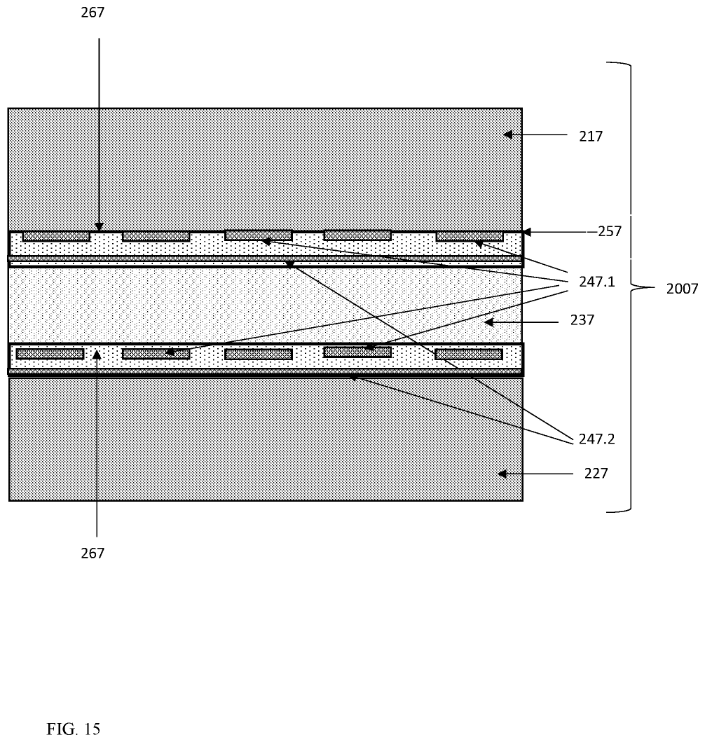

FIG. 15 depicts an embodiment of the present invention wherein two glass substrates (217 and 227) adhere to the composite adhesive polymeric interlayer, which comprises the top adhesive interlayer (TAPI; 267) and the bulk adhesive interlayer (BAPI; 237) to form the stack (2007). Generally speaking, the TAPI layer thickness is much lower than the thickness of the BAPI. The top adhesive polymeric interlayer (TAPI; 267) comprises discrete debonding zones (247.1) and continuous debonding zones (247.2) and begins at the interface (257) of the TAPI (267) and the glass substrate (217 and 227) and extends about 10% in thickness into the API. The debonding zone's (247) thickness is much lower than the thickness of the API (TAPI+BAPI; 167+137). FIG. 15 shows two TAPIs and correspondingly, discrete and continuous debonding zones in each. Each TAPI can be 10% or less in thickness of the CAPI and the two TAPIs.

In one embodiment, the laminate structure can comprise more than one glass substrate with corresponding CAPI, BAPI or TAPI layers in between. For example, the number of glass substrates can be 1, 2, 3, 4, 5, 6, 7, 8, 9, 10, 11, 12, 13, 14, 15, 16, 17, 18, 19, and 20. The number of CAPI, BAPI, and/or the TAPI layers can also be from 1-20.

Embodiments described herein use a two-glass substrate with one CAPI layer, but only as an exemplar. It is understood that the description applies to multiple glass substrates with corresponding multiple CAPI, TAPI, and/or BAPI layers.

In one embodiment, this invention relates to a laminate structure comprising a stack of two glass substrates adhered to each other through a composite adhesive polymeric interlayer (CAPI). The TAPI layer within the CAPI layer comprises cohesive discrete and/or continuous debonding zones. In one embodiment, such cohesive discrete and/or continuous debonding zones are coplanar to the TAPI, BAPI, CAPI, or one or both glass substrates. The cohesive discrete debonding zones are different from the TAPI in at least one physical and/or one chemical characteristic.

In one embodiment, the laminated structure of the present invention comprises more than one cohesive discrete and/or continuous debonding zones.

In one embodiment, the discrete and/or continuous debonding zone within the TAPI layer comprises a polymeric material chemically and/or physically different from that of the surface interlayer. Stated differently, at least one of the three items—the discrete and/or continuous debonding zone, the TAPI layer, and the bulk adhesive polymeric interlayer—is necessarily different from the other two, in at least one chemical and/or one physical characteristic. For example, the discrete and/or continuous debonding zone and the TAPI layer, or the TAPI layer and the BAPI layer differ in terms of molecular weight, crystallinity, density, glass transition temperature, melt-flow index, chemical composition, additive, chemical modification, or a combination of one or more of such characteristics.

In an aspect, the invention provides a TAPI layer comprising a controlled debonding zone which, when combined with one or more layers of glass and bulk adhesive polymeric interlayer (BAPI) to form a laminate, provides a combination of improved toughness, adhesion, and durability.

In another aspect, the invention provides a TAPI layer with a controlled debonding treatment that is substantially uniform and creates substantially discrete and/or continuous debonding zones with variable fracture toughness so that debonding occurs at a prescribed fracture energy level.

In another aspect, the invention provides a TAPI layer with a controlled debonding treatment that is substantially discrete and creates debonding zones with variable fracture toughness with higher and lower fracture energy.

In yet another aspect, the invention provides a TAPI layer with a controlled debonding treatment that is substantially discrete and has a substantially uniform pattern; and creates debonding zones with variable fracture toughness with higher and lower fracture energy.

In yet another aspect, the invention provides a TAPI layer with a controlled debonding treatment that is substantially discrete and has a substantially stochastic pattern; and creates debonding zones with variable fracture toughness with higher and lower fracture energy.

In yet another aspect, the invention provides a TAPI layer with a controlled debonding treatment that is substantially uniform and creates debonding zones with variable fracture toughness so that debonding occurs at a prescribed fracture energy level in a cohesive manner.

In one aspect, the invention provides a surface layer comprising discrete debonding zones at the interface of the surface layer and the bulk adhesive polymeric interface layer (BAPI), wherein the discrete debonding zones are characterized by: (i) a regular shape, (ii) a stochastic/random shape, (iii) one-dimensional patterns, and/or, (iv) a cluster of regular, random, and/or one-dimensional patterns.

In one embodiment of the laminate structures described above, the weight content of the discrete and/or continuous debonding zones, as a percentage of the total of the CAPI including said discrete and/or continuous debonding zones, is in the range of 1% to about 30%. Stated differently, the weight content is any one of the following numbers, as measured in percentage of the CAPI: 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30. The weight content can be any number within a range defined by any two numbers herein, including the endpoints of the range.

In another embodiment of the laminate structures described above, the weight content of the discrete debonding zones, as a percentage of the total of the CAPI including said discrete debonding zones, is in the range of 0.001% to about 1%. Stated differently, the weight content is any one of the following numbers, as measured in percentage of the API: 0.001, 0.10, 0.020, 0.030, 0.040, 0.050, 0.060, 0.070, 0.080, 0.090, and 1.00. The weight content can be any number within a range defined by any two numbers herein, including the endpoints of the range.

As described previously, in one embodiment, the TAPI comprises at least two zones, wherein the zone with maximum mean peel strength has a mean peel strength that is at least about 2 times greater than a mean peel strength of the zone with minimum mean peel strength. In another embodiment, the zone with maximum mean peel strength has a mean peel strength that is from about 2 times to about 250 times greater than a mean peel strength of the zone with minimum mean peel strength.

In another embodiment of the laminate structure the TAPI layer comprises at least two zones, wherein at least one of the zones has a mean peel strength of from about 0.1 to about 4.0 kJ/m². In yet another embodiment, the mean peel strength is from about 0.5 to about 3.0 kJ/m². In a further embodiment of the invention, the at least one of the zones has a mean peel strength of from about 8.0 to about 12.0 kJ/m². In one embodiment, the mean peel strength is from about 9.0 to about 11.0 kJ/m².

In one embodiment, the composite polymeric adhesive interlayer (CAPI) comprises a polyvinyl acetal, an ionomer, a thermoplastic elastomer, a silane, an ethyl vinyl acetate, or combinations thereof. However, the physical and/or chemical composition of the discrete debonding zone and the TAPI layer is different at least in one substantial aspect. The discrete debonding zones within said TAPI layer also comprise a polyvinyl acetal, an ionomer, a thermoplastic elastomer, a silane, an ethyl vinyl acetate, or combinations thereof. In one embodiment, the discrete debonding zones comprises the ionomer, wherein the ionomer resin is a sodium-neutralized ethylene-α, β-unsaturated carboxylic acid copolymer.

In one embodiment, the polyvinyl acetal is a polyvinyl butyral. Polyvinyl acetal is described infra. In one embodiment, the laminate structure further comprising an adhesion modifying agent. In another embodiment, the adhesion modifying agent is a silane, an alkali metal salt, an alkaline earth metal salt or a carboxylic group-containing olefinic polymer. In one embodiment, the adhesion modifying agent is present in a range of from about 0.001% to about 25% by weight of the composite adhesive polymeric interlayer.

In one embodiment, the discrete and/or continuous debonding zones have a thickness of from about 0.001 mm to about 1.0 mm. In another embodiment, wherein the shape of the discrete debonding zone is a circle that has an area that is 30-100% of the area of the CAPI.

In one embodiment, the mean peel strength of the Glass/Treatment interface zone (Z_{G-T}) is at least 2 times greater than the mean peel strength of the TAPI/Treatment interface zone (Z_{API-T}). This provides the benefit of having high glass adhesion and durability with controlled bonding of the TAPI (hence improved laminate toughness).

In one embodiment, in the laminate structures of the present invention, whether with one or more glass substrates, one or more discrete and/or continuous debonding zones in each laminated structure are coplanar to the TAPI layer, the BAPI layer, the CAPI layer, and/or to said glass substrate/s. In some embodiments, the discrete and/or continuous debonding zones are nominally coplanar and in others, they are substantially coplanar. In some embodiment, one or more discrete and/or continuous debonding zones are not coplanar to at least one glass substrate. It should be noted that the interlayer sheeting will have a surface texture/roughness and the cohesive layer may fluctuate in thickness with some of these ‘bumps’ or may not completely ‘undulate’ with this roughness. Then, although the glass is reasonably flat/smooth, the final laminated composite structure may have a textured thickness.

### Second Set of Embodiments

In this set, the present invention relates to an interlayer and a laminate structure comprising the CAPI interlayer comprising a stack of a first superbonding layer and a BAPI layer; wherein the first superbonding layer interfaces a first glass substrate on one side and the BAPI layer on the other side; and the BAPI layer interfacing the first superbonding layer on one side and a TAPI layer, a second superbonding layer, or a second glass substrate on the other side.

In the second set of the embodiments, this invention provides a superbonding layer interposed between the glass substrate and the API. In a preferred embodiment, the superbonding layer has a substantially higher adhesion to the glass substrate compared to its adhesion with the API. As a result, a potential fracture is likely to occur within the API, i.e., a substantially cohesive failure. With the superbonding layer in place, the API becomes substrate-agnostic. Stated differently, no matter what the glass substrate is, what its surface treatment is, what its surface properties are, what its physical characteristics are, what its contours are, the superbonding layer directs the laminate failure to a cohesive failure, that is, within the API (TAPI or the BAPI, depending upon the embodiment).

In one embodiment, the present invention relates to a laminate structure comprising a stack of at least one glass substrate and an adhesive polymeric interlayer (API) that comprises cohesive debonding zones that are substantially discrete and/or substantially continuous in their layout Such debonding zones are located preferably within the 10% thickness of API from the interface of said API and the glass substrate. These zones allow for a unique combination of modified API-glass debonding, laminate toughness, and laminate durability. Moreover, a submicron thick superbonding layer is provided in between the glass substrate and the API such that the superbonding layer's adhesion to the glass substrate is substantially greater than its adhesion to the API. Various spatial patterns and densities of debonding are described, as well as the resulting material properties.

In one embodiment, this invention relates to a laminate structure comprising a stack of at least one glass substrate adhered to an adhesive polymeric interlayer. The interfacial region or zone of the adhesive polymeric interlayer (API) comprises discrete and/or continuous debonding zones.

As discussed previously, the cohesive discrete debonding zones are substantially discrete, that is, the zones, which may or may not cover generally the entire area of the adhesive polymeric interlayer (API), in the planar direction, are substantially separate from each other with defined boundaries. The likely random imperfections in discreteness of the zones given the limitations of the materials, and/or the process of making the materials—for example, two zones that are substantially discrete may “bleed into” each other, de minimis—are acknowledged in the present invention. The discrete zones may be co-planar or may not be co-planar. The discrete zones in a given plane may be co-planar to at least one of the glass substrate, or to the API layer. The cohesive discrete debonding zones are different from the API in at least one physical and/or one chemical characteristic.

In a preferred embodiment, in the 10% thickness of the API starting from the glass substrate, are found discrete and/or continuous debonding zones, which are explained supra. The debonding zones act as reservoirs to dissipate fracture energy, for example, upon impact. Because the debonding zones reside in the 10% thickness of the API, the fracture is likely to be a cohesive failure, being guided or controlled by the debonding zones.

In one embodiment, this invention relates to a laminate structure comprising a stack of at least one glass substrate adhered to an adhesive polymeric interlayer. The interfacial region or zone of the adhesive polymeric interlayer (API) comprises discrete and/or continuous debonding zones.

As discussed previously, the cohesive discrete debonding zones are substantially discrete, that is, the zones, which may or may not cover generally the entire area of the adhesive polymeric interlayer (API), in the planar direction, are substantially separate from each other with defined boundaries. The likely random imperfections in discreteness of the zones given the limitations of the materials, and/or the process of making the materials—for example, two zones that are substantially discrete may “bleed into” each other, de minimis—are acknowledged in the present invention. The discrete zones may be co-planar or may not be co-planar. The discrete zones in a given plane may be co-planar to at least one of the glass substrate, or to the API layer. The cohesive discrete debonding zones are different from the API in at least one physical and/or one chemical characteristic.

Some of the embodiments are described in the figures below.

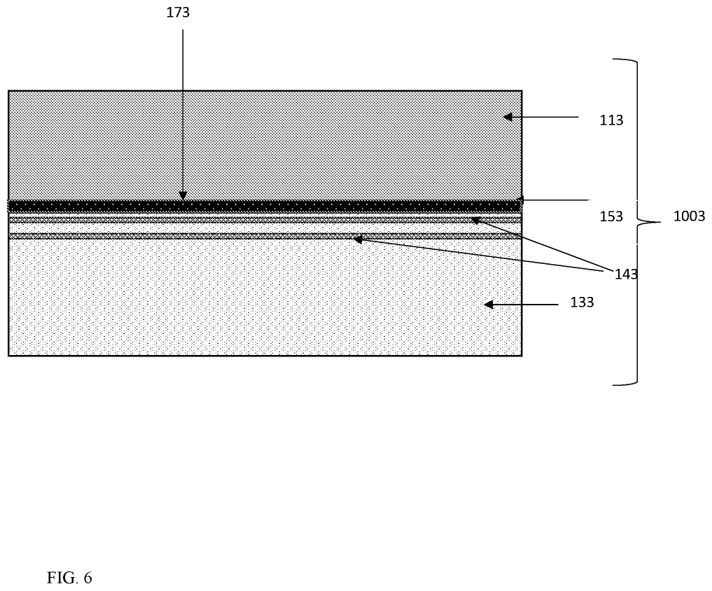

FIG. 6 depicts an embodiment of the second embodiment of the present invention wherein only one glass substrate (113) adheres to the adhesive polymeric interlayer (133), which comprises a submicron superbonding layer (173) to form the stack (1003). The adhesive polymeric interlayer (API; 133) below the sub-micron superbonding layer comprises continuous debonding zones (143) and begins at the interface (153) of the sub-micron superbonding layer (173) and the glass substrate (113) and extends about 10% in thickness into the API. The debonding zone's (143) thickness is much lower than the thickness of the API (133). While the API comprises the superbonding layer, the debonding zones are within the API and not in the superbonding layer.

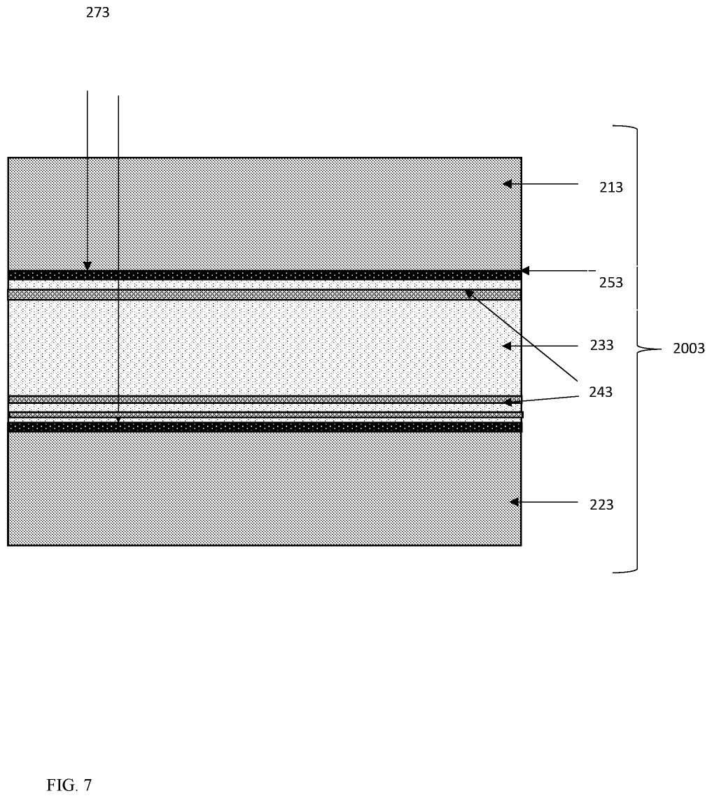

FIG. 7 depicts an embodiment of the second embodiment of the present invention wherein two one glass substrates (213 and 223) adhere to the adhesive polymeric interlayer (233), which comprises a submicron superbonding layer (173) one or both of its interfaces with the glass substrates (although the discussion herein is regarding only one) to form the stack (2003). The adhesive polymeric interlayer (API; 233) below the sub-micron superbonding layer comprises continuous debonding zones (243) and begins at the interface (253) of the sub-micron superbonding layer (273) and the glass substrate (213) and extends about 10% in thickness into the API. The debonding zone's (243) thickness is much lower than the thickness of the API (233). While the API comprises the superbonding layer, the debonding zones are within the API and not in the superbonding layer.

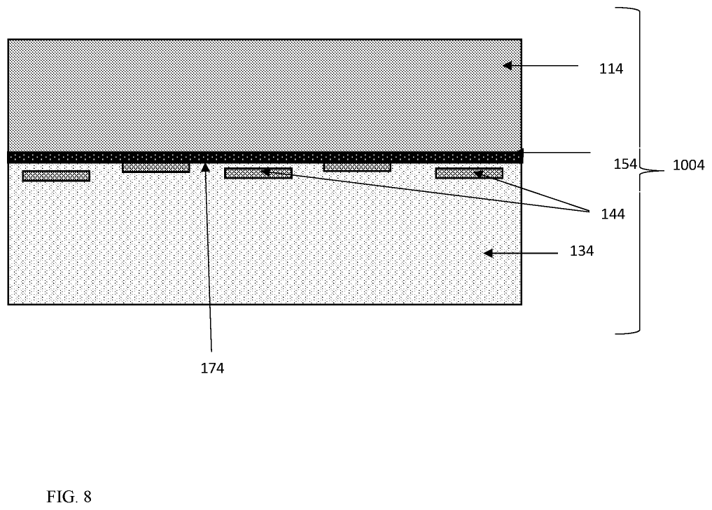

FIG. 8 depicts an embodiment of the second embodiment of the present invention wherein only one glass substrate (114) adheres to the adhesive polymeric interlayer (134), which comprises a submicron superbonding layer (174) to form the stack (1004). The adhesive polymeric interlayer (API; 134) below the sub-micron superbonding layer comprises discrete debonding zones (144) and begins at the interface (154) of the sub-micron superbonding layer (174) and the glass substrate (114) and extends about 10% in thickness into the API. The debonding zone's (144) thickness is much lower than the thickness of the API (134). While the API comprises the superbonding layer, the debonding zones are within the API and not in the superbonding layer.

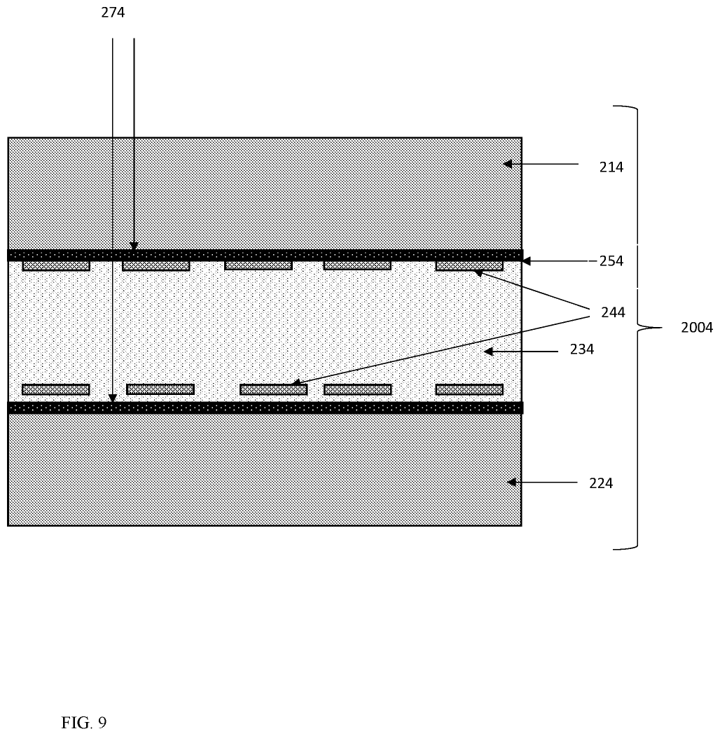

FIG. 9 depicts an embodiment of the second embodiment of the present invention wherein two one glass substrates (214 and 224) adhere to the adhesive polymeric interlayer (234), which comprises a submicron superbonding layer (174) one or both of its interfaces with the glass substrates (although the discussion herein is regarding only one) to form the stack (2004). The adhesive polymeric interlayer (API; 234) below the sub-micron superbonding layer comprises discrete debonding zones (244) and begins at the interface (254) of the sub-micron superbonding layer (274) and the glass substrate (214) and extends about 10% in thickness into the API. The debonding zone's (244) thickness is much lower than the thickness of the API (234). While the API comprises the superbonding layer, the debonding zones are within the API and not in the superbonding layer.

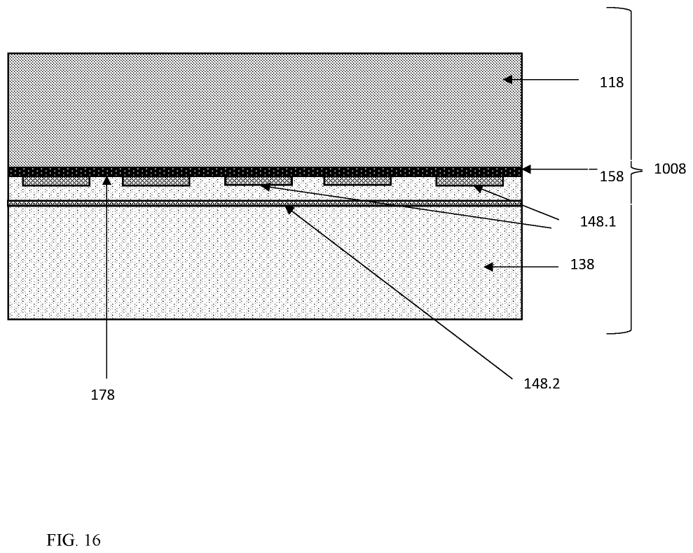

FIG. 16 depicts an embodiment of the second embodiment of the present invention wherein only one glass substrate (118) adheres to the adhesive polymeric interlayer (138), which comprises a submicron superbonding layer (178) to form the stack (1008). The adhesive polymeric interlayer (API; 138) below the sub-micron superbonding layer comprises discrete debonding zones (148.1) and continuous debonding zones (148.2) and begins at the interface (158) of the submicron superbonding layer (178) and the glass substrate (118) and extends about 10% in thickness into the API. The debonding zone's (148) thickness is much lower than the thickness of the API (138). While the API comprises the superbonding layer, the debonding zones are within the API and not in the superbonding layer.

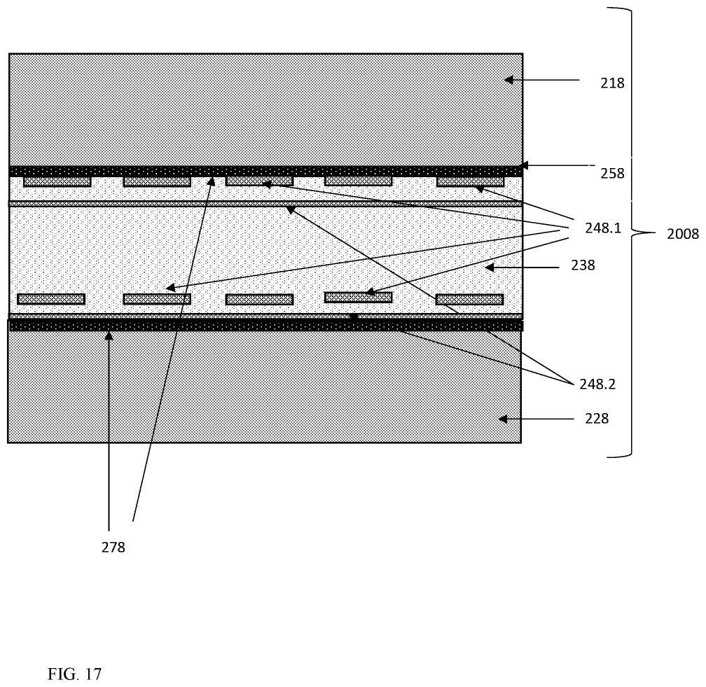

FIG. 17 depicts an embodiment of the second embodiment of the present invention wherein two one glass substrates (218 and 228) adhere to the adhesive polymeric interlayer (238), which comprises a submicron superbonding layer (178) on one or both of its interfaces with the glass substrates (although the discussion herein is regarding only one) to form the stack (2008). The adhesive polymeric interlayer (API; 238) below the sub-micron superbonding layer comprises discrete debonding zones (248.1) or continuous debonding zones (248.2) and begins at the interface (258) of the sub-micron superbonding layer (278) and the glass substrate (218) and extends about 10% in thickness into the API. The debonding zone's (248) thickness is much lower than the thickness of the API (238). While the API comprises the superbonding layer, the debonding zones are within the API and not in the superbonding layer.

In one embodiment, the laminate structure can comprise more than one glass substrate and corresponding polymeric interlayers in between. For example, the number of glass substrates can be 1, 2, 3, 4, 5, 6, 7, 8, 9, 10 . . . 20. Similarly, the number of API, in alternation with the glass, or in series with itself, can range from 1-20.

### Third Set of Embodiments

Generally, in this set of embodiments, the laminate structure comprises the composite adhesive interlayer (CAPI), the CAPI interlayer comprising a stack of a first superbonding layer, a first TAPI layer, and a BAPI layer; wherein the first superbonding layer interfaces a first glass substrate on one side and the first TAPI layer on the other side; the first TAPI layer interfacing the first superbonding layer on one side and the BAPI layer on the other side; and the BAPI layer interfacing the first TAPI layer on one side and a second TAPI layer, a second superbonding layer, or a second glass substrate on the other side.

In one embodiment of the first set of embodiments, this invention relates to a laminate structure comprising a stack of at least one glass substrate and a composite adhesive polymeric interlayer (CAPI). The glass substrate adheres to the CAPI. The CAPI comprises three layers: (i) a submicron superbonding layer; (ii) a top adhesive polymeric interlayer (TAPI) and (iii) a bulk or base adhesive polymeric interlayer (BAPI). In this embodiment, the TAPI is adhered to the BAPI. The TAPI, in the aggregate, is different from the BAPI, in the aggregate, in at least one physical and/or one chemical characteristic. The TAPI includes cohesive debonding zones that are substantially discrete and/or substantially continuous in their layout. Preferably, substantially all of the cohesive debonding zones are located within the TAPI.

In another embodiment of the first set, this invention relates to a laminate structure that comprising a stack of a first glass substrate; a composite adhesive polymeric interlayer (CAPI); and a second glass substrate. The first glass substrate adheres to the second glass substrate through the composite adhesive polymeric interlayer (CAPI). The CAPI comprises three layers: a first sub-micron superbonding layer, a top adhesive polymeric interlayer (TAPI) and a base adhesive polymeric interlayer (BAPI). The first TAPI is adhered to the BAPI. The first TAPI, in the aggregate, is different from the BAPI, in the aggregate, in at least one physical and/or one chemical characteristic. The first TAPI includes cohesive debonding zones that are substantially discrete and/or substantially continuous in their layout. Preferably, substantially all of the cohesive discrete debonding zones are located within the first TAPI. At the other end of the BAPI is found (i) a second superbonding layer interposed between the BAPI and the second glass substrate, (ii) a second TAPI layer interposed between the BAPI and the second glass substrate, or (iii) a second TAPI layer with a second sub-micron superbonding layer coated on the TAPI and interposed between the second TAPI and the second glass substrate.

In yet another embodiment of the first set, this invention relates to the laminate structures described above, wherein substantially all of the cohesive discrete and/or continuous debonding zones are located within about a 10% thickness of the composite adhesive polymeric interlayer (CAPI) from the interface of said CAPI and the first glass substrate and/or the second glass substrate, if present. These zones allow for a unique combination of API-glass debonding, laminate toughness, and laminate durability. Various spatial patterns and densities of debonding are described, as well as the resulting material properties.

The core embodiment of the first set of the present invention includes the glass substrate and the composite adhesive polymeric interlayer (CAPI). This invention also envisions a stack comprising one or more than one of each layer, the glass substrate and the CAPI. In one embodiment, the stack comprises the two layers, that could be alternating or placed in a random fashion, with the number of each layer being same or different. So, for example if the glass substrate is represented as An, and the CAPI as Bn, the following exemplary structures and their logical equivalents are envisioned:

A1/B1; A1/B1/A2; A1/B1/B2; A1/B1/B2/A2; A1/B1/A2/B2; A1/B1/B2/B3/A2; A1/B1/B2/A2/B3/A3, and so on and so forth.

In one embodiment, of the multi-layer stack, the end layers of the stack are glass substrates. In another multi-layer stack, the end-layer on one side is the glass substrate and the other side is a CAPI. One such embodiment is described above.

In one embodiment, this invention relates to a laminate structure comprising a stack of at least one glass substrate adhered to a composite adhesive polymeric interlayer (CAPI). The CAPI interlayer comprises three layers, a first sub-micron superbonding layer, a first top adhesive polymeric interlayer (TAPI) and a bulk adhesive polymeric interlayer (BAPI). The first top adhesive polymeric interlayer, which is a component of the CAPI, comprises discrete and/or continuous debonding zones, optionally coplanar to the CAPI, TAPI, BAPI, and/or to one or more of the glass substrates. The first TAPI layer is different from the BAPI in at least one physical and/or one chemical characteristic. The CAPI can further comprise a second TAPI and/or a second sub-micron superbonding layers.

In one embodiment, this invention relates to a laminate structure comprising a stack of two glass substrates adhered to each other through an adhesive polymeric interlayer. The interfacial region or zone of the adhesive polymeric interlayer (API) comprises cohesive debonding zones discrete and/or continuous. In one embodiment, such cohesive discrete and/or continuous debonding zones are coplanar to the API or to both glass substrates. The cohesive discrete and/or continuous debonding zones are different from the API in at least one physical and/or one chemical characteristic. Embodiments described below use a two-glass substrate with one API layer, but only as an example. It is understood that the description applies to multiple glass substrates with corresponding multiple API layers.

As discussed previously, the cohesive discrete debonding zones are substantially discrete, that is, the zones, which may or may not cover generally the entire area of the top adhesive polymeric interlayer (TAPI), in the planar direction, are substantially separate from each other with defined boundaries. The likely random imperfections in discreteness of the zones given the limitations of the materials, and/or the process of making the materials—for example, two zones that are substantially discrete and/or continuous may “bleed into” each other, de minimis—are acknowledged in the present invention. The discrete zones may be co-planar or may not be co-planar. The cohesive discrete debonding zones are different from the API in at least one physical and/or one chemical characteristic.

The above embodiments are illustrated in the following figures.

In one embodiment, the laminate structure can comprise more than one glass substrate and corresponding polymeric interlayers in between. For example, the number of glass substrates can be 1, 2, 3, 4, 5, 6, 7, 8, 9, 10 . . . 20. Similarly, the number of API, in alternation with the glass, or in series with itself, can range from 1-20.

Embodiments described below use a two-glass substrate with one API layer, but only as an exemplar. It is understood that the description applies to multiple glass substrates with corresponding multiple API layers.

In one embodiment, this invention relates to a laminate structure comprising a stack of two glass substrates adhered to each other through an adhesive polymeric interlayer. The interfacial region or zone of the adhesive polymeric interlayer (API) comprises cohesive discrete and/or continuous debonding zones. In one embodiment, such cohesive discrete and/or continuous debonding zones are coplanar to the API or to both glass substrates. The cohesive discrete and/or continuous debonding zones are different from the API in at least one physical and/or one chemical characteristic.

The above embodiments are described in the drawings below.

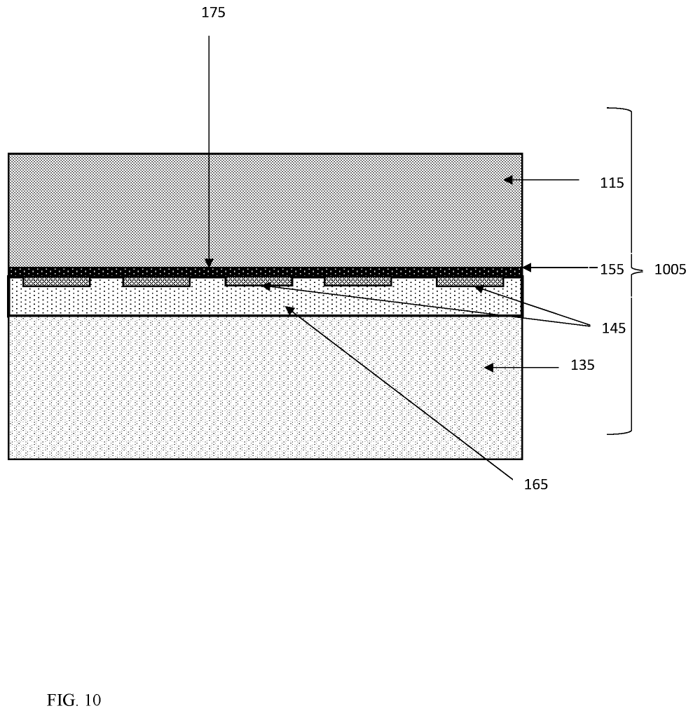

FIG. 10 depicts an embodiment of the present invention wherein only one glass substrate (115) adheres to the composite adhesive polymeric interlayer, which comprises the top adhesive interlayer (TAPI; 166) and the bulk adhesive interlayer (BAPI; 135). The API further comprises a submicron superbonding layer (175) on top of the TAPI (165) to form the stack (1005). Generally speaking, the TAPI layer thickness is much lower than the thickness of the BAPI. The top adhesive polymeric interlayer (TAPI; 165) comprises discrete debonding zones (145) and begins at the interface (155) of the TAPI (165) and the glass substrate (115) and extends about 10% in thickness into the API. The debonding zone's (145) thickness is much lower than the thickness of the API (TAPI+BAPI; 165+135).

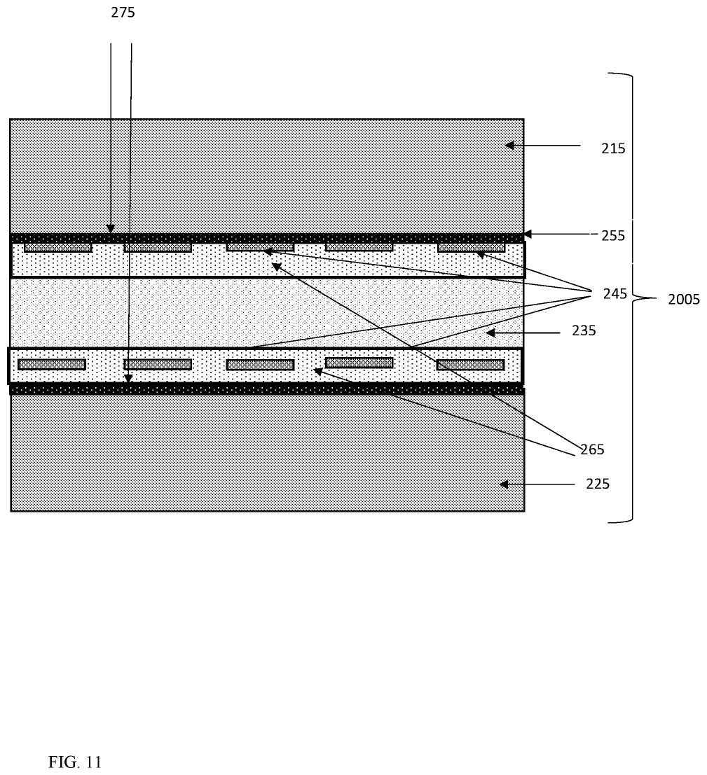

FIG. 11 depicts an embodiment of the present invention wherein two glass substrates (215 and 225) adhere to the composite adhesive polymeric interlayer, which comprises the top adhesive interlayer (TAPI; 266) and the bulk adhesive interlayer (BAPI; 235). The API further comprises a submicron superbonding layer (275) on top of the TAPI (265) to form the stack (2005). Generally speaking, the TAPI layer thickness is much lower than the thickness of the BAPI. The top adhesive polymeric interlayer (TAPI; 265) comprises discrete debonding zones (245) and begins at the interface (255) of the TAPI (265) and the glass substrate (115) and extends about 10% in thickness into the API. The debonding zone's (245) thickness is much lower than the thickness of the API (TAPI+BAPI; 265+235). FIG. 11 shows two TAPIs and correspondingly, discrete debonding zones in each. Each TAPI can be 10% or less in thickness of the CAPI and the two TAPIs.

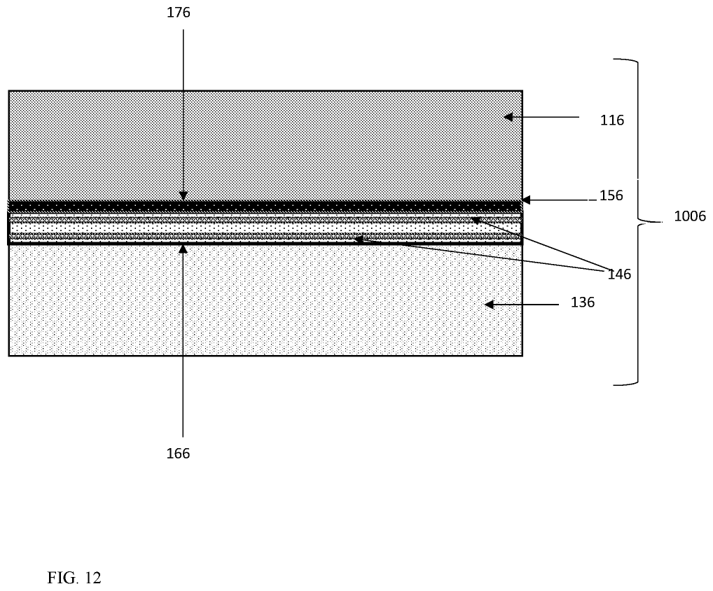

FIG. 12 depicts an embodiment of the present invention wherein only one glass substrate (116) adheres to the composite adhesive polymeric interlayer, which comprises the top adhesive interlayer (TAPI; 166) and the bulk adhesive interlayer (BAPI; 136). The API further comprises a submicron superbonding layer (176) on top of the TAPI (166) to form the stack (1006). Generally speaking, the TAPI layer thickness is much lower than the thickness of the BAPI. The top adhesive polymeric interlayer (TAPI; 166) comprises continuous debonding zones (146) and begins at the interface (156) of the TAPI (166) and the glass substrate (116) and extends about 10% in thickness into the API. The debonding zone's (146) thickness is much lower than the thickness of the API (TAPI+BAPI; 166+136).

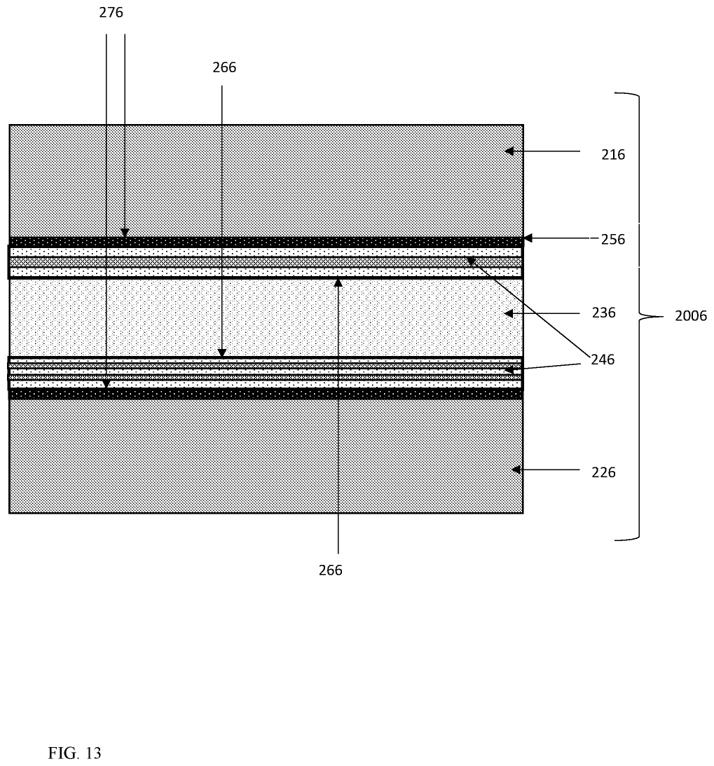

FIG. 13 depicts an embodiment of the present invention wherein two glass substrates (216 and 226) adhere to the composite adhesive polymeric interlayer, which comprises the top adhesive interlayer (TAPI; 266) and the bulk adhesive interlayer (BAPI; 236). The API further comprises a submicron superbonding layer (275) on top of the TAPI (265) to form the stack (2006). Generally speaking, the TAPI layer thickness is much lower than the thickness of the BAPI. The top adhesive polymeric interlayer (TAPI; 266) comprises continuous debonding zones (246) and begins at the interface (256) of the TAPI (266) and the glass substrate (115) and extends about 10% in thickness into the API. The debonding zone's (245) thickness is much lower than the thickness of the API (TAPI+BAPI; 266+236). FIG. 13 shows two TAPIs and correspondingly, discrete debonding zones in each. Each TAPI can be 10% or less in thickness of the CAPI and the two TAPIs.

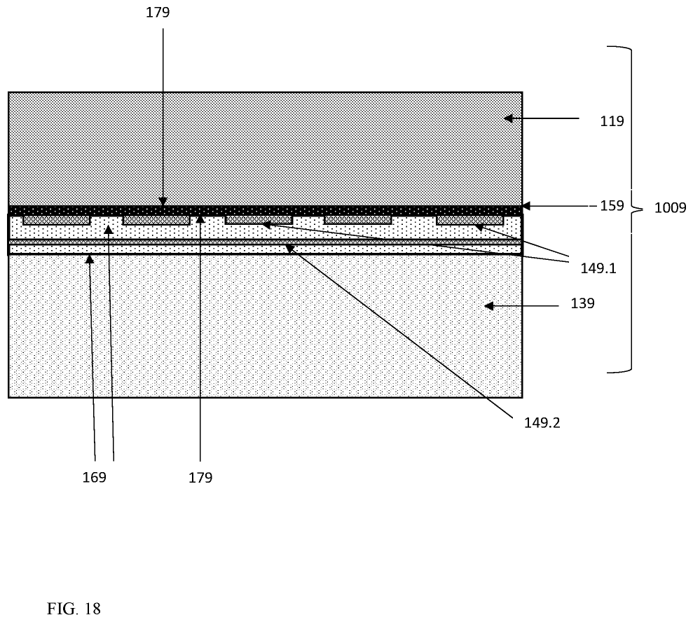

FIG. 18 depicts an embodiment of the present invention wherein only one glass substrate (119) adheres to the composite adhesive polymeric interlayer, which comprises the top adhesive interlayer (TAPI; 169) and the bulk adhesive interlayer (BAPI; 139). The API further comprises a submicron superbonding layer (179) on top of the TAPI (169) to form the stack (1009). Generally speaking, the TAPI layer thickness is much lower than the thickness of the BAPI. The top adhesive polymeric interlayer (TAPI; 169) comprises discrete debonding zones (149.1) and continuous debonding zones (149.2) and begins at the interface (159) of the TAPI (169) and the glass substrate (119) and extends about 10% in thickness into the API. The debonding zone's (149) thickness is much lower than the thickness of the API (TAPI+BAPI; 169+139).

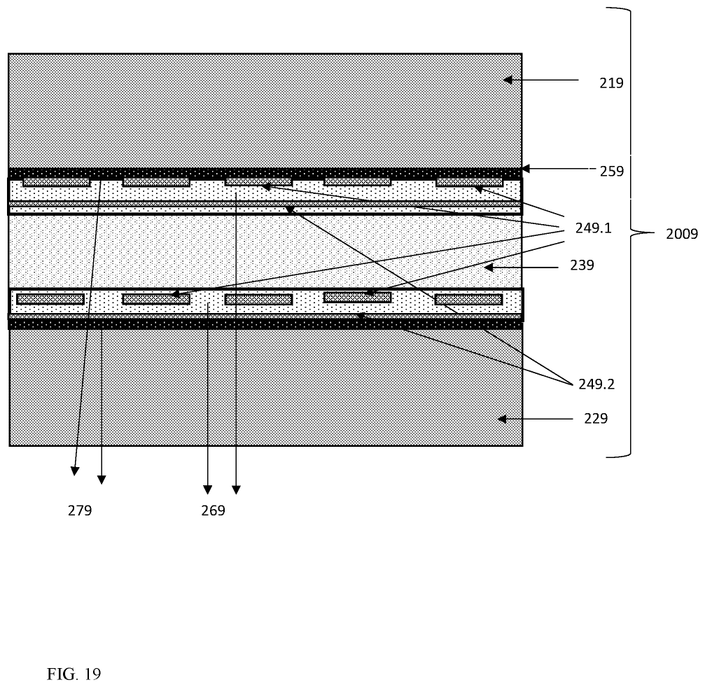

FIG. 19 depicts an embodiment of the present invention wherein two glass substrates (219 and 229) adhere to the composite adhesive polymeric interlayer, which comprises the top adhesive interlayer (TAPI; 269) and the bulk adhesive interlayer (BAPI; 239). The API further comprises a submicron superbonding layer (279) on top of the TAPI (269) to form the stack (2009). Generally speaking, the TAPI layer thickness is much lower than the thickness of the BAPI. The top adhesive polymeric interlayer (TAPI; 269) comprises discrete debonding zones (249.1) and continuous debonding zones (249.2) and begins at the interface (259) of the TAPI (269) and the glass substrate (119) and extends about 10% in thickness into the API. The debonding zone's (249) thickness is much lower than the thickness of the API (TAPI+BAPI; 269+239). FIG. 19 shows two TAPIs and correspondingly, discrete debonding zones in each. Each TAPI can be 10% or less in thickness of the CAPI and the two TAPIs.

### Materials

### Poly(Vinyl)Acetal Resin

In accordance with the present invention, there is provided herein a plasticized polyvinyl acetal composition, preferably a polyvinyl butyral composition, wherein the composition comprises (a) a polyvinyl acetal resin having a hydroxyl number of from about 12 to about 34, preferably of from about 15 to about 34, as determined according to ASTM D1396-92; (b) a plasticizer in an amount of from about 20, or from about 30, to about 60, or to about 50, parts per hundred (pph), based on the dry weight of the polyvinyl acetal resin; and (c) a light stabilizer/antioxidant additive package comprising an oligomeric hindered amine light stabilizer with antioxidant functionality (HALS); wherein substantially no additional antioxidant is present. It is further provided that the plasticized polyvinyl acetal composition is a plasticized polyvinyl butyral composition. Additionally, sheets comprising the plasticized polyvinyl acetal composition, as well as laminates comprising said sheets, are provided herein.

Suitable polyvinyl acetal resins and processes for their preparation are in a general sense well known to those of ordinary skill in the relevant art, as exemplified by previously incorporated U.S. Pat. No. 8,329,793B2, US2016/0214354A1, US2016/0214352A1, US2017/0253704A1, US2017/0072665A1 and US2017/0217132A1, and other publications mentioned below. These resins show, for example, acceptable impact strength per end-use standards, acceptable adhesion, low color, low haze, and relatively little change in end-use conditions.

The polyvinyl acetal resin can be produced by conventionally known methods of acetalization of polyvinyl alcohol with an aldehyde. The polyvinyl alcohol is produced by hydrolysis of a corresponding polyvinyl acetate.

A viscosity average polymerization degree of polyvinyl alcohol serving as a raw material of the polyvinyl acetal resin is typically 100 or more, or 300 or more, or 400 or more, or 600 or more, or 700 or more, or 750 or more, or 900 or more, or 1200 or more. When the viscosity average polymerization degree of polyvinyl alcohol is too low, there is a concern that the penetration resistance or creep resistance properties, particularly creep resistance properties under high-temperature and high-humidity conditions, such as those at 85° C. and at 85% RH, are lowered. In addition, the viscosity average polymerization degree of polyvinyl alcohol is typically 5000 or less, or 3000 or less, or 2500 or less, or 2300 or less, or 2000 or less. When the viscosity average polymerization degree of polyvinyl alcohol is more than 5000, there is a concern that the extrusion of a resin film is difficult.

It is to be noted that since the viscosity average polymerization degree of the polyvinyl acetal resin coincides with the viscosity average polymerization degree of polyvinyl alcohol serving as a raw material, the above-described preferred viscosity average polymerization degree of polyvinyl alcohol coincides with the typical viscosity average polymerization degree of the polyvinyl acetal resin.

The polyvinyl acetal resin is generally constituted of vinyl acetal units, vinyl alcohol units and vinyl acetate units, and these respective units can be, for example, measured by the “Testing Methods for Polyvinyl Butyral” of JIS K 6728, or a nuclear magnetic resonance method (NMR).

Typically, a polyvinyl acetal resin is used having a hydroxyl number of from about 12 to about 34, preferably of from about 15 to about 34 (as determined according to ASTM D1396-92).

In the case where the polyvinyl acetal resin contains a unit other than the vinyl acetal unit, by measuring a unit quantity of vinyl alcohol and a unit quantity of vinyl acetate and subtracting these both unit quantities from a vinyl acetal unit quantity in the case of not containing a unit other than the vinyl acetal unit, the remaining vinyl acetal unit quantity can be calculated.

The aldehyde which is used for acetalization of polyvinyl alcohol is preferably an aldehyde having 1 or more and 12 or less carbon atoms. When the carbon number of the aldehyde is more than 12, the reactivity of the acetalization is lowered, and moreover, blocking of the resin is liable to be generated during the reaction, and the synthesis of the polyvinyl acetal resin is liable to be accompanied with difficulties.

The aldehyde is not particularly limited, and examples thereof include aliphatic, aromatic, or alicyclic aldehydes, such as formaldehyde, acetaldehyde, propionaldehyde, n-butyl aldehyde, isobutyl aldehyde, valeraldehyde, n-hexyl aldehyde, 2-ethylbutyl aldehyde, n-heptyl aldehyde, n-octyl aldehyde, n-nonyl aldehyde, n-decyl aldehyde, benzaldehyde, cinnamaldehyde, etc. Of those, aliphatic aldehydes having 2 or more and 6 or less carbon atoms are preferred, and above all, butyl aldehyde is especially preferred. In addition, the above-described aldehydes may be used solely or may be used in combination of two or more thereof. Furthermore, a small amount of a polyfunctional aldehyde or an aldehyde having other functional group, or the like may also be used in combination in an amount in the range of 20% by mass or less.

The polyvinyl acetal resin is most preferably polyvinyl butyral.

### Plasticizers for Poly(Vinyl)Acetal Resins

The polyvinyl acetal resin compositions of the present invention contain a plasticizer. Suitable plasticizers can be chosen from any that are known or used conventionally in the manufacture of plasticized PVB sheeting compositions. For example, a plasticizer suitable for use herein can be a plasticizer or a mixture of plasticizers selected from the group consisting of: diesters obtained from the chemical reaction of aliphatic diols with carboxylic acids, including diesters of polyether diols or polyether polyols; and esters obtained from polyvalent carboxylic acids and aliphatic alcohols. For convenience, when describing the sheet compositions of the present invention, a mixture of plasticizers can be referred to herein as “plasticizer”. That is, the singular form of the word “plasticizer” as used herein can represent the use of either one plasticizer or the use of a mixture of two or more plasticizers in a given sheet composition. The intended use will be apparent to a reader skilled in the art. Preferred plasticizers for use herein are diesters obtained by the reaction of triethylene glycol or tetraethylene glycol with aliphatic carboxylic acids having from 6 to 10 carbon atoms; and diesters obtained from the reaction of sebacic acid with aliphatic alcohols having from 1 to 18 carbon atoms. More preferably the plasticizer is either tetraethylene glycol di(2-heptanoate) (4G7), triethyleneglycol di-(2-ethyl hexanoate) (3GO), dihexyl adipate (DHA), triethylene glycol di(2-ethylbutyrate (3GH) or dibutyl sebacate (DBS). Most preferably the plasticizer is 3GO.

### Optional Additives for Poly(Vinyl)Acetal Resins

The poly(vinyl) acetal resins of present invention may include a surfactant. A surfactant suitable for use herein can be any that is known to be useful in the art of polyvinyl acetal manufacture. For example, surfactants suitable for use herein include: sodium lauryl sulfate; ammonium lauryl sulfate; sodium dioctyl sulfosuccinate; ammonium perfluorocarboxylates having from 6 to 12 carbon atoms; sodium aryl sulfonates, adducts of chlorinated cyclopentadiene and maleic anhydride; partially neutralized polymethacrylic acid; alkylaryl sulfonates; sodium N-oleyl-N-methyl laurate; sodium alkylaryl polyether sulfonates; triethanolamine lauryl sulfate; diethyl dicyclohexyl ammonium lauryl sulfate; sodium secondary-alkyl sulfates; sulfated fatty acid esters; sulfated aryl alcohols; and the like. Preferable surfactants include sodium lauryl sulfate, sodium dioctyl sulfosuccinate, sodium cocomethyl tauride, and decyl(sulfophenoxy)benzenesulfonic acid disodium salt. It has been found that sodium dodecyl sulfate (SDS) and sodium lauryl sulfate (SLS) are particularly useful.

The surfactant can be included in any effective amount for the particular set of process conditions practiced. The surfactant can be included in an amount of from about 0.01, or from about 0.10, or from about 0.15, to about 0.85, or to about 0.80, or to about 0.75, or to about 0.70, pph by weight, based on the weight of polyvinyl acetate resin ultimately used to prepare the polyvinyl acetal.

In addition, it is also possible to control the adhesion of the resulting laminate to a glass or the like, if desired, through the addition of one or more adhesion modifier. Typical adhesion modifiers include, for example, those disclosed in International Patent Application Publication No. WO03/033583A1. Alkali metal salts and alkaline earth metal salts are typically used, for example, salts of potassium, sodium, magnesium, and the like. Examples of the salt include salts of organic acids, such as octanoic acid, hexanoic acid, butyric acid, acetic acid, and formic acid; inorganic acids, such as hydrochloric acid and nitric acid; and the like. Magnesium compounds are preferred.

### Ionomer

In accordance with the present invention, the ionomer resin is a sodium-neutralized ethylene-α,β-unsaturated carboxylic acid copolymer, which includes resins having constituent units derived from ethylene, constituent units derived from an α,β-unsaturated carboxylic acid and optionally other constituent units as described below, in which at least a part of the constituent units derived from the α,β-unsaturated carboxylic acid are neutralized with a sodium ion.

In the ethylene-α,β-unsaturated carboxylic acid copolymer serving as a base polymer, a content proportion of the constituent units derived from an α,β-unsaturated carboxylic acid is typically 2% by mass or more, or 5% by mass or more (based on total copolymer mass). In addition, the content proportion of the constituent units derived from an α,β-unsaturated carboxylic acid is typically 30% by mass or less (based on total copolymer mass).

Examples of the α,β-unsaturated carboxylic acid constituting the ionomer include, without limitation, acrylic acid, methacrylic acid, itaconic acid, maleic acid, fumaric acid, and mixtures of two or more thereof. In one embodiment, the α,β-ethylenically unsaturated carboxylic acid is selected from acrylic acid, methacrylic acid, and mixtures thereof. In another embodiment, the α,β-ethylenically unsaturated carboxylic acid is methacrylic acid.

The ethylene acid copolymer may further comprise copolymerized units of one or more additional comonomer(s), such as an α,β-ethylenically unsaturated carboxylic acid ester. When present, alkyl esters having 3 to 10, or 3 to 8 carbons, are typically used. Specific examples of suitable esters of unsaturated carboxylic acids include, without limitation, methyl acrylate, methyl methacrylate, ethyl acrylate, ethyl methacrylate, propyl acrylate, propyl methacrylate, isopropyl acrylate, isopropyl methacrylate, n-butyl acrylate, n-butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, dimethyl maleate, diethyl maleate, dibutyl maleate, dimethyl fumarate, diethyl fumarate, dibutyl fumarate, dimethyl fumarate, vinyl acetate, vinyl propionate, and mixtures of two or more thereof. In one embodiment, the additional comonomers are selected from methyl acrylate, methyl methacrylate, n-butyl acrylate, n-butyl methacrylate, isobutyl acrylate, isobutyl methacrylate, glycidyl methacrylate, vinyl acetate, and mixtures of two or more thereof. In another embodiment, the additional comonomer is one or more of n-butyl acrylate, n-butyl methacrylate, isobutyl acrylate and isobutyl methacrylate. In another embodiment, the additional comonomer is one or both of n-butyl acrylate and isobutyl acrylate.

Suitable ethylene acid copolymers have a melt flow rate (MFR) of from about 1, or from about 2, to about 4000 g/10 min, or to 1000 g/10 min, or to about 400 g/10 min, as determined in accordance with ASTM method D1238-89 at 190° C. and 2.16 kg.

Finally, suitable ethylene acid copolymers may be synthesized as described, for example, in U.S. Pat. Nos. 3,404,134, 5,028,674, 6,500,888, 6,518,365, 8,334,033 and 8,399,096. In one embodiment, a method described in U.S. Pat. No. 8,399,096 is used, and a sufficiently high level and complementary amount of the derivative of the second α,β-ethylenically unsaturated carboxylic acid is present in the reaction mixture.

To obtain the ionomers, the ethylene acid copolymers are partially neutralized by reaction with one or more bases. An example of a suitable procedure for neutralizing the ethylene acid copolymers is described in U.S. Pat. Nos. 3,404,134 and 6,518,365. After neutralization, about 1%, or about 10%, or about 15%, or about 20%, to about 90%, or to about 60%, or to about 55%, or to about 30%, of the hydrogen atoms of carboxylic acid groups present in the ethylene acid copolymer are replaced by other cations. Stated alternatively, about 1%, or about 10%, or about 15%, or about 20%, to about 90%, or to about 60%, or to about 55%, or to about 30%, of the total content of the carboxylic acid groups present in the ethylene acid copolymer are neutralized. In another alternative expression, the acid groups are neutralized to a level of about 1%, or about 10%, or about 15%, or about 20%, to about 90%, or to about 60%, or to about 55%, or to about 30%, based on the total content of carboxylic acid groups present in the ethylene acid copolymers as calculated or measured for the non-neutralized ethylene acid copolymers. The neutralization level can be tailored for the specific end-use.

The counterions to the carboxylate anions in the ionomer are sodium cations. While ionomers used in the present invention are sodium-neutralized ionomers, counterions other than sodium cations may be present in small amounts of less than 5 equivalent %, or less than 3 equivalent %, or less than 2 equivalent %, or less than 1 equivalent %, based on the total equivalents of carboxylate groups in the ionomer. In one embodiment, the counterions are substantially sodium ions.

Suitable cations other than sodium include any positively charged species that is stable under the conditions in which the ionomer composition is synthesized, processed, and used. Suitable cations may be used in combinations of two or more. Typically, such other cations are metal cations, which may be monovalent, divalent, trivalent, or multivalent. Monovalent metal cations include but are not limited to cations of potassium, lithium, silver, mercury, copper, and the like. Divalent metal cations include but are not limited to cations of beryllium, magnesium, calcium, strontium, barium, copper, cadmium, mercury, tin, lead, iron, cobalt, nickel, zinc, and the like. Trivalent metal cations include but are not limited to cations of aluminum, scandium, iron, yttrium, and the like. Multivalent metal cations include but are not limited to cations of titanium, zirconium, hafnium, vanadium, tantalum, tungsten, chromium, cerium, iron, and the like. When the metal cation is multivalent, complexing agents such as stearate, oleate, salicylate, and phenolate radicals may be included, as described in U.S. Pat. No. 3,404,134. Typically, when present, the metal cations used are monovalent or divalent metal cations, such as lithium, magnesium, zinc, potassium, and combinations of one or more of these metal cations.

In one embodiment, counterions other than sodium are present in at most “contaminant” amounts, as one would typically find in industrial situations, as would be recognized by persons of ordinary skill in the relevant art.

The resulting sodium-neutralized ethylene acid copolymer has a melt index, as determined in accordance with ASTM method D1238-89 at 190° C. and 2.16 kg, that is lower than that of the corresponding ethylene acid copolymer. The ionomer's melt index depends on a number of factors, including the melt index of the ethylene acid copolymer, the amount of copolymerized acid, the neutralization level, the identity of the cation and its valency. Moreover, the desired value of the ionomer's melt index may be determined by its intended end use. Typically, however, the ionomer has a melt index of about 1000 g/10 min or less, or about 750 g/10 min or less, or about 500 g/10 min or less, or about 250 g/10 min or less, or about 100 g/10 min or less, or about 50 g/10 min or less, or about 25 g/10 min or less, or about of 20 g/10 min or less, or about 10 g/10 min or less, or about 7.5 g/10 min or less, as determined in accordance with ASTM method D1238-89 at 190° C. and 2.16 kg.

In one embodiment, the ionomer is an at least partially sodium-neutralized ethylene acid dipolymer comprising (consisting essentially of) copolymerized units of:
(i) ethylene, and
(ii) from about 10 wt. %, or from about 15 wt. %, or from about 18 wt. %, or from about 20 wt. %, to about 30 wt. %, or to about 25 wt. %, or to about 23 wt. % or to about 22 wt. %, of at least one α,β-unsaturated carboxylic acid having 3 to 10 carbon atoms,
wherein the weight percentages of the copolymerized units are based on the total weight of the ethylene acid copolymer and the sum of the weight percentages of the copolymerized units is 100 wt. %, and wherein at least a portion of carboxylic acid groups of the α,β-unsaturated carboxylic acid are neutralized to form an ionomer comprising carboxylate groups having sodium counterions.

In one embodiment, the ionomer is an at least partially sodium-neutralized ethylene acid terpolymer comprising copolymerized units of:
(i) ethylene,
(ii) from about 10 wt. %, or from about 15 wt. %, or from about 18 wt. %, or from about 20 wt. %, to about 30 wt. %, or to about 25 wt. %, or to about 23 wt. % or to about 22 wt. %, of at least one α,β-unsaturated carboxylic acid having 3 to 10 carbon atoms,
(iii) from about 2 wt. %, or from about 3 wt. %, or from about 4 wt. %, or from about 5 wt. %, to about 15 wt. %, or to about 12 wt. %, or to about 11 wt. %, or to about 10 wt. %, of at least one α,β-unsaturated carboxylic acid ester having 3 to 10 carbon atoms, and
(iv) optionally a derivative of an α,β-unsaturated carboxylic acid other than (iii) in an amount such that (iii)+(iv) is about 15 wt. % or less, or about 12 wt. % or less, or about 11 wt. % or less,
wherein the weight percentages of the copolymerized units are based on the total weight of the ethylene acid copolymer and the sum of the weight percentages of the copolymerized units is 100 wt. %, and wherein at least a portion of carboxylic acid groups of the α,β-unsaturated carboxylic acid are neutralized to form an ionomer comprising carboxylate groups having sodium counterions.

Such terpolymer ionomers are generally disclosed in International Patent Application Nos. WO 2015/199750A1 and WO 2014/100313A1, as well as in previously incorporated U.S. Provisional Application Ser. No. 62/333,371 (filed 9 May 2016).

In one embodiment of the dipolymer or terpolymer as described above, the α,β-unsaturated carboxylic acid is methacrylic acid.

In one embodiment of the terpolymer as described above, the α,β-unsaturated carboxylic acid ester is n-butyl acrylate, isobutyl acrylate or a mixture thereof.

In one embodiment of the terpolymer described above, the copolymer consists essentially of copolymerized units of (i), (ii) and (iii).

### Thermoplastic Elastomer

Thermoplastic elastomers can be used in the multilayer polymeric interlayer described above. These materials generally provide polymeric interlayer sheets and laminates comprising these sheets with improved acoustic properties, as described in US Published Patent Application No. 2017/0320297A1. Generally speaking, these materials, also referred to as “elastomers”, generally include materials with soft and hard segments, such as a polystyrene-based elastomer (soft segment: polybutadiene, polyisoprene/hard segment: polystyrene), a polyolefin-based elastomer (soft segment: ethylene propylene rubber/hard segment: polypropylene), a polyvinyl chloride-based elastomer (soft segment: polyvinyl chloride/hard segment: polyvinyl chloride), a polyurethane-based elastomer (soft segment: polyether, polyester, or polycarbonate/hard segment: polyurethane), a polyester-based elastomer (soft segment: aliphatic polyester/hard segment: aromatic polyester), a polyether ester-based elastomer (soft segment: polyether/hard segment: polyester), a polyamide-based elastomer (soft segment: polypropylene glycol, polytetramethylene ether glycol, polyester, or polyether/hard segment: polyamide (such as a nylon resin)), a polybutadiene-based elastomer (soft segment: amorphous butyl rubber/hard segment: syndiotactic 1,2-polybutadiene resin), an acrylic elastomer (soft segment: polyacrylate ester/hard segment: polymethyl methacrylate). It is to be noted that the above-described thermoplastic elastomers may be used solely or may be used in combination of two or more thereof.

A content of the hard segment in the thermoplastic elastomer is preferably about 5% by mass or more, or about 7% by mass or more, or about 8% by mass or more, or about 10% by mass or more, or about 14% by mass or more, or about 16% by mass or more, or about 18% by mass or more, relative to the total amount of the thermoplastic elastomer. A content of the hard segment is preferably about 40% by mass or less, or about 30% by mass or less, or about 20% by mass or less, relative to the total amount of the thermoplastic elastomer. When the content of the hard segment is less than about 5% by mass, there is a tendency for the molding of the layer B to be difficult, the height of the peak of tan δ is small, the flexural rigidity of the laminate is small, or the sound insulating properties in a high-frequency region is lowered. When the content of the hard segment is more than about 40% by mass, there is a tendency for the characteristics of the thermoplastic elastomer to be hardly exhibited, the stability of sound insulating performance is lowered, or the sound insulating characteristics in the vicinity of room temperature are lowered.

A content of the soft segment in the thermoplastic elastomer is preferably about 60% by mass or more, or about 70% by mass or more, or about 80% by mass or more, relative to the total amount of the thermoplastic elastomer. The content of the soft segment is preferably about 95% by mass or less, or about 92% by mass or less, or about 90% by mass or less, or about 88% by mass or less, or about 86% by mass or less, or about 84% by mass or less, or about 82% by mass or less relative to the total amount of the thermoplastic elastomer. When the content of the soft segment is less than about 60% by mass, the characteristics of the thermoplastic elastomer tend to be hardly exhibited. When the content of the soft segment is more than about 95% by mass, there is a tendency that the molding of the layer B is difficult, the height of the peak of tan δ is small, the flexural rigidity of the laminate is small, or the sound insulating properties in a high-frequency region are lowered. Here, in the case where a plurality of the thermoplastic elastomers is mixed, the contents of the hard segment and the soft segment in the thermoplastic elastomer are each considered as an average value of the mixture.

From the viewpoint of making both the moldability and the sound insulating properties compatible with each other, it is more preferred to use a block copolymer having a hard segment and a soft segment as the thermoplastic elastomer. Furthermore, from the viewpoint of further improving the sound insulating properties, it is preferred to use a polystyrene-based elastomer.

In addition, crosslinked rubbers of natural rubber, isoprene rubber, butadiene rubber, chloroprene rubber, nitrile rubber, butyl rubber, ethylene propylene rubber, urethane rubber, silicone rubber, chlorosulfonated polyethylene rubber, acrylic rubber, fluorine rubber, and the like may be used as the thermoplastic elastomer.

The thermoplastic elastomer is preferably a copolymer of an aromatic vinyl monomer and a vinyl monomer or a conjugated diene monomer, or a hydrogenated product of the copolymer. From the viewpoint of making both the function as a rubber exhibiting sound insulating properties and the function as a plastic compatible with each other, the copolymer is preferably a block copolymer having an aromatic vinyl polymer block and an aliphatic unsaturated hydrocarbon polymer block, for example, a polystyrene-based elastomer.

In the case where a copolymer having an aromatic vinyl polymer block and a vinyl polymer block or a conjugated diene polymer block, for example, a block copolymer having an aromatic vinyl polymer block and an aliphatic unsaturated hydrocarbon polymer block is used as the thermoplastic elastomer, the binding form of these polymer blocks is not particularly limited, and it may be any of a linear binding form, a branched binding form, a radial binding form, and a combined binding form of two or more thereof. Of those, a linear binding form is preferred.

When the aromatic vinyl polymer block is expressed as “a”, and the aliphatic unsaturated hydrocarbon polymer block is expressed as “b”, examples of the linear binding form include a diblock copolymer expressed by a-b, a triblock copolymer expressed by a-b-a or b-a-b, a tetrablock copolymer expressed by a-b-a-b, a pentablock copolymer expressed by a-b-a-b-a or b-a-b-a-b, an (a-b)ₙX type copolymer (X represents a coupling residual group, and n represents an integer of 2 or more), and a mixture thereof. Of those, a diblock copolymer or a triblock copolymer is preferred, and the triblock copolymer is more preferably a triblock copolymer expressed by a-b-a.

A sum total of an aromatic vinyl monomer unit and an aliphatic unsaturated hydrocarbon monomer unit in the block copolymer is preferably about 80% by mass or more, or about 95% by mass or more, or about 98% by mass or more relative to the whole of the monomer units. It is to be noted that a part or the whole of the aliphatic unsaturated hydrocarbon polymer blocks in the block copolymer may be hydrogenated.

A content of the aromatic vinyl monomer unit in the block copolymer is preferably about 5% by mass or more, or about 7% by mass or more, or about 8% by mass or more, or about 14% by mass or more, or about 16% by mass or more, or about 18% by mass or more, relative to the whole of the monomer units of the block copolymer. A content of the aromatic vinyl monomer unit is preferably about 40% by mass or less, or about 30% by mass or less, or about 25% by mass or less, or about 20% by mass or less, relative to the whole of the monomer units of the block copolymer.

When the content of the aromatic vinyl monomer unit in the block copolymer is less than about 5% by mass, there is a tendency that the molding of the layer A is difficult, a deviation of glasses is caused due to heat, the height of the peak of tan δ is small, the flexural rigidity of the laminate is small, or the sound insulating properties in a high-frequency region are lowered. When the content of the aromatic vinyl monomer unit in the block copolymer is more than about 40% by mass, there is a tendency that the characteristics as the thermoplastic elastomer are hardly exhibited, or the stability of sound insulating performance is lowered.

The content of the aromatic vinyl monomer unit in the block copolymer can be determined from a charge ratio of the respective monomers in synthesizing the block copolymer, or the measurement results of ¹H-NMR or the like of the block copolymer. Here, in the case where a plurality of the block copolymers is mixed, the content of the aromatic vinyl monomer unit in the block copolymer is considered as an average value of the mixture.

In the aromatic vinyl polymer block, a monomer other than the aromatic vinyl monomer may be copolymerized so long as its amount is small. A proportion of the aromatic vinyl monomer unit in the aromatic vinyl polymer block is preferably about 80% by mass or more, or about 95% by mass or more, or about 98% by mass or more relative to the whole of the monomer units in the aromatic vinyl polymer block.

Examples of the aromatic vinyl monomer constituting the aromatic vinyl polymer block include styrene; alkylstyrenes, such as α-methylstyrene, 2-methylstyrene, 3-methylstyrene, 4-methylstyrene, 4-propylstyrene, 4-cyclohexylstyrene and 4-dodecylstyrene; arylstyrenes, such as 2-ethyl-4-benzylstyrene, 4-(phenylbutyl)styrene, 1-vinylnaphthalene and 2-vinylnaphthalene; halogenated styrenes; alkoxystyrenes; vinylbenzoate esters; and the like. These aromatic vinyl monomers may be used solely or may be used in combination of two or more thereof.

A content of the aliphatic unsaturated hydrocarbon monomer unit in the block copolymer is preferably about 60% by mass or more, or about 70% by mass or more, or about 75% by mass or more, or 80% by mass or more, relative to the whole of the monomer units of the block copolymer. The content of the aliphatic unsaturated hydrocarbon monomer unit in the block copolymer is preferably about 95% by mass or less, or about 92% by mass or less, or about 90% by mass or less, or about 88% by mass or less, or about 86% by mass or less, or about 84% by mass or less, or about 82% by mass or less, relative to the whole of the monomer units of the block copolymer.

When the content of the aliphatic unsaturated hydrocarbon monomer unit in the block copolymer is less than about 60% by mass, there is a tendency that the characteristics as the thermoplastic elastomer are hardly exhibited, or the stability of sound insulating performance is lowered. When the content of the aliphatic unsaturated hydrocarbon monomer unit in the block copolymer is more than about 95% by mass, there is a tendency that the molding of the layer B is difficult, the height of the peak of tan δ is small, the flexural rigidity of the laminate is small, or the sound insulating properties in a high-frequency region are lowered.

The content of the aliphatic unsaturated hydrocarbon monomer unit in the block copolymer can be determined from a charge ratio of the respective monomers in synthesizing the block copolymer, or the measurement results of ¹H-NMR or the like of the block copolymer. Here, in the case where a plurality of the block copolymers is mixed, the content of the aliphatic unsaturated hydrocarbon monomer unit in the block copolymer is considered as an average value of the mixture.

In the aliphatic unsaturated hydrocarbon polymer block, a monomer other than the aliphatic unsaturated hydrocarbon monomer may be copolymerized so long as its amount is small. A proportion of the aliphatic unsaturated hydrocarbon monomer unit in the aliphatic unsaturated hydrocarbon polymer block is preferably about 80% by mass or more, or about 95% by mass or more, or about 98% by mass or more, relative to the whole of the monomer units in the aliphatic unsaturated hydrocarbon polymer block.

Examples of the aliphatic unsaturated hydrocarbon monomer constituting the aliphatic unsaturated hydrocarbon polymer block include ethylene, propylene, 1-butene, 1-pentene, 1-hexene, 1-heptene, 1-octene, 1-nonene, 1-decene, 4-phenyl-1-butene, 6-phenyl-1-hexene, 3-methyl-1-butene, 4-methyl-1-butene, 3-methyl-1-pentene, 4-methyl-1-pentene, 3-methyl-1-hexene, 4-methyl-1-hexene, 5-methyl-1-hexene, 3,3-dimethyl-1-pentene, 3,4-dimethyl-1-pentene, 4,4-dimethyl-1-pentene, vinylcyclohexane, hexafluoropropene, tetrafluoroethylene, 2-fluoropropene, fluoroethylene, 1,1-difluoroethylene, 3-fluoropropene, trifluoroethylene, 3,4-dichloro-1-butene, butadiene, isoprene, dicyclopentadiene, norbornene, acetylene, and the like. These aliphatic unsaturated hydrocarbon monomers may be used solely or may be used in combination of two or more thereof.

From the viewpoints of ease of availability and handling properties, the aliphatic unsaturated hydrocarbon monomer is preferably an aliphatic unsaturated hydrocarbon having 2 or more carbon atoms, or an aliphatic hydrocarbon having 4 or more carbon atoms, and is preferably an aliphatic unsaturated hydrocarbon having 12 or less carbon atoms, or an aliphatic hydrocarbon having 8 or less carbon atoms. Among those, butadiene, isoprene, and a combination of butadiene and isoprene are preferred.

In addition, from the viewpoints of easiness of availability and handling properties as well as easiness of synthesis, the aliphatic unsaturated hydrocarbon monomer is preferably a conjugated diene. From the viewpoint of improving the heat stability, in the case of using a conjugated diene as the constituent unit of the aliphatic unsaturated hydrocarbon polymer block, the conjugated diene is preferably a hydrogenated product resulting from hydrogenating a part or the whole thereof. On that occasion, a hydrogenation ratio is preferably 80% or more, or 90% or more. The hydrogenation ratio as referred to herein is a value obtained by measuring an iodine value of the block copolymer before and after the hydrogenation reaction.

From the viewpoints of mechanical characteristics and molding processability, a weight average molecular weight of the block copolymer is preferably about 30,000 or more, or about 50,000 or more and preferably about 400,000 or less, or about 300,000 or less. A ratio (Mw/Mn) of weight average molecular weight to number average molecular weight of the block copolymer is preferably about 1.0 or more, and preferably about 2.0 or less, or about 1.5 or less. Here, the weight average molecular weight refers to a weight average molecular weight as reduced into polystyrene as determined by the gel permeation chromatography (GPC) measurement, and the number average molecular weight refers to a number average molecular weight as reduced into polystyrene as determined by the GPC measurement.

Though a production method of the block copolymer is not particularly limited, the block copolymer can be, for example, produced by an anionic polymerization method, a cationic polymerization method, a radical polymerization method, or the like. For example, in the case of anionic polymerization, specific examples thereof include:
(i) a method of successively polymerizing an aromatic vinyl monomer, a conjugated diene monomer, and subsequently an aromatic vinyl monomer by using an alkyllithium compound as an initiator;
(ii) a method of successively polymerizing an aromatic vinyl monomer and a conjugated diene monomer by using an alkyllithium compound as an initiator and subsequently adding a coupling agent to undergo coupling;
(iii) a method of successively polymerizing a conjugated diene monomer and subsequently an aromatic vinyl monomer by using a dilithium compound as an initiator; and the like.

In the case of using a conjugated diene as the aliphatic unsaturated hydrocarbon monomer, by adding an organic Lewis base on the occasion of anionic polymerization, a 1,2-bond quantity and a 3,4-bond quantity of the thermoplastic elastomer can be increased, and the 1,2-bond quantity and the 3,4-bond quantity of the thermoplastic elastomer can be easily controlled by the addition amount of the organic Lewis base. By controlling them, the peak temperature or height of tan δ can be adjusted.

Examples of the organic Lewis base include esters, such as ethyl acetate; amines, such as triethylamine, N,N,N′,N′-tetramethylethylenediamine (TMEDA) and N-methylmorpholine; nitrogen-containing heterocyclic aromatic compounds, such as pyridine; amides, such as dimethylacetamide; ethers, such as dimethyl ether, diethyl ether, tetrahydrofuran (THF) and dioxane; glycol ethers, such as ethylene glycol dimethyl ether and diethylene glycol dimethyl ether; sulfoxides, such as dimethyl sulfoxide; ketones, such as acetone and methyl ethyl ketone; and the like.

In the case of subjecting the unhydrogenated polystyrene-based elastomer to a hydrogenation reaction, the hydrogenation reaction can be conducted by dissolving the obtained unhydrogenated polystyrene-based elastomer in a solvent inert to a hydrogenation catalyst, or allowing the unhydrogenated polystyrene-based elastomer to react directly with hydrogen without being isolated from a reaction liquid in the presence of a hydrogenation catalyst. The hydrogenation ratio is preferably about 60% or more, or about 80% or more, or about 90% or more.

Examples of the hydrogenation catalyst include Raney nickel; heterogeneous catalysts in which a metal, such as Pt, Pd, Ru, Rh and/or Ni, is supported on a carrier, such as carbon, alumina and/or diatomaceous earth; Ziegler-based catalysts composed of a combination of a transition metal compound with an alkylaluminum compound and/or an alkyllithium compound; metallocene-based catalysts; and the like. The hydrogenation reaction can be generally conducted under conditions at a hydrogen pressure of about 0.1 MPa or more and about 20 MPa or less and at a reaction temperature of about 20° C. or higher and about 250° C. or lower for a reaction time of about 0.1 hours or more and about 100 hours or less.

In a preferred embodiment, the thermoplastic elastomer has a sea-island phase separated structure in which the hard segment block is included as an island component and the soft segment block is included as a sea component. It has been found that the phase separation size of an island component is sometimes increased in a layer to be used in an interlayer for a laminated glass, and therefore, the interlayer for a laminated glass shrinks when producing a laminated glass or the haze of the laminated glass is decreased, and also found that a laminated glass using an interlayer for a laminated glass having a specific structure has excellent sound insulating properties even when the thickness is reduced and also has low shrinkability.

More specifically in this embodiment, the thermoplastic elastomer includes a hard segment block and a soft segment block, and the layer B has a sea-island phase separated structure in which the hard segment block is included as an island component and the soft segment block is included as a sea component, and when the degree of orientation (1) is defined by the following formula (I) based on the maximum intensity value and the minimum intensity value in an arbitrary azimuth range of 180° including the azimuth at which the intensity reaches the maximum in the azimuthal intensity distribution of periodic scattering or coherent scattering by the hard segment block or the soft segment block obtained for the layer A by small-angle X-ray scattering measurement, the degree of orientation (1) is about 0.9 or less.

Degree of orientation (1)=(maximum intensity value−minimum intensity value)/(maximum intensity value+minimum intensity value) (I)

It is preferred that the degree of orientation (2), as defined by the following formula (II), is about 10 or less.

Degree of orientation (2)=maximum intensity value/minimum intensity value (II)

It is also preferred that, when an island component having a largest major axis size is selected from the island components having a substantially elliptical shape or a substantially continuous linear shape in each phase image obtained by observation with an atomic force microscope of a region in the range of 200 nm×200 nm at arbitrary 5 sites on a sliced surface obtained by slicing a central area in the thickness direction of the layer B along a plane substantially parallel to the layer B, the average of the major axis size of the selected island components is about 100 nm or less.

Specific examples of suitable thermoplastic elastomers can be found, for example, by reference to US Published Patent Application No. 2010/0239802.

In one preferred embodiment, the thermoplastic elastomer is a hydrogenated block copolymer formed by hydrogenating a block copolymer comprising at least a polymer block (A) constituted predominantly from an aromatic vinyl compound unit and a polymer block (B) constituted predominantly from a 1,3-butadiene unit or constituted predominantly from an isoprene unit and a 1,3-butadiene unit, wherein a content of the polymer block (A) is from about 5% to about 40% mass on the basis of a total amount of the hydrogenated block copolymer, wherein the polymer block (B) has a hydrogenation rate of about 70% or more, and wherein the hydrogenated block copolymer has a glass transition temperature of from about −45° C. to about 30° C.

In another preferred embodiment, the thermoplastic elastomer is a hydrogenated block copolymer formed by hydrogenating a block copolymer comprising at least a polymer block (C) constituted predominantly from an aromatic vinyl compound unit and a polymer block (D) constituted predominantly from a 1,3-butadiene unit or constituted predominantly from an isoprene unit and a 1,3-butadiene unit, wherein a content of the polymer block (C) is from about 10% to about 40% mass on the basis of a total amount of the hydrogenated block copolymer, wherein the polymer block (D) has a hydrogenation rate of about 80% or more, and wherein the hydrogenated block copolymer has a glass transition temperature of less than about −45° C.

In the above two preferred embodiments, desirably the aromatic vinyl compound is styrene, and/or the polymer block (B) and (D) are constituted predominantly from an isoprene unit and a 1,3-butadiene unit, and/or the hydrogenated block copolymer is a tri-block copolymer having an A1-B-A2 or C1-D-C2 type structure.

### Ethylene Vinyl Acetate (EVA)

In the present invention, the acoustic damping layer can be an ethylene vinyl acetate (EVA)-type material, such as disclosed in US Published Patent Application No. 2016/0167348A1. Preferably, the EVA material comprises ethylene vinyl acetate having a vinyl acetate content of greater than about 25 wt. %, or from about 30 wt. %, to about 40 wt. %, or to about 35 wt. %, or about 33 wt. %; an initial melt flow index of at least about 14 g/10 min, and a final melt flow index of about 2 g/10 min or lower, or about 1.5 g/10 min or lower, after the material is cross-linked by one or more methods known to those of ordinary skill in the relevant art (for example, thermally crosslinked with the aid of a peroxide crosslinker).

### Silanes

Silanes suitable for use in accordance with the present invention are dialkoxysilanes. Without being held to theory, it is believed that the hydrolyzed silanol portion of the silane can form an adhesive bond with the glass surface (silanols), thereby enhancing the adhesive force at the interface between the polymer and glass surface. The remaining portion of the silane molecule should then ‘anchor’ in some fashion and to some degree, with the surrounding ionomer resin ‘matrix’.

In one embodiment, each of the alkoxy groups individually contains from 1 to 3 carbon atoms. Suitable examples include diethoxydimethylsilane, diethoxyl(methyl)vinylsilane, 1,3-diethoxy-1,1,3,3-tertramethyldisiloxane, dimethoxydimethylsilane, dimethoxylmethylvinylsilane, methyldiethoxysilane, diisopropyldimethoxysilane, dicyclopentyldimethoxysilane, γ-aminopropyl-N-cyclohexylmethyldimethoxysilane, 3-aminopropylmethyldimethoxysilane, N-phenyl-3-aminopropylmethyldimethoxysilane, N-phenyl-3-aminopropylmethyldiethoxysilane, N-β-(aminoethyl)-γ-aminopropylmethyldimethoxysilane and 3-glycidoxypropylmethyl diethoxysilane.

In another embodiment, in addition to the alkoxy groups the silane also contains an “active” chemical group for bonding into the ionomer resin matrix, for example, a carboxylic acidreactive group such as an amino group or a glycidyl group. Suitable examples include γ-aminopropyl-N-cyclohexylmethyldimethoxysilane, 3-aminopropylmethyldimethoxysilane, N-phenyl-3-aminopropylmethyldimethoxysilane, N-phenyl-3-aminopropylmethyldiethoxysilane, N-β-(aminoethyl)-γ-aminopropylmethyldimethoxysilane and 3-glycidoxypropylmethyl diethoxysilane.

Desirably the silane is a liquid under ambient conditions (for example, at 20° C.). Specific such examples include N-β-(aminoethyl)-γ-aminopropylmethyldimethoxysilane (CAS #3069-29-2) and 3-glycidoxypropylmethyldiethoxysilane (CAS #2897-60-1).

### Other Additives

Other than the aforementioned silanes and other adhesion modifiers, the resin composition and masterbatch of the present invention may contain one or more other additives including, for example, an antioxidant, an ultraviolet ray absorber, a photostabilizer, an antiblocking agent, a pigment, a dye, a heat shielding material (infrared ray absorber) and the like, or mixtures thereof. Such other additives are in a general sense well known to those of ordinary skill in the relevant art.

Examples of the antioxidant include phenol-based antioxidants, phosphorus-based antioxidants, sulfur-based antioxidants, and the like. Of those, phenol-based antioxidants are preferred, and alkyl-substituted phenol-based antioxidants are especially preferred.

Examples of the phenol-based antioxidant include acrylate-based compounds, such as 2-t-butyl-6-(3-t-butyl-2-hydroxy-5-methylbenzyl)-4-methylphenyl acrylate and 2,4-di-t-amyl-6-(1-(3,5-di-t-amyl-2-hydroxyphenyl)ethyl)phenyl acrylate; alkyl-substituted phenol-based compounds, such as 2,6-di-t-butyl-4-methylphenol, 2,6-di-t-butyl-4-ethylphenol, octadecyl-3-(3,5-di-t-butyl-4-hydroxyphenyl)propionate, 2,2′-methylene-bis(4-methyl-6-t-butylphenol), 4,4′-butylidene-bis(4-methyl-6-t-butylphenol), 4,4′-butylidene-bis(6-t-butyl-m-cresol), 4,4′-thiobis(3-methyl-6-t-butylphenol), bis(3-cyclohexyl-2-hydroxy-5-methylphenyl)methane, 3,9-bis(2-(3-(3-t-butyl-4-hydroxy-5-methylphenyl)propionyloxy)-1,1-dimethylethyl)-2,4,8,10-tetraoxaspiro[5.5]undecane, 1,1,3-trix(2-methyl-4-hydroxy-5-t-butylphenyl)butane, 1,3,5-trimethyl-2,4,6-tris(3,5-di-t-butyl-4-hydroxybenzyl)benzene, tetrakis(methylene-3-(3′,5′-di-t-butyl-4′-hydroxyphenyl)propionate)methane and triethylene glycol bis(3-(3-t-butyl-4-hydroxy-5-methylphenyl)propionate); triazine group-containing phenol-based compounds, such as 1,3,5-tris(2,6-dimethyl-3-hydroxy-4-t-butylbenzyl)-1,3,5-triazine-2,4,6(1H,3H,5H)-trione, 6-(4-hydroxy-3,5-di-t-butylanilino)-2,4-bis-octylthio-1,3,5-triazine, 6-(4-hydroxy-3,5-dimethyl anilino)-2,4-bis-octylthio-1,3,5-triazine, 6-(4-hydroxy-3-methyl-5-t-butylanilino)-2,4-bis-octyl thio-1,3,5-triazine and 2-octylthio-4,6-bis-(3,5-di-t-butyl-4-oxyanilino)-1,3,5-triazine; and the like.

Examples of the phosphorus-based antioxidant include monophosphite-based compounds, such as triphenyl phosphite, diphenylisodecyl phosphite, phenyldiisodecyl phosphite, tris(nonylphenyl) phosphite, tris(dinonylphenyl) phosphite, tris(2-t-butyl-4-methylphenyl) phosphite, tris(2,4-di-t-butyl) phosphite, tris(cyclohexylphenyl) phosphite, 2,2-methylenebis(4,6-di-tbutylphenyl)octyl phosphite, 9,10-dihydro-9-oxa-10-phosphaphenanthrene-10-oxide, 10-(3,5-di-t-butyl-4-hydroxybenzyl)-9,10-dihydro-9-oxa-10-phosphaphenanthrene-10-oxide and 10-decyloxy-9,10-dihydro-9-oxa-10-phosphaphenanthrene; diphosphite-based compounds, such as 4,4′-butylidene-bis(3-methyl-6-t-butylphenyl-di-tridecylphosphite), 4,4′-isopropylidene-bis (phenyl-di-alkyl(C12-C15)phosphite), 4,4′-isopropylidene-bis(diphenylmonoalkyl(C12-C15) phosphite), 1,1,3-tris(2-methyl-4-di-tridecylphosphite-5-t-butylphenyl)butane and tetrakis(2,4-di-t-butylphenyl)-4,4′-biphenylene phosphite; and the like. Of those, monophosphite-based compounds are preferred.

Examples of the sulfur-based antioxidant include dilauryl 3,3′-thiodipropionate, distearyl 3,3-thiodipropionate, lauryl stearyl 3,3′-thiodipropionate, pentaerythritol-tetrakis-(β-laurylthiopropionate), 3,9-bis(2-dodecylthioethyl)-2,4,8,10-tetraoxaspiro [5.5] undecane, and the like.

These antioxidants can be used solely or in combination of two or more thereof. In the final resin composition, the antioxidant utilized is typically about 0.001 parts by weight or more, or about 0.01 parts by weight or more, based on 100 parts by weight of the ionomer resin. In addition, the amount of antioxidant utilized is typically about 5 parts by weight or less, or about 1 part by weight or less, based on 100 parts by weight of the ionomer resin. Examples of the ultraviolet ray absorber include benzotriazole-based ultraviolet ray absorbers, such as 2-(5-methyl-2-hydroxyphenyl)benzotriazole, 2-[2-hydroxy-3,5-bis(α,α′-dimethylbenzyl)phenyl]-2H-benzotriazole, 2-(3,5-di-t-butyl-2-hydroxyphenyl)benzotriazole, 2-(3-t-butyl-5-methyl-2-hydroxyphenyl)-5-chlorobenzotriazole, 2-(3,5-di-t-butyl-5-methyl-2-hydroxyphenyl)-5-chlorobenzotriazole and 2-(3,5-di-t-amyl-2-hydroxyphenyl)benzotriazole, 2-(2′-hydroxy-5′-t-octylphenyl)triazole; hindered amine-based ultraviolet ray absorbers, such as 2,2,6,6-tetramethyl-4-piperidyl benzoate, bis(2,2,6,6-tetramethyl-4-piperidyl)sebacate, bis(1,2,2,6,6-pentamethyl-4-piperidyl)-2-(3,5-di-t-butyl-4-hydroxybenzyl)-2-n-butylmalonate and 4-(3-(3,5-di-t-butyl-4-hydroxyphenyl)propionyloxy)-1-(2-(3-(3,5-di-t-butyl-4-hydroxy phenyl)propionyloxy)ethyl)-2,2,6,6-tetramethylpiperidine; benzoate-based ultraviolet ray absorbers, such as 2,4-di-t-butylphenyl-3,5-di-t-butyl-4-hydroxybenzoate and hexadecyl-3,5-di-t-butyl-4-hydroxybenzoate; and the like.

These ultraviolet ray absorbers can be used solely or in combination of two or more thereof. In the final resin composition, the amount of ultraviolet ray absorber utilized is typically about 10 ppm by weight or more, or about 100 ppm by weight or more, based on the weight of the ionomer resin. In addition, the amount of ultraviolet ray absorber utilized is typically about 50,000 ppm or less, or about 10,000 ppm or less, based on the weight of the ionomer resin.

In some embodiments, it is also possible to use two or more types of UV absorbers in combination.

In other embodiments, no UV absorber is added, or the laminate is substantially UV absorber additive free.

Examples of the photostabilizer include hindered amine-based materials, such as “ADEKA STAB LA-57” (a trade name) manufactured by Adeka Corporation, and “TINUVIN 622” (a trade name) manufactured by Ciba Specialty Chemicals Inc.

When a laminated glass is prepared by incorporating a heat-shielding fine particle or a heat-shielding compound as the heat-shielding material into the API layer of the present invention to give a heat-shielding function to the laminate, a transmittance at a wavelength of 1,500 nm can be regulated to about 50% or less, or the TDS value (calculated from ISO 13837:2008) can be regulated to less than about 43%.

Examples of the heat-shielding fine particle include a metal-doped indium oxide, such as tin-doped indium oxide (ITO), a metal-doped tin oxide, such as antimony-doped tin oxide (ATO), a metal-doped zinc oxide, such as aluminum-doped zinc oxide (AZO), a metal element adhesive polymeric tungsten oxide represented by a general formula: MₘWOₙ (M represents a metal element; m is about 0.01 or more and about 1.0 or less; and n is about 2.2 or more and about 3.0 or less), zinc antimonate (ZnSb₂O₅), lanthanum hexaboride, and the like. Of those, ITO, ATO, and a metal element adhesive polymeric tungsten oxide are preferred, and a metal element adhesive polymeric tungsten oxide is more preferred. Examples of the metal element represented by M in the metal element adhesive polymeric tungsten oxide include Cs, Tl, Rb, Na, K, and the like, and in particular, Cs is preferred. From the viewpoint of heat shielding properties, m is preferably about 0.2 or more, or about 0.3 or more, and it is preferably about 0.5 or less, or about 0.4 or less.

From the viewpoint of transparency of the ultimate laminate, an average particle diameter of the heat shielding fine particle is preferably about 100 nm or less, or about 50 nm or less. It is to be noted that the average particle diameter of the heat shielding particle as referred to herein means one measured by a laser diffraction instrument. In the final resin composition, a content of the heat shielding fine particle is preferably about 0.01% by weight or more, or about 0.05% by weight or more, or about 0.1% by weight or more, or about 0.2% by weight or more relative to the weight of the ionomer resin. In addition, the content of the heat shielding fine particle is preferably about 5% by weight or less, or about 3% by weight or less. Examples of the heat shielding compound include phthalocyanine compounds, naphthalocyanine compounds, and the like. From the viewpoint of further improving the heat shielding properties, it is preferred that the heat shielding compound contains a metal. Examples of the metal include Na, K, Li, Cu, Zn, Fe, Co, Ni, Ru, Rh, Pd, Pt, Mn, Sn, V, Ca, Al, and the like, with Ni being especially preferred. A content of the heat shielding compound is preferably about 0.001% by weight or more, or about 0.005% by weight or more, or about 0.01% by weight or more, based on the weight of the ionomer resin. In addition, the content of the heat shielding compound is preferably about 1% by weight or less, or about 0.5% by weight or less.

### Production of Discrete Cohesive Modifier Compositions

The dispersion coating composition may include other additives known in the art. For example, the composition may include a wax additive, such as a microcrystalline wax or a polyethylene wax, which serves as an anti-blocking agent as well as to improve the coefficient of friction of the final coated substrate. Other types of additives include fumed silica, which reduces the tack of the coating at room temperature, fillers, cross-linking agents, anti-static agents, defoamers, dyes, brighteners, processing aids, flow enhancing additives, lubricants, dyes, pigments, flame retardants, impact modifiers, nucleating agents, anti-blocking agents, thermal stabilizers, UV absorbers, UV stabilizers, surfactants, chelating agents, and coupling agents and the like.

Inorganic fillers include calcium carbonate, titanium dioxide, silica, talc, barium sulfate, carbon black, ceramics, chalk, or mixtures thereof. Organic fillers include natural starch, modified starch, chemically modified starch, rice starch, corn starch, wood flour, cellulose, and mixtures thereof.

### Production of Surface Treated Fluorinated-Ethylene-Propylene (FEP) Layers

Coating methods include embodiments where the blend combination is in the form of an extrusion coating wherein the blend combination is in molten form and lamination methods wherein the blend combination is in the form of a preformed film. The coating composition can be applied to one or both sides of the substrate, as well as to the surface of the glass or other rigid substrate.

Fluorinated-ethylene-propylene (FEP) layers described herein can be disposed on within the composite adhesive polymeric interlayer (CAPI) such as sheets of an interlayer resin composition. Such interlayers can be prepared by conventional melt extrusion or melt molding processes suitable for making interlayers for glass laminates. Such processes are well-known to those of ordinary skill in the relevant art, as exemplified by the previously incorporated publications.

The CAPI can be monolayer or multilayer sheets. For example, multilayer sheets can be formed having a functional core layer sandwiched between two exterior layers and other optional interior layers. In one embodiment, at least one (or both) of the exterior layers of the multilayer interlayer is a sheet of the resin composition in accordance with the present invention.

As one example of a functional core layer can be mentioned an acoustic damping layer, such as a polystyrene copolymer intermediate film (see JP2007-91491A), a polyvinyl acetal layer (see US Published Patent Application No. 2013/0183507, U.S. Pat. No. 8,741,439, JP Published Patent Application No. 2012-214305A and U.S. Pat. No. 8,883,317), a viscoelastic acrylic layer (see U.S. Pat. No. 7,121,380), a layer containing a copolymer of styrene and a rubber-based resin monomer (see JP Published Patent Application No. 2009-256128A), a layer containing a polyolefin (see US Published Patent Application No. 2012/0204940), a layer containing an ethylene/vinyl acetate polymer (see International Patent Application No. WO 2015/013242A1), a layer containing an ethylene acid copolymer (see International Patent Application No. WO 2015/085165A1).

In one specific embodiment, the intermediate layer is thermoplastic elastomer resin, such as disclosed in International Patent Application Nos. WO 2016/076336A1, WO 2016/076337A1, WO 2016/076338A1 WO 2016/076339A1 and WO 2016/076340A1, as well as U.S. patent application Ser. No. 15/588,986 (filed 8 May 2017). In a more specific embodiment, the thermoplastic elastomer resin is a hydrogenated product of a block copolymer having:
(i) an aromatic vinyl polymer block (a) containing about 60 mol % or more of an aromatic vinyl monomer unit, based on the aromatic vinyl polymer block, and
(ii) an aliphatic unsaturated polymer block (b) containing about 60 mol % or more of a conjugated diene monomer unit, based on the aliphatic unsaturated polymer block,
wherein the aliphatic unsaturated polymer block (b) contains about 50 mol % or more in total of an isoprene unit and a butadiene unit as the conjugated diene monomer unit, and
wherein the amount of residual carbon-carbon double bonds the aliphatic unsaturated polymer block derived from conjugated diene monomer units is from about 2 to about 40 mol %.

Further, the interlayer as a whole can be symmetric having a substantially consistent thickness, or can be asymmetric wherein a portion of the interlayer has a thickness greater than another portion (for example, partial or full “wedge”, as discussed in U.S. patent application Ser. No. 15/588,986 (filed 8 May 2017) and U.S. Provisional Application No. 62/414,015 (filed 28 Oct. 2016)). Further, the laminate can be substantially clear or having coloring in all or a portion (for example, “shadeband” as discussed in U.S. patent application Ser. No. 15/588,986 (filed 8 May 2017) and U.S. Provisional Application No. 62/414,015 (filed 28 Oct. 2016)).

In an asymmetric construction such as a wedge, the thinner portion of the interlayer should possess the thicknesses of a symmetric construction, while the thickness of the thick portion will depend on various parameters such as wedge angle. In one embodiment of a wedge-shaped interlayer, the thicker edge has a thickness of about 1850 μm or less, or about 1600 μm or less, or about 1520 μm or less, or about 1330 μm or less, or about 1140 μm or less; and the thinner edge has a thickness of about 600 μm or more, or about 700 μm or more, or about 760 μm or more.

In addition, a concave and convex structure, such as an embossing, can be formed on the surface of the interlayer of the present invention by conventionally known methods for assistance in deairing in laminate production. The shape of the embossing is not particularly limited, and those which are conventionally known can be adopted.

In one embodiment, at least one surface (and preferably both surfaces) of the interlayer for a laminated glass is shaped. By shaping at least one surface of the interlayer for a laminated glass, in the case where a laminated glass is produced, an air bubble present at an interface between the interlayer for a laminated glass and a glass easily escapes to the outside of the laminated glass, and thus, the appearance of the laminated glass can be made favorable. It is preferred to shape at least one surface of the interlayer for a laminated glass by an embossing roll method. By shaping the surface of the interlayer for a laminated glass, a concave portion and/or a convex portion are/is formed on the surface of the interlayer for a laminated glass.

An embossing roll to be used in the embossing roll method can be produced, for example, by using an engraving mill (mother mill) having a desired concave-convex pattern and transferring the concave-convex pattern to the surface of a metal roll. Further, an embossing roll can also be produced using laser etching. Further, after forming a fine concave-convex pattern on the surface of a metal roll as described above, the surface with the fine concave-convex pattern is subjected to a blast treatment using an abrasive material such as aluminum oxide, silicon oxide, or glass beads, whereby a finer concave-convex pattern can also be formed.

Further, the embossing roll to be used in the embossing roll method is preferably subjected to a release treatment. In the case where an embossing roll which is not subjected to a release treatment is used, it becomes difficult to release the interlayer for a laminated glass from the embossing roll. Examples of a method for the release treatment include known methods such as a silicone treatment, a Teflon (registered trademark) treatment, and a plasma treatment.

The depth of the concave portion and/or the height of the convex portion (hereinafter sometimes referred to as “the height of the embossed portion”) of the surface of the interlayer for a laminated glass shaped by an embossing roll method or the like are/is typically about 5 μm or more, or about 10 μm or more, or about 20 μm or more. The height of the embossed portion is typically about 150 μm or less, or about 100 μm or less, or about 80 μm or less.

In the invention, the height of the embossed portion refers to a maximum height roughness (Rz) defined in JIS B 0601 (2001). The height of the embossed portion can be measured by, for example, utilizing the confocal principle of a laser microscope or the like. Incidentally, the height of the embossed portion, that is, the depth of the concave portion or the height of the convex portion may vary within a range that does not depart from the gist of the invention.

Examples of the form of the shape imparted by an embossing roll method or the like include a lattice, an oblique lattice, an oblique ellipse, an ellipse, an oblique groove, and a groove. The inclination angle of such form is typically from about 100 to about 80° with respect to the film flow direction (MD direction). Further, the shaping pattern may be a regular pattern or an irregular pattern such as a random matte pattern, or a pattern such as disclosed in U.S. Pat. No. 7,351,468.

The shaping by an embossing roll method or the like may be performed on one surface of the interlayer for a laminated glass, or may be performed on both surfaces, but is more typically performed on both surfaces.

### Laminates

In various examples below, a fluorinated-ethylene-propylene (FEP) layer is present within the TAPI in the 10% depth of the CAPI, as discussed previously. It is possible to produce laminates of the present invention by conventionally known methods. Examples thereof include using a vacuum laminator, using a vacuum bag, using a vacuum ring, using a nip roll, and the like. In addition, a method can be used in which, after temporary contact bonding, the resultant laminate is put into an autoclave for final bonding. Further description of these methods can be found in, for example, U.S. Pat. No. 7,642,307.

In the case of using a vacuum laminator, for example, a known instrument which is used for production of a solar cell can be used, and the assembly is laminated under a reduced pressure of about 1×10⁻⁶ MPa or more and about 3×10⁻² MPa or less at a temperature of about 100° C. or higher, or about 130° C. or higher, and about 200° C. or lower, or about 170° C. or lower. The method of using a vacuum bag or a vacuum ring is, for example, described in EP Published Patent Application No. 1235683A1 (CA Published Patent Application No. 2388107A1) and, for example, the assembly is laminated under a pressure of about 2×10⁻² MPa at about 130° C. or higher and about 145° C. or lower.

In the case of using a nip roll, for example, there is exemplified a method in which after conducting first temporary contact bonding at a temperature of a flow starting temperature of the skin resin or lower, temporary contact bonding is further conducted under a condition close to the flow starting temperature. Specifically, for example, there is exemplified a method in which the assembly is heated at about 30° C. or higher and about 100° C. or lower by an infrared heater or the like, then de-aerated by a roll, and further heated at about 50° C. or higher and about 150° C. or lower, followed by conducting contact bonding by a roll to achieve bonding or temporary bonding.

Though the autoclave process which is supplementarily conducted after the temporary contact bonding is variable depending upon the thickness or constitution of a module, it is, for example, carried out under a pressure of about 1 MPa or more and about 15 MPa or less at a temperature of about 120° C. or higher and about 160° C. or lower for about 0.5 hours or more and about 2 hours or less.

Well-known “no-autoclave” processes may alternatively be used to process laminates.

Advantageously, the glass to be used for preparing a laminated glass is not particularly limited. Inorganic glasses, such as a float sheet glass, a polished sheet glass, a figured glass, a wired sheet glass, a heat-ray absorbing glass, and conventionally known organic glasses, such as polymethyl methacrylate and polycarbonate, and the like can be used. These glasses may be any of colorless, colored, transparent, or non-transparent glasses. These glasses may be used solely, or may be used in combination of two or more thereof.

The laminated glass of the present invention can be suitably used for a windshield for automobile, a side glass for automobile, a sunroof for automobile, a rear glass for automobile, or a glass for head-up display; a building member for a window, a wall, a roof, a sunroof, a sound insulating wall, a display window, a balcony, a handrail wall, or the like; a partition glass member of a conference room; a solar panel; and the like. Further information on such uses can be found by reference to the previously incorporated publication.

In one embodiment, the separation between two debonding zones is clearly demarcated. Stated another way, the difference in peel strength is sufficiently drastic to show a difference. In another embodiment, the difference between two zones is more diffuse. In one embodiment, there is a spatial distance between two debonding zones of at least about 0.01 mm; or about 0.1 mm; or about 1.0 mm; or about 2.0 mm; or about 3.0 mm; or about 4.0 mm; or about 5.0 mm; or about 10.0 mm; or about 25.0 mm; or about 50.0 mm; or about 100.0 mm.

The discussion below where CAPI layer is used applies to laminate structures with or without the superbonding layer.

In one embodiment, the debonding zones' peel strengths are engendered by using different polymer or the same polymer to form the CAPI layer (with or without the superbonding layer). In both cases, the present invention envisages the scenario where the molecular weight of the polymer is used to generate the debonding zones. In yet another embodiment, external treatment of the top adhesive interlayer (TAPI) is used to generate the debonding zones. In one embodiment, the debonding zones are generated by treatment of the TAPI and/or the laminate glass adhering to the TAPI layer. The debonding treatment can include the application of a chemically active substance or mixture which can alter the adhesive/debonding characteristics at or near the interface between the rigid substrate and the TAPI layer. A treatment can alternatively include the application of an energetic ‘beam’, such as electron beam, gamma, plasma, electron discharge, laser, ionbeam or other energetic means such as, plasma, flame-treatment, UV/VIS/IR radiation, microwaves or chemical alteration, via, coating techniques, chemical vapor deposition, and the like. Combinations of a chemical substance(s) with energetic sources can also be employed as a treatment. The treatment may be of an infinitesimally small dimension (i.e., only surface atomic or molecular monolayer affected by the treatment or the treatment may be of a finite thickness (approaching up to 10% of the CAPI layer thickness. The treatment may be applied to either the rigid substrate or to the TAPI layer or both. It is generally most advantageous to apply the treatment to the TAPI layer. The application directly to and as part of the TAPI layer provides for ease of the manufacturing (e.g. roll-to-roll processing and the like).

In an embodiment, the invention provides a TAPI layer comprising at least two zones, wherein the zone with maximum mean peel strength has a mean peel strength that is at least about 2 times greater than a mean peel strength of the zone with minimum mean peel strength; or about 3 times greater than a mean peel strength of the zone with minimum mean peel strength; or about 4 times greater than a mean peel strength of the zone with minimum mean peel strength; or about 5 times greater than a mean peel strength of the zone with minimum mean peel strength; or about 6 times greater than a mean peel strength of the zone with minimum mean peel strength; or about 7 times greater than a mean peel strength of the zone with minimum mean peel strength; or about 8 times greater than a mean peel strength of the zone with minimum mean peel strength; or about 9 times greater than a mean peel strength of the zone with minimum mean peel strength.

In an embodiment, the invention provides a TAPI layer comprising at least two zones, wherein the zone with maximum mean peel strength has a mean peel strength that is at least about X times greater than a mean peel strength of the zone with minimum mean peel strength, wherein X is one of the following numbers or within a range defined by any two of the following numbers, including the endpoints of such range:

10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, and 250.

In an embodiment, the maximum mean peel strength is at least about Y times greater than the minimum mean peel strength, wherein Y is any number below and within a range defined by any two numbers below, including the endpoints of such range:

10, 20, 30, 40, 50, 60, 70, 80, 90, 100, 110, 120, 130, 140, 150, 160, 170, 180, 190, 200, 210, 220, 230, 240, and 250.

In an embodiment, the invention provides TAPI layer comprising at least two zones, wherein the zone with maximum mean peel strength has a mean peel strength that is from about 2 times to about 250 times greater than a mean peel strength of the zone with minimum mean peel strength; or wherein the maximum mean peel strength is from about 3 times to about 225 times greater than the minimum mean peel strength; or wherein or wherein the maximum mean peel strength is from about 4 times to about 200 times greater than the minimum mean peel strength; or wherein the maximum mean peel strength is from about 5 times to about 175 times greater than the minimum mean peel strength; or wherein the maximum mean peel strength is from about 5 times to about 150 times greater than the minimum mean peel strength; or wherein or wherein the maximum mean peel strength is from about 5 times to about 125 times greater than the minimum mean peel strength; or wherein the maximum mean peel strength is from about 5 times to about 100 times greater than the minimum mean peel strength; or wherein the maximum mean peel strength is from about 10 times to about 95 times greater than the minimum mean peel strength; or wherein the maximum mean peel strength is from about 15 times to about 90 times greater than the minimum mean peel strength; or wherein the maximum mean peel strength is from about 20 times to about 85 times greater than the minimum mean peel strength; or wherein the maximum mean peel strength is from about 25 times to about 80 times greater than the minimum mean peel strength; or wherein the maximum mean peel strength is from about 30 times to about 75 times greater than the minimum mean peel strength; or wherein the maximum mean peel strength is from about 35 times to about 70 times greater than the minimum mean peel strength; or wherein the maximum mean peel strength is from about 40 times to about 65 times greater than the minimum mean peel strength; or wherein the maximum mean peel strength is from about 45 times to about 60 times greater than the minimum mean peel strength; or wherein the maximum mean peel strength is from about 50 times to about 55 times greater than the minimum mean peel strength.

In an embodiment, the invention provides a TAPI layer comprising at least two zones, wherein the zone with maximum mean peel strength has a mean peel strength that is from about 2 times to about 5 times greater than a mean peel strength of the zone with minimum mean peel strength; or wherein the maximum mean peel strength is from about 5 times to about 10 times greater than the minimum mean peel strength; or wherein the maximum mean peel strength is from about 10 times to about 15 times greater than the minimum mean peel strength; or wherein the maximum mean peel strength is from about 15 times to about 20 times greater than the minimum mean peel strength; or wherein the maximum mean peel strength is from about 20 times to about 25 times greater than the minimum mean peel strength; or wherein the maximum mean peel strength is from about 25 times to about 30 times greater than the minimum mean peel strength; or wherein the maximum mean peel strength is from about 30 times to about 35 times greater than the minimum mean peel strength; or wherein the maximum mean peel strength is from about 35 times to about 40 times greater than the minimum mean peel strength; or wherein the maximum mean peel strength is from about 40 times to about 45 times greater than the minimum mean peel strength; or wherein the maximum mean peel strength is from about 45 times to about 50 times greater than the minimum mean peel strength; or wherein the maximum mean peel strength is from about 50 times to about 55 times greater than the minimum mean peel strength; or wherein the maximum mean peel strength is from about 55 times to about 60 times greater than the minimum mean peel strength; or wherein the maximum mean peel strength is from about 60 times to about 65 times greater than the minimum mean peel strength; or wherein the maximum mean peel strength is from about 65 times to about 70 times greater than the minimum mean peel strength; or wherein the maximum mean peel strength is from about 70 times to about 75 times greater than the minimum mean peel strength; or wherein the maximum mean peel strength is from about 75 times to about 80 times greater than the minimum mean peel strength; or wherein the maximum mean peel strength is from about 80 times to about 85 times greater than the minimum mean peel strength; or wherein the maximum mean peel strength is from about 85 times to about 90 times greater than the minimum mean peel strength; or wherein the maximum mean peel strength is from about 90 times to about 95 times greater than the minimum mean peel strength; or wherein the maximum mean peel strength is from about 95 times to about 100 times greater than the minimum mean peel strength or wherein the maximum mean peel strength is from about 100 times to about 105 times greater than the minimum mean peel strength; or wherein the maximum mean peel strength is from about 105 times to about 110 times greater than the minimum mean peel strength; or wherein the maximum mean peel strength is from about 110 times to about 115 times greater than the minimum mean peel strength; or wherein the maximum mean peel strength is from about 115 times to about 120 times greater than the minimum mean peel strength; or wherein the maximum mean peel strength is from about 120 times to about 125 times greater than the minimum mean peel strength; or wherein the maximum mean peel strength is from about 125 times to about 130 times greater than the minimum mean peel strength; or wherein the maximum mean peel strength is from about 130 times to about 135 times greater than the minimum mean peel strength; or wherein the maximum mean peel strength is from about 135 times to about 140 times greater than the minimum mean peel strength; or wherein the maximum mean peel strength is from about 140 times to about 145 times greater than the minimum mean peel strength; or wherein the maximum mean peel strength is from about 145 times to about 150 times greater than the minimum mean peel strength; or wherein the maximum mean peel strength is from about 150 times to about 155 times greater than the minimum mean peel strength; or wherein the maximum mean peel strength is from about 155 times to about 160 times greater than the minimum mean peel strength; or wherein the maximum mean peel strength is from about 160 times to about 165 times greater than the minimum mean peel strength; or wherein the maximum mean peel strength is from about 165 times to about 170 times greater than the minimum mean peel strength; or wherein the maximum mean peel strength is from about 170 times to about 175 times greater than the minimum mean peel strength; or wherein the maximum mean peel strength is from about 175 times to about 180 times greater than the minimum mean peel strength; or wherein the maximum mean peel strength is from about 180 times to about 185 times greater than the minimum mean peel strength; or wherein the maximum mean peel strength is from about 185 times to about 190 times greater than the minimum mean peel strength; or wherein the maximum mean peel strength is from about 190 times to about 195 times greater than the minimum mean peel strength; or wherein the maximum mean peel strength is from about 195 times to about 200 times greater than the minimum mean peel strength; or wherein the maximum mean peel strength is from about 200 times to about 205 times greater than the minimum mean peel strength; or wherein the maximum mean peel strength is from about 205 times to about 210 times greater than the minimum mean peel strength; or wherein the maximum mean peel strength is from about 210 times to about 215 times greater than the minimum mean peel strength; or wherein the maximum mean peel strength is from about 215 times to about 220 times greater than the minimum mean peel strength; or wherein the maximum mean peel strength is from about 220 times to about 225 times greater than the minimum mean peel strength; or wherein the maximum mean peel strength is from about 225 times to about 230 times greater than the minimum mean peel strength; or wherein the maximum mean peel strength is from about 230 times to about 235 times greater than the minimum mean peel strength; or wherein the maximum mean peel strength is from about 235 times to about 240 times greater than the minimum mean peel strength; or wherein the maximum mean peel strength is from about 240 times to about 245 times greater than the minimum mean peel strength; or wherein the maximum mean peel strength is from about 245 times to about 250 times greater than the minimum mean peel strength.

In an embodiment, the invention provides a TAPI layer comprising at least two zones, wherein at least one of the zones has a mean peel strength of from about 0.01 to about 4.0 kJ/m²; or wherein at least one of the zones has a mean peel strength of from about 0.25 to about 3.5 kJ/m²; or wherein at least one of the zones has a mean peel strength of from about 0.5 to about 3.0 kJ/m²; or wherein at least one of the zones has a mean peel strength of from about 0.75 to about 2.5 kJ/m²; or wherein at least one of the zones has a mean peel strength of from about 1.0 to about 2.0 kJ/m²; or wherein at least one of the zones has a mean peel strength of from about 1.25 to about 1.5 kJ/m².

In yet another embodiment, the invention provides a TAPI layer comprising at least two zones, wherein at least one of the zones has a mean peel strength of from about 0.01 to about 0.5 kJ/m²; or wherein at least one of the zones has a mean peel strength of from about 0.5 to about 1.0 kJ/m²; or wherein at least one of the zones has a mean peel strength of from about 1.0 to about 1.5 kJ/m²; or wherein at least one of the zones has a mean peel strength of from about 1.5 to about 2.0 kJ/m²; or wherein at least one of the zones has a mean peel strength of from about 2.0 to about 2.5 kJ/m²; or wherein at least one of the zones has a mean peel strength of from about 2.5 to about 3.0 kJ/m²; or wherein at least one of the zones has a mean peel strength of from about 3.0 to about 3.5 kJ/m²; or wherein at least one of the zones has a mean peel strength of from about 3.5 to about 4.0 kJ/m².

In yet another embodiment, the invention provides a TAPI layer comprising at least two zones, wherein at least one of the zones has a mean peel strength of from about 8.0 to about 12.0 kJ/m²; or wherein at least one of the zones has a mean peel strength of from about 8.5 to about 11.5 kJ/m²; or wherein at least one of the zones has a mean peel strength of from about 9.0 to about 11.0 kJ/m²; or wherein at least one of the zones has a mean peel strength of from about 9.5 to about 10.5 kJ/m².

In yet another embodiment, the invention provides a TAPI layer comprising at least two zones, wherein at least one of the zones has a mean peel strength of from about 8.0 to about 8.5 kJ/m²; or wherein at least one of the zones has a mean peel strength of from about 8.5 to about 9.0 kJ/m²; or wherein at least one of the zones has a mean peel strength of from about 9.0 to about 9.5 kJ/m²; or wherein at least one of the zones has a mean peel strength of from about 10.0 to about 10.5 kJ/m²; or wherein at least one of the zones has a mean peel strength of from about 10.5 to about 11.0 kJ/m²; or wherein at least one of the zones has a mean peel strength of from about 11.0 to about 11.5 kJ/m²; or wherein at least one of the zones has a mean peel strength of from about 11.5 to about 12.0 kJ/m².

In one embodiment comprising at least two zones, the mean peel strength of the zone with the maximum mean peel strength is in the range of from about 0.3 kJ/m² to about 12.0 kJ/m². Stated another way, the mean peel strength can be any one of the following numbers in kJ/m²:

0.3, 0.4, 0.5, . . . , 1.0, 1.5, 2.0, . . . 3.0, 4.0, 5.0, 6.0, 7.0, 8.0, 9.0, 10.0, 11.0, and 12.0.

In one embodiment, such mean peel strength is within the range defined by selecting any two numbers above, including the end-points of such range.

In another embodiment, the invention provides a debonding region within the TAPI layer comprising at least two zones, wherein at least one of the zones comprises a polyvinyl acetal, an ionomer, a thermoplastic elastomer, a silane, an ethylvinylacetate, or combinations thereof. In an embodiment, at least one of the zones comprises a polyvinyl acetal. In an embodiment, at least one of the zones comprises an ionomer. In an embodiment, at least one of the zones comprises a thermoplastic elastomer. In an embodiment, at least one of the zones comprises a silane. In an embodiment, at least one of the zones comprises an ethylvinylacetate. In an embodiment, at least one of the zones comprises a combination of one of these materials.

In yet another embodiment, the invention provides a debonding region within the TAPI layer comprising at least two zones, wherein the zones each comprise a polyvinyl acetal, an ionomer, a thermoplastic elastomer, a silane, an ethylvinylacetate, or combinations thereof. In an embodiment, the zones each comprises a polyvinyl acetal. In yet another embodiment, both of the zones comprise an ionomer. In an embodiment, the zones each comprise a thermoplastic elastomer. In an embodiment, the zones each comprise a silane. In an embodiment, the zones each comprise an ethylvinylacetate. In an embodiment, the zones each comprise a combination of these materials.

In another embodiment, the invention provides a debonding region within the TAPI layer comprising at least two zones, wherein at least one of the zones comprises the ionomer and the ionomer is a sodium-neutralized ethylene-α,β-unsaturated carboxylic acid copolymer. In another embodiment, the invention provides a polymeric interlayer comprising at least two zones, wherein the zones each comprise the ionomer and the ionomer is a sodium-neutralized ethylene-α,β-unsaturated carboxylic acid copolymer.

In another embodiment, the invention provides a debonding region within the TAPI layer comprising at least two zones, wherein at least one of the zones comprises the polyvinyl acetal and the polyvinyl acetal is a polyvinyl butyral. In another embodiment, the invention provides a fluorinated-ethylene-propylene (FEP) layer comprising at least two zones, wherein the zones each comprise the polyvinyl acetal and the polyvinyl acetal is a polyvinyl butyral.

In yet another embodiment, the invention provides a debonding region within the TAPI layer comprising at least two zones, wherein the fluorinated-ethylene-propylene (FEP) layer has a thickness of from about 0.001 mm to about 1.0 mm; or wherein the fluorinated-ethylene-propylene (FEP) layer has a thickness of from about 0.01 mm to about 0.5 mm; or wherein the fluorinatedethylene-propylene (FEP) layer has a thickness of from about 0.15 mm to about 0.2 mm.

In yet another embodiment, the invention provides a debonding region comprising at least two zones, wherein the debonding region within the TAPI layer has a thickness of from about 0.001 mm to about 1.0 mm; or wherein the debonding region has a thickness of from about 0.01 mm to about 0.5 mm; or wherein the debonding region has a thickness of from about 0.15 mm to about 0.25 mm.

In a further embodiment, the invention provides a debonding region within the TAPI layer comprising at least two zones, wherein CAPI is disposed between two panes of glass. In an embodiment, at least one of the glass panes is float glass. In an embodiment, both of the glass panes are float glass. In an embodiment, the debonding region is in contact with the tin side of the float glass.

In yet another embodiment, the invention provides a debonding region within the TAPI layer comprising at least three zones; or wherein the debonding region comprises at least four zones; or wherein the interlayer comprises at least five zones; or wherein the debonding region comprises at least six zones; or wherein the debonding region comprises at least seven zones; or wherein the debonding region comprises at least eight zones; or wherein the debonding region comprises at least nine zones; or wherein the debonding region comprises at least ten zones.

In a further embodiment, the invention provides a TAPI layer comprising at least two zones, wherein at least one of the zones is shaped as a dot, a circle, a square, a rectangle, a pentagon, a hexagon; or is amorphous. In a further embodiment, the invention provides a TAPI layer comprising at least two zones, wherein the zones are each shaped as a dot, a circle, an oval, a triangle, a square, a rectangle, a pentagon, a hexagon; or is amorphous. In an embodiment, at least one of the zones are shaped as a dot. In an embodiment, at least one of the zones are shaped as a circle. In an embodiment, at least one of the zones are shaped as an oval. In an embodiment, at least one of the zones are shaped as a triangle. In an embodiment, at least one of the zones are shaped as a square. In an embodiment, at least one of the zones are shaped as a rectangle. In an embodiment, at least one of the zones are shaped as a pentagon. In an embodiment, at least one of the zones are shaped as a hexagon. In an embodiment, at least one of the zones are amorphous.

In a further embodiment, the invention provides a TAPI layer comprising at least two zones, wherein at least one of the zones is shaped as gridlines, crisscross lines, random lines, concentric circles, eccentric circles, spaghetti patterns and flat strips. In a further embodiment, the invention provides a TAPI layer comprising at least two zones, wherein the zones are each shaped as gridlines, crisscross lines, random lines, concentric circles, eccentric circles, spaghetti patterns and flat strips. In an embodiment, at least one of the zones are shaped as gridlines. In an embodiment, at least one of the zones are shaped as crisscross lines. In an embodiment, at least one of the zones are shaped as random lines. In an embodiment, at least one of the zones are shaped as concentric circles. In an embodiment, at least one of the zones are shaped as eccentric circles. In an embodiment, at least one of the zones are shaped as a spaghetti pattern. In an embodiment, at least one of the zones are shaped as a flat strip.

In a further embodiment, the invention provides a TAPI layer comprising at least two zones, wherein the zones have a size in a range of from about 0.5 times a thickness of the CAPI layer to about 10 times the thickness of the CAPI layer; or wherein the zones have a size in a range of from about 1.5 times the thickness to about 9.0 times the thickness of the CAPI; or wherein the zones have a size in a range of from about 2.0 times the thickness to about 8.0 times the thickness of the CAPI; or wherein the zones have a size in a range of from about 3.0 times the thickness to about 7.0 times the thickness of the CAPI; or wherein the zones have a size in a range of from about 4.0 times the thickness to about 6.0 times the thickness of the CAPI; or wherein the zones have a size in a range of from about 4.5 times the thickness to about 5.5 times the thickness of the CAPI; or wherein the zones have a size that is about 5.0 times the thickness to of the CAPI. In a further embodiment, the invention provides a TAPI layer comprising at least two zones, wherein the zones have a size in a range of from about 0.5 times a thickness of the CAPI to about 1.5 times the thickness of the CAPI; or wherein the zones have a size in a range of from about 1.5 times the thickness to about 2.0 times the thickness of the CAPI; or wherein the zones have a size in a range of from about 2.0 times the thickness to about 3.0 times the thickness of the CAPI; or wherein the zones have a size in a range of from about 3.0 times the thickness to about 4.0 times the thickness of the CAPI; or wherein the zones have a size in a range of from about 4.0 times the thickness to about 5.0 times the thickness of the CAPI; or wherein the zones have a size in a range of from about 5.0 times the thickness to about 6.0 times the thickness of the CAPI; or wherein the zones have a size in a range of from about 5.0 times the thickness to about 6.0 times the thickness of the CAPI; or wherein the zones have a size in a range of from about 6.0 times the thickness to about 7.0 times the thickness of the CAPI; or wherein the zones have a size in a range of from about 7.0 times the thickness to about 8.0 times the thickness of the CAPI; or wherein the zones have a size in a range of from about 8.0 times the thickness to about 9.0 times the thickness of the CAPI; or wherein the zones have a size in a range of from about 9.0 times the thickness to about 10.0 times the thickness of the CAPI.

In yet a further embodiment, the invention provides a TAPI layer comprising at least two zones, wherein the zones are shaped as a dot or circle having a diameter in the range of from about 0.5 times a thickness of the CAPI to about 10 times the thickness of the CAPI; or wherein the zones are shaped as a dot or circle having a diameter in the range of from about 1.5 times the thickness to about 9.0 times the thickness of the CAPI; or wherein the zones are shaped as a dot or circle having a diameter in the range of from about 2.0 times the thickness to about 8.0 times the thickness of the interlayer; or wherein the zones are shaped as a dot or circle having a diameter in the range of from about 3.0 times the thickness to about 7.0 times the thickness of the CAPI; or wherein the zones are shaped as a dot or circle having a diameter in the range of from about 4.0 times the thickness to about 6.0 times the thickness of the CAPI; or wherein the zones are shaped as a dot or circle having a diameter in the range of from about 5.5 times the thickness to about 5.5 times the thickness of the CAPI; or wherein the zones are shaped as a dot or circle having a diameter that is about 5.0 times the thickness to of the CAPI.

In yet a further embodiment, the invention provides a TAPI layer comprising at least two zones, wherein the zones are shaped as a dot or circle having a diameter in the range of from about 0.5 times a thickness of the interlayer to about 1.5 times the thickness of the CAPI; or wherein the zones are shaped as a dot or circle having a diameter in the range of from about 1.5 times the thickness to about 2.0 times the thickness of the CAPI; or wherein the zones are shaped as a dot or circle having a diameter in the range of from about 2.0 times the thickness to about 3.0 times the thickness of the CAPI; or wherein the zones are shaped as a dot or circle having a diameter in the range of from about 3.0 times the thickness to about 4.0 times the thickness of the CAPI; or wherein the zones are shaped as a dot or circle having a diameter in the range of from about 4.0 times the thickness to about 5.0 times the thickness of the CAPI; or wherein the zones are shaped as a dot or circle having a diameter in the range of from about 5.0 times the thickness to about 6.0 times the thickness of the CAPI; or wherein the zones are shaped as a dot or circle having a diameter in the range of from about 5.0 times the thickness to about 6.0 times the thickness of the CAPI; or wherein the zones are shaped as a dot or circle having a diameter in the range of from about 6.0 times the thickness to about 7.0 times the thickness of the CAPI; or wherein the zones are shaped as a dot or circle having a diameter in the range of from about 7.0 times the thickness to about 8.0 times the thickness of the CAPI; or wherein the zones are shaped as a dot or circle having a diameter in the range of from about 8.0 times the thickness to about 9.0 times the thickness of the CAPI; or wherein the zones are shaped as a dot or circle having a diameter in the range of from about 9.0 times the thickness to about 10.0 times the thickness of the CAPI.

In yet a further embodiment, the invention provides a TAPI layer comprising at least two zones, wherein one of the zones covers a surface area of from about 10% to about 60% of one of the glass panes; or wherein one of the zones covers a surface area of from about 15% to about 55% of one of the glass panes; or wherein one of the zones covers a surface area of from about 20% to about 50% of one of the glass panes; or wherein one of the zones covers a surface area of from about 25% to about 45% of one of the glass panes; or wherein one of the zones covers a surface area of from about 30% to about 40% of one of the glass panes.

In yet a further embodiment, the invention provides a TAPI layer comprising at least two zones, wherein one of the zones covers a surface area of from about 10% to about 15% of one of the glass panes; or wherein one of the zones covers a surface area of from about 15% to about 20% of one of the glass panes; or wherein one of the zones covers a surface area of from about 20% to about 25% of one of the glass panes; or wherein one of the zones covers a surface area of from about 25% to about 30% of one of the glass panes; or wherein one of the zones covers a surface area of from about 30% to about 35% of one of the glass panes; or wherein one of the zones covers a surface area of from about 35% to about 40% of one of the glass panes; or wherein one of the zones covers a surface area of from about 40% to about 45% of one of the glass panes; or wherein one of the zones covers a surface area of from about 45% to about 50% of one of the glass panes; or wherein one of the zones covers a surface area of from about 50% to about 55% of one of the glass panes; or wherein one of the zones covers a surface area of from about 55% to about 60% of one of the glass panes.

In yet a further embodiment, the invention provides a TAPI layer comprising at least two zones, wherein one of the zones covers a surface area of from about 1% to about 35% of one of the glass panes; or wherein one of the zones covers a surface area of from about 5% to about 30% of one of the glass panes; or wherein one of the zones covers a surface area of from about 5% to about 25% of one of the glass panes; or wherein one of the zones covers a surface area of from about 10% to about 20% of one of the glass panes.

In yet a further embodiment, the invention provides a TAPI layer comprising at least two zones, wherein one of the zones covers a surface area of from about 1% to about 5% of one of the glass panes; or wherein one of the zones covers a surface area of from about 5% to about 10% of one of the glass panes; or wherein one of the zones covers a surface area of from about 10% to about 15% of one of the glass panes; or wherein one of the zones covers a surface area of from about 15% to about 20% of one of the glass panes; or wherein one of the zones covers a surface area of from about 20% to about 25% of one of the glass panes; or wherein one of the zones covers a surface area of from about 25% to about 30% of one of the glass panes; or wherein one of the zones covers a surface area of from about 30% to about 35% of one of the glass panes.

In yet another embodiment, the invention provides a TAPI layer comprising at least three zones; or wherein the interlayer comprises at least four zones; or wherein the interlayer comprises at least five zones; or wherein the interlayer comprises at least six zones; or wherein the interlayer comprises at least seven zones; or wherein the interlayer comprises at least eight zones; or wherein the interlayer comprises at least nine zones; or wherein the interlayer comprises at least ten zones.

### Embodiments—API (BPI) Layer with a Superbonding Layer and No TAPI Layer

In an embodiment, for example, when the TAPI layer is not present and the debonding zones are present in the BAPI (or the API, a single layer), the debonding zones' peel strengths are engendered by using different polymer or the same polymer to form the API layer. In both cases, the present invention envisages the scenario where the molecular weight of the polymer is used to generate the debonding zones. In another embodiment, the thickness of the interfacial zone is used to generate the debonding zones. In yet another embodiment, external treatment of the interfacial zone is used to generate the debonding zones. In one embodiment, the debonding zones are generated by treatment of the adhesive polymeric adhesive and/or the laminate glass adhering to the API layer. The debonding treatment can include the application of a chemically active substance or mixture which can alter the adhesive/debonding characteristics at or near the interface between the rigid substrate and the API layer. A treatment can alternatively include the application of an energetic ‘beam’, such as electron beam, gamma, plasma, electron discharge, laser, ion-beam or other energetic means such as, plasma, flame-treatment, UV/VIS/IR radiation, microwaves or chemical alteration, via, coating techniques, chemical vapor deposition, and the like. Combinations of a chemical substance(s) with energetic sources can also be employed as a treatment. The treatment may be of an infinitesimally small dimension (i.e., only surface atomic or molecular monolayer affected by the treatment or the treatment may be of a finite thickness (approaching up to 10% of the interlayer thickness. The treatment may be applied to either the rigid substrate or to the polymeric interlayer or both. It is generally most advantageous to apply the treatment to the polymeric interlayer. The application directly to and as part of the interlayer provides for ease of the manufacturing (e.g. roll-to-roll processing and the like).

In an embodiment, for example, when the TAPI layer is not present and the debonding zones are present in the BAPI (or the API, a single layer) the invention provides a interfacial region layer comprising at least two zones, wherein the zone with maximum mean peel strength has a mean peel strength that is at least about 2 times greater than a mean peel strength of the zone with minimum mean peel strength; or about 3 times greater than a mean peel strength of the zone with minimum mean peel strength; or about 4 times greater than a mean peel strength of the zone with minimum mean peel strength; or about 5 times greater than a mean peel strength of the zone with minimum mean peel strength; or about 6 times greater than a mean peel strength of the zone with minimum mean peel strength; or about 7 times greater than a mean peel strength of the zone with minimum mean peel strength; or about 8 times greater than a mean peel strength of the zone with minimum mean peel strength; or about 9 times greater than a mean peel strength of the zone with minimum mean peel strength.

In an embodiment, for example, when the TAPI layer is not present and the debonding zones are present in the BAPI (or the API, a single layer), the invention provides an interfacial region comprising at least two zones, wherein the zone with maximum mean peel strength has a mean peel strength that is at least about 10 times greater than a mean peel strength of the zone with minimum mean peel strength; or wherein the zone with maximum mean peel strength has a mean peel strength that is at least about 15 times greater than a mean peel strength of the zone with minimum mean peel strength; or wherein the zone with maximum mean peel strength has a mean peel strength that is at least about 20 times greater than a mean peel strength of the zone with minimum mean peel strength; or wherein the zone with maximum mean peel strength has a mean peel strength that is at least about 25 times greater than a mean peel strength of the zone with minimum mean peel strength; or wherein the zone with maximum mean peel strength has a mean peel strength that is at least about 30 times greater than a mean peel strength of the zone with minimum mean peel strength; or wherein the maximum mean peel strength is at least about 35 times greater than the minimum mean peel strength; or wherein the maximum mean peel strength is at least about 40 times greater than the minimum mean peel strength; or wherein the maximum mean peel strength is at least about 45 times greater than the minimum mean peel strength; or wherein the maximum mean peel strength is at least about 50 times greater than the minimum mean peel strength; or wherein the maximum mean peel strength is at least about 55 times greater than the minimum mean peel strength; or wherein the maximum mean peel strength is at least about 60 times greater than the minimum mean peel strength; or wherein the maximum mean peel strength is at least about 65 times greater than the minimum mean peel strength; or wherein the maximum mean peel strength is at least about 70 times greater than the minimum mean peel strength; or wherein the maximum mean peel strength is at least about 75 times greater than the minimum mean peel strength; or wherein the maximum mean peel strength is at least about 80 times greater than the minimum mean peel strength; or wherein the maximum mean peel strength is at least about 85 times greater than the minimum mean peel strength; or wherein the maximum mean peel strength is at least about 90 times greater than the minimum mean peel strength; or wherein the maximum mean peel strength is at least about 95 times greater than the minimum mean peel strength; or wherein the maximum mean peel strength is at least about 100 times greater than the minimum mean peel strength; or wherein the maximum mean peel strength is at least about 105 times greater than the minimum mean peel strength; or wherein the maximum mean peel strength is at least about 110 times greater than the minimum mean peel strength; or wherein the maximum mean peel strength is at least about 115 times greater than the minimum mean peel strength; or wherein the maximum mean peel strength is at least about 120 times greater than the minimum mean peel strength; or wherein the maximum mean peel strength is at least about 125 times greater than the minimum mean peel strength; or wherein the maximum mean peel strength is at least about 130 times greater than the minimum mean peel strength; or wherein the maximum mean peel strength is at least about 135 times greater than the minimum mean peel strength; or wherein the maximum mean peel strength is at least about 140 times greater than the minimum mean peel strength; or wherein the maximum mean peel strength is at least about 145 times greater than the minimum mean peel strength; or wherein the maximum mean peel strength is at least about 150 times greater than the minimum mean peel strength; or wherein the maximum mean peel strength is at least about 155 times greater than the minimum mean peel strength; or wherein the maximum mean peel strength is at least about 160 times greater than the minimum mean peel strength; or wherein the maximum mean peel strength is at least about 165 times greater than the minimum mean peel strength; or wherein the maximum mean peel strength is at least about 170 times greater than the minimum mean peel strength; or wherein the maximum mean peel strength is at least about 175 times greater than the minimum mean peel strength; or wherein the maximum mean peel strength is at least about 180 times greater than the minimum mean peel strength; or wherein the maximum mean peel strength is at least about 185 times greater than the minimum mean peel strength; or wherein the maximum mean peel strength is at least about 190 times greater than the minimum mean peel strength; or wherein the maximum mean peel strength is at least about 195 times greater than the minimum mean peel strength; or wherein the maximum mean peel strength is at least about 200 times greater than the minimum mean peel strength; or wherein the maximum mean peel strength is at least about 205 times greater than the minimum mean peel strength; or wherein the maximum mean peel strength is at least about 210 times greater than the minimum mean peel strength; or wherein the maximum mean peel strength is at least about 215 times greater than the minimum mean peel strength; or wherein the maximum mean peel strength is at least about 200 times greater than the minimum mean peel strength; or wherein the maximum mean peel strength is at least about 225 times greater than the minimum mean peel strength; or wherein the maximum mean peel strength is at least about 230 times greater than the minimum mean peel strength; or wherein the maximum mean peel strength is at least about 235 times greater than the minimum mean peel strength; or wherein the maximum mean peel strength is at least about 240 times greater than the minimum mean peel strength; or wherein the maximum mean peel strength is at least about 245 times greater than the minimum mean peel strength; or wherein the maximum mean peel strength is at least about 250 times greater than the minimum mean peel strength.

In an embodiment, for example, when the TAPI layer is not present and the debonding zones are present in the BAPI (or the API, a single layer), the maximum mean peel strength is at least about 10 times greater than the minimum mean peel strength. In an embodiment, the maximum mean peel strength is at least about 20 times greater than the minimum mean peel strength. In an embodiment, the maximum mean peel strength is at least about 30 times greater than the minimum mean peel strength. In an embodiment, the maximum mean peel strength is at least about 40 times greater than the minimum mean peel strength. In an embodiment, the maximum mean peel strength is at least about 50 times greater than the minimum mean peel strength. In an embodiment, the maximum mean peel strength is at least about 60 times greater than the minimum mean peel strength. In an embodiment, the maximum mean peel strength is at least about 70 times greater than the minimum mean peel strength. In an embodiment, the maximum mean peel strength is at least about 80 times greater than the minimum mean peel strength. In an embodiment, the maximum mean peel strength is at least about 90 times greater than the minimum mean peel strength. In an embodiment, the maximum mean peel strength is at least about 100 times greater than the minimum mean peel strength. In an embodiment, the maximum mean peel strength is at least about 110 times greater than the minimum mean peel strength. In an embodiment, the maximum mean peel strength is at least about 120 times greater than the minimum mean peel strength. In an embodiment, the maximum mean peel strength is at least about 130 times greater than the minimum mean peel strength. In an embodiment, the maximum mean peel strength is at least about 140 times greater than the minimum mean peel strength. In an embodiment, the maximum mean peel strength is at least about 150 times greater than the minimum mean peel strength. In an embodiment, the maximum mean peel strength is at least about 160 times greater than the minimum mean peel strength. In an embodiment, the maximum mean peel strength is at least about 170 times greater than the minimum mean peel strength. In an embodiment, the maximum mean peel strength is at least about 180 times greater than the minimum mean peel strength. In an embodiment, the maximum mean peel strength is at least about 190 times greater than the minimum mean peel strength. In an embodiment, the maximum mean peel strength is at least about 200 times greater than the minimum mean peel strength. In an embodiment, the maximum mean peel strength is at least about 210 times greater than the minimum mean peel strength. In an embodiment, the maximum mean peel strength is at least about 220 times greater than the minimum mean peel strength. In an embodiment, the maximum mean peel strength is at least about 230 times greater than the minimum mean peel strength. In an embodiment, the maximum mean peel strength is at least about 240 times greater than the minimum mean peel strength. In an embodiment, the maximum mean peel strength is at least about 250 times greater than the minimum mean peel strength.

In an embodiment, for example, when the TAPI layer is not present and the debonding zones are present in the BAPI (or the API, a single layer), the invention provides an interfacial region comprising at least two zones, wherein the zone with maximum mean peel strength has a mean peel strength that is from about 2 times to about 250 times greater than a mean peel strength of the zone with minimum mean peel strength; or wherein the maximum mean peel strength is from about 3 times to about 225 times greater than the minimum mean peel strength; or wherein or wherein the maximum mean peel strength is from about 4 times to about 200 times greater than the minimum mean peel strength; or wherein the maximum mean peel strength is from about 5 times to about 175 times greater than the minimum mean peel strength; or wherein the maximum mean peel strength is from about 5 times to about 150 times greater than the minimum mean peel strength; or wherein or wherein the maximum mean peel strength is from about 5 times to about 125 times greater than the minimum mean peel strength; or wherein the maximum mean peel strength is from about 5 times to about 100 times greater than the minimum mean peel strength; or wherein the maximum mean peel strength is from about 10 times to about 95 times greater than the minimum mean peel strength; or wherein the maximum mean peel strength is from about 15 times to about 90 times greater than the minimum mean peel strength; or wherein the maximum mean peel strength is from about 20 times to about 85 times greater than the minimum mean peel strength; or wherein the maximum mean peel strength is from about 25 times to about 80 times greater than the minimum mean peel strength; or wherein the maximum mean peel strength is from about 30 times to about 75 times greater than the minimum mean peel strength; or wherein the maximum mean peel strength is from about 35 times to about 70 times greater than the minimum mean peel strength; or wherein the maximum mean peel strength is from about 40 times to about 65 times greater than the minimum mean peel strength; or wherein the maximum mean peel strength is from about 45 times to about 60 times greater than the minimum mean peel strength; or wherein the maximum mean peel strength is from about 50 times to about 55 times greater than the minimum mean peel strength.

In an embodiment, for example, when the TAPI layer is not present and the debonding zones are present in the BAPI (or the API, a single layer), the invention provides an interfacial region comprising at least two zones, wherein the zone with maximum mean peel strength has a mean peel strength that is from about 2 times to about 5 times greater than a mean peel strength of the zone with minimum mean peel strength; or wherein the maximum mean peel strength is from about 5 times to about 10 times greater than the minimum mean peel strength; or wherein the maximum mean peel strength is from about 10 times to about 15 times greater than the minimum mean peel strength; or wherein the maximum mean peel strength is from about 15 times to about 20 times greater than the minimum mean peel strength; or wherein the maximum mean peel strength is from about 20 times to about 25 times greater than the minimum mean peel strength; or wherein the maximum mean peel strength is from about 25 times to about 30 times greater than the minimum mean peel strength; or wherein the maximum mean peel strength is from about 30 times to about 35 times greater than the minimum mean peel strength; or wherein the maximum mean peel strength is from about 35 times to about 40 times greater than the minimum mean peel strength; or wherein the maximum mean peel strength is from about 40 times to about 45 times greater than the minimum mean peel strength; or wherein the maximum mean peel strength is from about 45 times to about 50 times greater than the minimum mean peel strength; or wherein the maximum mean peel strength is from about 50 times to about 55 times greater than the minimum mean peel strength; or wherein the maximum mean peel strength is from about 55 times to about 60 times greater than the minimum mean peel strength; or wherein the maximum mean peel strength is from about 60 times to about 65 times greater than the minimum mean peel strength; or wherein the maximum mean peel strength is from about 65 times to about 70 times greater than the minimum mean peel strength; or wherein the maximum mean peel strength is from about 70 times to about 75 times greater than the minimum mean peel strength; or wherein the maximum mean peel strength is from about 75 times to about 80 times greater than the minimum mean peel strength; or wherein the maximum mean peel strength is from about 80 times to about 85 times greater than the minimum mean peel strength; or wherein the maximum mean peel strength is from about 85 times to about 90 times greater than the minimum mean peel strength; or wherein the maximum mean peel strength is from about 90 times to about 95 times greater than the minimum mean peel strength; or wherein the maximum mean peel strength is from about 95 times to about 100 times greater than the minimum mean peel strength or wherein the maximum mean peel strength is from about 100 times to about 105 times greater than the minimum mean peel strength; or wherein the maximum mean peel strength is from about 105 times to about 110 times greater than the minimum mean peel strength; or wherein the maximum mean peel strength is from about 110 times to about 115 times greater than the minimum mean peel strength; or wherein the maximum mean peel strength is from about 115 times to about 120 times greater than the minimum mean peel strength; or wherein the maximum mean peel strength is from about 120 times to about 125 times greater than the minimum mean peel strength; or wherein the maximum mean peel strength is from about 125 times to about 130 times greater than the minimum mean peel strength; or wherein the maximum mean peel strength is from about 130 times to about 135 times greater than the minimum mean peel strength; or wherein the maximum mean peel strength is from about 135 times to about 140 times greater than the minimum mean peel strength; or wherein the maximum mean peel strength is from about 140 times to about 145 times greater than the minimum mean peel strength; or wherein the maximum mean peel strength is from about 145 times to about 150 times greater than the minimum mean peel strength; or wherein the maximum mean peel strength is from about 150 times to about 155 times greater than the minimum mean peel strength; or wherein the maximum mean peel strength is from about 155 times to about 160 times greater than the minimum mean peel strength; or wherein the maximum mean peel strength is from about 160 times to about 165 times greater than the minimum mean peel strength; or wherein the maximum mean peel strength is from about 165 times to about 170 times greater than the minimum mean peel strength; or wherein the maximum mean peel strength is from about 170 times to about 175 times greater than the minimum mean peel strength; or wherein the maximum mean peel strength is from about 175 times to about 180 times greater than the minimum mean peel strength; or wherein the maximum mean peel strength is from about 180 times to about 185 times greater than the minimum mean peel strength; or wherein the maximum mean peel strength is from about 185 times to about 190 times greater than the minimum mean peel strength; or wherein the maximum mean peel strength is from about 190 times to about 195 times greater than the minimum mean peel strength; or wherein the maximum mean peel strength is from about 195 times to about 200 times greater than the minimum mean peel strength; or wherein the maximum mean peel strength is from about 200 times to about 205 times greater than the minimum mean peel strength; or wherein the maximum mean peel strength is from about 205 times to about 210 times greater than the minimum mean peel strength; or wherein the maximum mean peel strength is from about 210 times to about 215 times greater than the minimum mean peel strength; or wherein the maximum mean peel strength is from about 215 times to about 220 times greater than the minimum mean peel strength; or wherein the maximum mean peel strength is from about 220 times to about 225 times greater than the minimum mean peel strength; or wherein the maximum mean peel strength is from about 225 times to about 230 times greater than the minimum mean peel strength; or wherein the maximum mean peel strength is from about 230 times to about 235 times greater than the minimum mean peel strength; or wherein the maximum mean peel strength is from about 235 times to about 240 times greater than the minimum mean peel strength; or wherein the maximum mean peel strength is from about 240 times to about 245 times greater than the minimum mean peel strength; or wherein the maximum mean peel strength is from about 245 times to about 250 times greater than the minimum mean peel strength.

The peel strength in some cases exceeds the peel arm strength, thereby causing a tear to occur, whereby making the further determination of the peel strength difficult or void of specific information via this technique to provide a measurement for any region beyond this point of test failure. Thereby, the highest peel strength is taken as that measured/observed just prior to initiation of the tearing through the bulk of the peel arm and/or in any significant separation of layers within the peel arm.

In an embodiment, for example, when the TAPI layer is not present and the debonding zones are present in the BAPI (or the API, a single layer), the invention provides an interfacial region comprising at least two zones, wherein at least one of the zones has a mean peel strength of from about 0.01 to about 4.0 kJ/m²; or wherein at least one of the zones has a mean peel strength of from about 0.25 to about 3.5 kJ/m²; or wherein at least one of the zones has a mean peel strength of from about 0.5 to about 3.0 kJ/m²; or wherein at least one of the zones has a mean peel strength of from about 0.75 to about 2.5 kJ/m²; or wherein at least one of the zones has a mean peel strength of from about 1.0 to about 2.0 kJ/m²; or wherein at least one of the zones has a mean peel strength of from about 1.25 to about 1.5 kJ/m².

In yet another embodiment, for example, when the TAPI layer is not present and the debonding zones are present in the BAPI (or the API, a single layer), the invention provides an interfacial region comprising at least two zones, wherein at least one of the zones has a mean peel strength of from about 0.01 to about 0.5 kJ/m²; or wherein at least one of the zones has a mean peel strength of from about 0.5 to about 1.0 kJ/m²; or wherein at least one of the zones has a mean peel strength of from about 1.0 to about 1.5 kJ/m²; or wherein at least one of the zones has a mean peel strength of from about 1.5 to about 2.0 kJ/m²; or wherein at least one of the zones has a mean peel strength of from about 2.0 to about 2.5 kJ/m²; or wherein at least one of the zones has a mean peel strength of from about 2.5 to about 3.0 kJ/m²; or wherein at least one of the zones has a mean peel strength of from about 3.0 to about 3.5 kJ/m²; or wherein at least one of the zones has a mean peel strength of from about 3.5 to about 4.0 kJ/m².

In yet another embodiment, for example, when the TAPI layer is not present and the debonding zones are present in the BAPI (or the API, a single layer), the invention provides an interfacial region comprising at least two zones, wherein at least one of the zones has a mean peel strength of from about 8.0 to about 12.0 kJ/m²; or wherein at least one of the zones has a mean peel strength of from about 8.5 to about 11.5 kJ/m²; or wherein at least one of the zones has a mean peel strength of from about 9.0 to about 11.0 kJ/m²; or wherein at least one of the zones has a mean peel strength of from about 9.5 to about 10.5 kJ/m².

In yet another embodiment, for example, when the TAPI layer is not present and the debonding zones are present in the BAPI (or the API, a single layer), the invention provides an interfacial region comprising at least two zones, wherein at least one of the zones has a mean peel strength of from about 8.0 to about 8.5 kJ/m²; or wherein at least one of the zones has a mean peel strength of from about 8.5 to about 9.0 kJ/m²; or wherein at least one of the zones has a mean peel strength of from about 9.0 to about 9.5 kJ/m²; or wherein at least one of the zones has a mean peel strength of from about 10.0 to about 10.5 kJ/m²; or wherein at least one of the zones has a mean peel strength of from about 10.5 to about 11.0 kJ/m²; or wherein at least one of the zones has a mean peel strength of from about 11.0 to about 11.5 kJ/m²; or wherein at least one of the zones has a mean peel strength of from about 11.5 to about 12.0 kJ/m².

In one embodiment comprising at least two zones, the mean peel strength of the zone with the maximum mean peel strength is in the range of from about 0.3 kJ/m² to about 12.0 kJ/m². Stated another way, the mean peel strength can be any one of the following numbers in kJ/m²:

0.3, 0.4, 0.5, . . . , 1.0, 1.5, 2.0, . . . 3.0, 4.0, 5.0, 6.0, 7.0, 8.0, 9.0, 10.0, 11.0, and 12.0.

In one embodiment, such mean peel strength is within the range defined by selecting any two numbers above, including the end-points of such range.

In an embodiment, the invention provides a CAPI comprising at least two zones, wherein the zones are distributed in an ordered pattern. In an embodiment, the zones are distributed in a grid, in concentric circles or in a dot pattern. In another embodiment, the invention provides a polymeric interlayer comprising at least two zones, wherein the zones are distributed stochastically.

In another embodiment, the invention provides a debonding region comprising at least two zones, wherein at least one of the zones comprises a polyvinyl acetal, an ionomer, a thermoplastic elastomer, a silane, an ethylvinylacetate, or combinations thereof. In an embodiment, at least one of the zones comprises a polyvinyl acetal. In an embodiment, at least one of the zones comprises an ionomer. In an embodiment, at least one of the zones comprises a thermoplastic elastomer. In an embodiment, at least one of the zones comprises a silane. In an embodiment, at least one of the zones comprises an ethylvinylacetate. In an embodiment, at least one of the zones comprises a combination of one of these materials.

In yet another embodiment, the invention provides a debonding region comprising at least two zones, wherein the zones each comprise a polyvinyl acetal, an ionomer, a thermoplastic elastomer, a silane, an ethylvinylacetate, or combinations thereof. In an embodiment, the zones each comprises a polyvinyl acetal. In yet another embodiment, both of the zones comprise an ionomer. In an embodiment, the zones each comprise a thermoplastic elastomer. In an embodiment, the zones each comprise a silane. In an embodiment, the zones each comprise an ethylvinylacetate. In an embodiment, the zones each comprise a combination of these materials.

In another embodiment, the invention provides a debonding region comprising at least two zones, wherein at least one of the zones comprises the ionomer and the ionomer is a sodium-neutralized ethylene-α,β-unsaturated carboxylic acid copolymer. In another embodiment, the invention provides a polymeric interlayer comprising at least two zones, wherein the zones each comprise the ionomer and the ionomer is a sodium-neutralized ethylene-α,β-unsaturated carboxylic acid copolymer.

In another embodiment, the invention provides a debonding region comprising at least two zones, wherein at least one of the zones comprises the polyvinyl acetal and the polyvinyl acetal is a polyvinyl butyral. In another embodiment, the invention provides a fluorinated-ethylene-propylene (FEP) layer comprising at least two zones, wherein the zones each comprise the polyvinyl acetal and the polyvinyl acetal is a polyvinyl butyral.

In yet another embodiment, the invention provides a polymeric interlayer (TAPI or BAPI for the discussion below) comprising at least two zones, wherein at least one of the zones further comprises an adhesion modifying agent. In an embodiment, the adhesion modifying agent is a silane, an alkali metal salt, an alkaline earth metal salt or a carboxylic group-containing olefinic polymer. In an embodiment, the adhesion modifying agent is a silane. In an embodiment, the adhesion modifying agent is an alkali metal salt. In an embodiment, the adhesion modifying agent is an alkaline earth metal salt. In an embodiment, the adhesion modifying agent is a carboxylic group-containing olefinic polymer.

In another embodiment, the invention provides a polymeric interlayer comprising at least two zones, wherein at least one of the zones comprises the adhesion modifying agent in a range of from about 5% to about 25% by weight of combined weight in the zone. In another embodiment, the invention provides a polymeric interlayer comprising at least two zones, wherein at least one of the zones comprises the adhesion modifying agent in a range of from about 10% to about 20% by weight of combined weight in the zone.

In yet another embodiment, the invention provides, wherein at least one of the zones comprises the adhesion modifying agent in a range of from about 5% to about 10% by weight of combined weight in the zone; or wherein at least one of the zones comprises the adhesion modifying agent in a range of from about 10% to about 15% by weight of combined weight in the zone; or wherein at least one of the zones comprises the adhesion modifying agent in a range of from about 15% to about 20% by weight of combined weight in the zone; or wherein at least one of the zones comprises the adhesion modifying agent in a range of from about 20% to about 25% by weight of combined weight in the zone.

In another embodiment, the invention provides a polymeric interlayer comprising at least two zones, wherein at least one of the zones comprises the adhesion modifying agent in a range of from about 50% to about 75% by weight of combined weight in the zone. In another embodiment, the invention provides a polymeric interlayer comprising at least two zones, wherein at least one of the zones comprises the adhesion modifying agent in a range of from about 60% to about 70% by weight of combined weight in the zone.

In another embodiment, the invention provides a polymeric interlayer comprising at least two zones, wherein at least one of the zones comprises the adhesion modifying agent in a range of from about 50% to about 55% by weight of combined weight in the zone; or wherein the adhesion modifying agent is present in a range of from about 55% to about 60% by weight of combined weight in the zone; or wherein the adhesion modifying agent is present in a range of from about 65% to about 70% by weight of combined weight in the zone; or wherein the adhesion modifying agent is present in a range of from about 70% to about 75% by weight of combined weight in the zone.

In yet another embodiment, the invention provides a polymeric interlayer comprising at least two zones, wherein the interlayer has a thickness of from about 0.1 mm to about 10.0 mm; or wherein the interlayer has a thickness of from about 0.25 mm to about 7.5 mm; or wherein the interlayer has a thickness of from about 0.35 mm to about 5.0 mm; or wherein the interlayer has a thickness of from about 0.5 mm to about 2.5 mm.

In yet another embodiment, the invention provides a polymeric interlayer comprising at least two zones, wherein the interlayer has a thickness of from about 0.1 mm to about 1.0 mm; or wherein the interlayer has a thickness of from about 1.0 mm to about 2.0 mm; or wherein the interlayer has a thickness of from about 2.0 mm to about 3.0 mm; or wherein the interlayer has a thickness of from about 3.0 mm to about 4.0 mm; or wherein the interlayer has a thickness of from about 4.0 mm to about 5.0 mm; or wherein the interlayer has a thickness of from about 5.0 mm to about 6.0 mm; or wherein the interlayer has a thickness of from about 6.0 mm to about 7.0 mm; or wherein the interlayer has a thickness of from about 7.0 mm to about 8.0 mm; or wherein the interlayer has a thickness of from about 8.0 mm to about 9.0 mm; or wherein the interlayer has a thickness of from about 9.0 mm to about 10.0 mm.

In a further embodiment, the invention provides a polymeric interlayer comprising at least two zones, wherein the interlayer is disposed between two panes of glass. In an embodiment, at least one of the glass panes is float glass. In an embodiment, both of the glass panes are float glass. In an embodiment, the interlayer is in contact with the tin side of the float glass.

In yet another embodiment, the invention provides a debonding region comprising at least two zones, wherein the fluorinated-ethylene-propylene (FEP) layer has a thickness of from about 0.001 mm to about 1.0 mm; or wherein the fluorinated-ethylene-propylene (FEP) layer has a thickness of from about 0.01 mm to about 0.5 mm; or wherein the fluorinated-ethylene-propylene (FEP) layer has a thickness of from about 0.15 mm to about 0.2 mm.

In yet another embodiment, the invention provides a debonding region comprising at least two zones, wherein the Debonding region has a thickness of from about 0.001 mm to about 1.0 mm; or wherein the debonding region has a thickness of from about 0.01 mm to about 0.5 mm; or wherein the debonding region has a thickness of from about 0.15 mm to about 0.25 mm.

In a further embodiment, the invention provides a debonding region comprising at least two zones, wherein the debonding region is disposed between two panes of glass. In an embodiment, at least one of the glass panes is float glass. In an embodiment, both of the glass panes are float glass. In an embodiment, the debonding region is in contact with the tin side of the float glass.

In yet another embodiment, the invention provides a debonding region comprising at least three zones; or wherein the debonding region comprises at least four zones; or wherein the interlayer comprises at least five zones; or wherein the debonding region comprises at least six zones; or wherein the debonding region comprises at least seven zones; or wherein the debonding region comprises at least eight zones; or wherein the debonding region comprises at least nine zones; or wherein the debonding region comprises at least ten zones.

In a further embodiment, the invention provides a polymeric interlayer comprising at least two zones, wherein at least one of the zones is shaped as a dot, a circle, a square, a rectangle, a pentagon, a hexagon; or is amorphous. In a further embodiment, the invention provides a polymeric interlayer comprising at least two zones, wherein the zones are each shaped as a dot, a circle, an oval, a triangle, a square, a rectangle, a pentagon, a hexagon; or is amorphous. In an embodiment, at least one of the zones are shaped as a dot. In an embodiment, at least one of the zones are shaped as a circle. In an embodiment, at least one of the zones are shaped as an oval. In an embodiment, at least one of the zones are shaped as a triangle. In an embodiment, at least one of the zones are shaped as a square. In an embodiment, at least one of the zones are shaped as a rectangle. In an embodiment, at least one of the zones are shaped as a pentagon. In an embodiment, at least one of the zones are shaped as a hexagon. In an embodiment, at least one of the zones are amorphous.

In a further embodiment, the invention provides a polymeric interlayer comprising at least two zones, wherein at least one of the zones is shaped as gridlines, crisscross lines, random lines, concentric circles, eccentric circles, spaghetti patterns and flat strips. In a further embodiment, the invention provides a polymeric interlayer comprising at least two zones, wherein the zones are each shaped as gridlines, crisscross lines, random lines, concentric circles, eccentric circles, spaghetti patterns and flat strips. In an embodiment, at least one of the zones are shaped as gridlines. In an embodiment, at least one of the zones are shaped as crisscross lines. In an embodiment, at least one of the zones are shaped as random lines. In an embodiment, at least one of the zones are shaped as concentric circles. In an embodiment, at least one of the zones are shaped as eccentric circles. In an embodiment, at least one of the zones are shaped as a spaghetti pattern. In an embodiment, at least one of the zones are shaped as a flat strip.

In a further embodiment, the invention provides a polymeric interlayer comprising at least two zones, wherein the zones have a size in a range of from about 0.5 times a thickness of the interlayer to about 10 times the thickness of the interlayer; or wherein the zones have a size in a range of from about 1.5 times the thickness to about 9.0 times the thickness of the interlayer; or wherein the zones have a size in a range of from about 2.0 times the thickness to about 8.0 times the thickness of the interlayer; or wherein the zones have a size in a range of from about 3.0 times the thickness to about 7.0 times the thickness of the interlayer; or wherein the zones have a size in a range of from about 4.0 times the thickness to about 6.0 times the thickness of the interlayer; or wherein the zones have a size in a range of from about 4.5 times the thickness to about 5.5 times the thickness of the interlayer; or wherein the zones have a size that is about 5.0 times the thickness to of the interlayer.

In a further embodiment, the invention provides a polymeric interlayer comprising at least two zones, wherein the zones have a size in a range of from about 0.5 times a thickness of the interlayer to about 1.5 times the thickness of the interlayer; or wherein the zones have a size in a range of from about 1.5 times the thickness to about 2.0 times the thickness of the interlayer; or wherein the zones have a size in a range of from about 2.0 times the thickness to about 3.0 times the thickness of the interlayer; or wherein the zones have a size in a range of from about 3.0 times the thickness to about 4.0 times the thickness of the interlayer; or wherein the zones have a size in a range of from about 4.0 times the thickness to about 5.0 times the thickness of the interlayer; or wherein the zones have a size in a range of from about 5.0 times the thickness to about 6.0 times the thickness of the interlayer; or wherein the zones have a size in a range of from about 5.0 times the thickness to about 6.0 times the thickness of the interlayer; or wherein the zones have a size in a range of from about 6.0 times the thickness to about 7.0 times the thickness of the interlayer; or wherein the zones have a size in a range of from about 7.0 times the thickness to about 8.0 times the thickness of the interlayer; or wherein the zones have a size in a range of from about 8.0 times the thickness to about 9.0 times the thickness of the interlayer; or wherein the zones have a size in a range of from about 9.0 times the thickness to about 10.0 times the thickness of the interlayer.

In yet a further embodiment, the invention provides a polymeric interlayer comprising at least two zones, wherein the zones are shaped as a dot or circle having a diameter in the range of from about 0.5 times a thickness of the interlayer to about 10 times the thickness of the interlayer; or wherein the zones are shaped as a dot or circle having a diameter in the range of from about 1.5 times the thickness to about 9.0 times the thickness of the interlayer; or wherein the zones are shaped as a dot or circle having a diameter in the range of from about 2.0 times the thickness to about 8.0 times the thickness of the interlayer; or wherein the zones are shaped as a dot or circle having a diameter in the range of from about 3.0 times the thickness to about 7.0 times the thickness of the interlayer; or wherein the zones are shaped as a dot or circle having a diameter in the range of from about 4.0 times the thickness to about 6.0 times the thickness of the interlayer; or wherein the zones are shaped as a dot or circle having a diameter in the range of from about 5.5 times the thickness to about 5.5 times the thickness of the interlayer; or wherein the zones are shaped as a dot or circle having a diameter that is about 5.0 times the thickness to of the interlayer.

In yet a further embodiment, the invention provides a polymeric interlayer comprising at least two zones, wherein the zones are shaped as a dot or circle having a diameter in the range of from about 0.5 times a thickness of the interlayer to about 1.5 times the thickness of the interlayer; or wherein the zones are shaped as a dot or circle having a diameter in the range of from about 1.5 times the thickness to about 2.0 times the thickness of the interlayer; or wherein the zones are shaped as a dot or circle having a diameter in the range of from about 2.0 times the thickness to about 3.0 times the thickness of the interlayer; or wherein the zones are shaped as a dot or circle having a diameter in the range of from about 3.0 times the thickness to about 4.0 times the thickness of the interlayer; or wherein the zones are shaped as a dot or circle having a diameter in the range of from about 4.0 times the thickness to about 5.0 times the thickness of the interlayer; or wherein the zones are shaped as a dot or circle having a diameter in the range of from about 5.0 times the thickness to about 6.0 times the thickness of the interlayer; or wherein the zones are shaped as a dot or circle having a diameter in the range of from about 5.0 times the thickness to about 6.0 times the thickness of the interlayer; or wherein the zones are shaped as a dot or circle having a diameter in the range of from about 6.0 times the thickness to about 7.0 times the thickness of the interlayer; or wherein the zones are shaped as a dot or circle having a diameter in the range of from about 7.0 times the thickness to about 8.0 times the thickness of the interlayer; or wherein the zones are shaped as a dot or circle having a diameter in the range of from about 8.0 times the thickness to about 9.0 times the thickness of the interlayer; or wherein the zones are shaped as a dot or circle having a diameter in the range of from about 9.0 times the thickness to about 10.0 times the thickness of the interlayer.

In yet another embodiment, this invention relates to an adhesive polymeric interlayer (API) as described above, wherein an effective diameter of the discrete zone is in a range of from about 0.1 mm to about 50 mm. In one embodiment, the invention provides an API wherein an effective diameter of the discrete zone selected from one of the following numbers or is in a range defined by any two numbers including the endpoints of such range, as measured in mm:

0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50.

In yet another embodiment, this invention relates to an adhesive polymeric interlayer (API) as described above, wherein the effective diameter of the regular shaped discrete zone, the random shaped discrete zone, or the cluster discrete zone is from about 1 multiple to about 150,000,000-multiples of the thickness of the discrete zone. An exemplary set of multiples includes the following numbers, those included within a range formed by any two numbers below:

1, 5, 10, 20, 100, 150, 200, 1000, 5000, 10000, 20000, 50000, 100000, 200000, 500000, 1000000, 5000000, 10000000, 20000000, 50000000, 100000000, 120000000, 125000000, and 150000000.
In one embodiment, the effective diameter of the regular shaped discrete debonding zone, the random shaped discrete debonding zone, or the cluster discrete zone is from about 1 multiple to about 150,000,000-multiples of the thickness of the discrete debonding zone. Stated differently, the thickness and the size in terms of effective diameter of the discrete debonding zone can the same, or the can range in multiples of 2, 3, 4, 5, . . . 100, 200, 300, . . . 1000, 2000, 3000, . . . , 10000, 20000, 30000 , , , 100000, 200000, 300000 , , , 1 million (M), 2M, 3M , , , 10M, 2M, 3M , , , 100M, 110M, 120M, 130M, and 150M of the thickness of the discrete zone.

In one embodiment, the invention provides an interlayer that comprises discrete debonding treated zones that have a surface area on one side that is a percentage number of the area of the substrate or the API surface where the percentage number is one of the following numbers, or is within a range defined by any two of the following numbers, including the endpoints of such range:

1, 2, 3,4, 5,6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 51, 52, 53, 54, 55, 56, 57, 58, 59, 60, 61, 62, 63, 64, 65, 66, 67, 68, 69, 70, 71, 72, 73, 74, 75, 76, 77, 78, 79, and 80.

In one embodiment, the invention provides polymeric interlayer comprising at least two zones, wherein at least one of the zones covers a surface area of from about 10% to about 100% of one of the glass panes:

10, 11,12 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47,48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

In one embodiment, the invention relates to a polymeric interlayer comprising at least two zones, wherein at least one of the zones covers a surface area of one of the glass panes, which is within a range defined by any two numbers above, in the units of percent surface area covered, including the endpoints of such a range.

In yet a further embodiment, the invention provides a polymeric interlayer comprising at least two zones, wherein one of the zones covers a surface area of from about 10% to about 100% of one of the glass panes; or wherein one of the zones covers a surface area of from about 15% to about 55% of one of the glass panes; or wherein one of the zones covers a surface area of from about 20% to about 50% of one of the glass panes; or wherein one of the zones covers a surface area of from about 25% to about 45% of one of the glass panes; or wherein one of the zones covers a surface area of from about 30% to about 40% of one of the glass panes.

In yet a further embodiment, the invention provides a polymeric interlayer comprising at least two zones, wherein one of the zones covers a surface area of from about 10% to about 15% of one of the glass panes; or wherein one of the zones covers a surface area of from about 15% to about 20% of one of the glass panes; or wherein one of the zones covers a surface area of from about 20% to about 25% of one of the glass panes; or wherein one of the zones covers a surface area of from about 25% to about 30% of one of the glass panes; or wherein one of the zones covers a surface area of from about 30% to about 35% of one of the glass panes; or wherein one of the zones covers a surface area of from about 35% to about 40% of one of the glass panes; or wherein one of the zones covers a surface area of from about 40% to about 45% of one of the glass panes; or wherein one of the zones covers a surface area of from about 45% to about 50% of one of the glass panes; or wherein one of the zones covers a surface area of from about 50% to about 55% of one of the glass panes; or wherein one of the zones covers a surface area of from about 55% to about 60% of one of the glass panes.

In yet a further embodiment, the invention provides a polymeric interlayer comprising at least two zones, wherein one of the zones covers a surface area of from about 1% to about 35% of one of the glass panes; or wherein one of the zones covers a surface area of from about 5% to about 30% of one of the glass panes; or wherein one of the zones covers a surface area of from about 5% to about 25% of one of the glass panes; or wherein one of the zones covers a surface area of from about 10% to about 20% of one of the glass panes.

In yet a further embodiment, the invention provides a polymeric interlayer comprising at least two zones, wherein one of the zones covers a surface area of from about 1% to about 5% of one of the glass panes; or wherein one of the zones covers a surface area of from about 5% to about 10% of one of the glass panes; or wherein one of the zones covers a surface area of from about 10% to about 15% of one of the glass panes; or wherein one of the zones covers a surface area of from about 15% to about 20% of one of the glass panes; or wherein one of the zones covers a surface area of from about 20% to about 25% of one of the glass panes; or wherein one of the zones covers a surface area of from about 25% to about 30% of one of the glass panes; or wherein one of the zones covers a surface area of from about 30% to about 35% of one of the glass panes.

In yet a further embodiment, the invention provides a polymeric interlayer comprising at least two sets of discrete zones, wherein one set of discrete zones, for example, the controlled debonding treatment zones covers a surface area of: from about 1% to about 80% of the surface areas of one of the glass substrate; from about 10% to about 60% of one of the glass panes; from about 20% to about 50% of one of the glass substrate; from about 30% to about 40% of the surface areas of one of the glass substrate; from about 5% to about 25% of the surface areas of one of the glass substrate; from about 1% to about 35% of the surface areas of one of the glass substrate; from about 15% to about 55% of one of the glass panes; from about 25% to about 45% of one of the glass panes; from about 10% to about 15% of one of the glass panes; from about 15% to about 20% of one of the glass panes; from about 20% to about 25% of one of the glass panes; from about 25% to about 30% of one of the glass panes; from about 30% to about 35% of one of the glass panes; from about 35% to about 40% of one of the glass panes; from about 40% to about 45% of one of the glass panes; from about 45% to about 50% of one of the glass panes; from about 50% to about 55% of one of the glass panes; or from about 55% to about 60% of one of the glass panes.

In one embodiment, this invention envisions the same area coverage or a different area coverage between a first glass substrate and the corresponding API surface and a second glass substrate and the corresponding API surface, for example in a glass substrate 1/API/glass substrate 2 laminate.

In one embodiment, this invention also envisions stacks of laminates. So, for example if glass substrate was designated as “A” and the API was designated as “B”, the following laminates are envisioned herein:

A1/B1; A1/B1/A2; A1/B1/A2/B2/A3; A1/B1/A2/B2/B3/A3 . . . ; and A1/B1B2B3/A2/B4/A3; and so on and so forth. At least one of the API layers in such a stack of the invention comprises the discrete zones as described herein.

The above can be represented by a general formula:

(AₓB_{y}A_{w})_{z}:

wherein y, 1≤y≤90;
wherein z, 1≤z≤30; and
wherein x=1, and w=1; or x=0 and w=1; or x=1 and w=0. In other words, an A₀ means the substrate is not present in that arrangement at that spot in a stack.

In one embodiment, this invention envisions another protective layer—abrasion-resistance coated polyester for example. While this invention has been described with a focus on a rigid substrate (e.g. glass), in some cases a coated polyester, polycarbonate, nylon, and other polymeric substrates are also included.

In one embodiment of the invention, thinner interlayers are plied together to make a thicker interlayer.

In yet another embodiment, the invention provides a polymeric interlayer comprising at least three zones; or wherein the interlayer comprises at least four zones; or wherein the interlayer comprises at least five zones; or wherein the interlayer comprises at least six zones; or wherein the interlayer comprises at least seven zones; or wherein the interlayer comprises at least eight zones; or wherein the interlayer comprises at least nine zones; or wherein the interlayer comprises at least ten zones.

In yet another embodiment, the invention provides a polymeric interlayer comprising the number of zones per cm² in the range 0.04 to 10,000 including the endpoints of the range. Elaborating further, for example, in one embodiment, the number of zones per cm² include any one of the following numbers and any number within a range defined by any two numbers below, including the endpoints:

0.04, 0.05, 0.06, 0.07, 0.08, 0.09, 0.1, 0.5, 0.8, 1.0, 10, 20, 50, 100, 200, 500, 1000, 2000, 3000, 4000, 5000, 6000, 7000, 8000, 9000, and 10000.

In one embodiment, the number of zones described above are measured per cm², per inch², per ft², and per m².

In another embodiment, the invention provides a polymeric interlayer comprising three zones; or wherein the interlayer comprises at least four zones; or wherein the interlayer comprises at least five zones; or wherein the interlayer comprises at least six zones; or wherein the interlayer comprises at least seven zones; or wherein the interlayer comprises at least eight zones; or wherein the interlayer comprises at least nine zones; or wherein the interlayer comprises at least ten zones.

In an embodiment, the invention provides a laminate comprising the polymeric interlayer described herein. In an embodiment, the laminate comprises wood, plastic, or glass. In an embodiment, the laminate comprises wood. In an embodiment, the laminate comprises plastic. In an embodiment, the laminate comprises glass.

The invention will be further understood from the following specific examples of the properties of the laminated glass. However, it will be understood that these examples are not to be construed as limiting the scope of the present invention in any manner.

### EXPERIMENTAL

### Discrete Debonding Zones

### Materials

The materials used in the examples are as follows:

The glass used in the Examples was soda-lime glass, standard annealed (obtained from Guardian Industries, Inc., Galax VA, USA).

Ionomer—a partially neutralized ethylene acid dipolymer ionomer obtained from The Dow Company, Midland, MI (21.7% methacrylic acid, Na 26% neutralized, MI=1.8 @190° C.).

The adhesion promotion used was gamma-aminopropyltriethoxysilane (Silquest A-1100, available from Momentive Performance Materials, Inc., Waterford, NY USA).

Fluorinated-ethylene-propylene (FEP) films (DuPont Teflon® FEP-50) used was 13 microns in thickness and purchased from American Durafilm Co, Inc., 55 Boynton Rd, Holliston MA 01746.

A superior interlayer composite structure where the API is treated such that more robust adhesiveness to the substrate is created in a more dependable fashion so that a targeted adhesive level is created over the conventional art. The debonding occurs within a desired range for the underlying API to dissipate energy in a favorable manner when the composite structure is impacted and the like.

The adhesive properties of conventional interlayers, such as PVB, are highly influenced by the presence of moisture. Without being held to theory, it has been reported that the adhesiveness is largely provided by hydrogen-bonding between the hydroxyl groups within the polymer chains of the PVB interlayer and the silanol groups on the glass surface (as one example of a composite structure type). The presence of water reduces the adhesiveness by effectively competing with the interaction of the hydroxy groups of the PVB and the silanol groups on the glass surface. The present invention seeks to provide a more robust interfacial bonding mechanism than that obtained through the conventional means. This approach provides a reliable means for adjusting the debonding energy between the substrate and API for optimizing the total energy absorbing capability of the composite laminate structure.

### EXAMPLES

Functional silanes are used in the examples below, but titanates and zirconates may also be used individually or in combinations to achieve the desired adhesive effect.

Example MB-1: A masterbatch is created by taking PVB resin containing about 40 to 48 wt. % hydroxyl (MW 50,000) is imbibed with a combination of (3-Glycidoxypropyl)triethoxysilane at 0.05 weight % and 0.10% (3-Glycidoxypropyl)methyldiethoxysilane by tumbling combined together on a roller mill in a closed container for 4 hours. The contents are then compounded together in a twin-screw extruder at a melt temperature of 240 C.

Example MB-2: A masterbatch is created by taking PVB resin containing about 18 to 21 wt. % hydroxyl (Mowital B16H) is imbibed with Octyl/decyl glycidyl ether CAS Number 68609-96-1 (available from Sigma-Aldrich) at 0.5 weight % by tumbling together on a roller mill in a closed container for 4 hours. The contents are then compounded together in a twin-screw extruder at a melt temperature of 220 C.

Example S-1: The extruded masterbatch products that are cited above are each strand-cut and dried. The masterbatch materials are then dissolved in 2-propanol at 0.1 weight % and the solution made from MB-2 is transfer printed onto the embossing roll in a position 90 degrees forward of the sheeting embossing nip position. The transfer printing consists of dots that are 2-mm circles and with a spacing such that 50% of the surface is covered with the printed dots. The solvent dries due to the elevated temperature of the embossing roll (˜150 C). At the 45 degree position, a solution made from MB-1 is transfer roll coated as a solid film layer onto the moving embossing roller ahead of the embossing nip position. Again, the solvent is removed by the heat of the embossing roll. These two deposits are than thermally transferred to the web of PVB interlayer sheeting (c.f. Trosifol® Type B550J—nominal thickness 0.76-mm) passing through the embossing nips. The embossing roll also provides the sheeting with a surface texture for de-airing purposes for eventual conversion into a glass laminate. Thus, during this coating transfer operation, the MB-1 material is transferred onto the outer-surface of the PVB sheeting as an overlay over the MB-2 material (discrete pattern of dots) previously applied. This same steps are repeated such that both sides of the sheeting are so modified with the adhesion treatment.

TABLE 1.1

| | | Mean Peel Strength, | | |
|---|---|---|---|---|
| | | γ [kJ/m²] | | |
| | | Sheet Moisture Level (wt. %) | | |
| Example | | 0.15 | 0.45 | 0.80 |
| C1 | Trosifol ® Type B550J | 8 | 5 | 2 |
| S-1 | Composite dot coated surface | 6 | 5 | 4 |

Traditional PVB sheeting is highly influenced by the level of moisture within the interlayer. A moderate adhesion level is generally the targeted goal to achieve a balance of durability/weathering (delamination resistance) and impact performance. Although, an optimum adhesion level is obtained at an intermediate moisture level (0.45%), the adhesion under dry conditions (0.15%) is very high and drops to a very low adhesion level at high moisture (0.8%). In the case for the sheeting that is treated with the dots/continuous layer solutions to form Example S-1, one can see the advantageous robustness of the debonding energy against moisture level. The impact performance of this treated API is improved over the conventional art as it exhibits less sensitivity to moisture. The embossed roll coating contains some disparities due to the roughness but does not detract from the functionality of the invention as a largely continuous layer is formed and transferred to the sheeting during the embossing step.

Similar benefits are found using Example S-2, whereby debonding occurs with the near vicinity of the S-1 discrete dots in a cohesive fashion and a fracture interface is created due to the lower cohesive fracture energy of the MB-1 layer. Any means which allows for the compositional placement of the materials above are within the scope of this invention. This can include transfer coating, co-lamination, spray or particle deposition, printing, and the like.

### Sample Preparation

In these examples, laminate breakage behavior and glass-polymer adhesion during breakage have been studied on laminates fabricated from annealed float glass and an ionomer interlayer sold by Kuraray America, Inc. (Wilmington, DE, USA) under the trademark “SENTRYGLAS®.” The ionomer is a partially neutralized ethylene acid dipolymer ionomer obtained from The Dow Company, Midland, MI (21.7% methacrylic acid, Na 26% neutralized, MI=1.8 @190° C.).

Discrete cohesive debonding zones were created by embedding fluorinated-ethylene-propylene (FEP) films into the ionomer. The FEP film (DuPont Teflon® FEP-50) used was 13 microns in thickness and purchased from American Durafilm Co, Inc., 55 Boynton Rd, Holliston MA 01746. Holes of either 2 mm diameter or 5 mm diameter were cut into some FEP films on a 10 mm×10 mm uniform square grid pattern using a laser-cutter (BOSSLASER, Model LS-1416 608 Trestle Point, Sanford FL 32771). In all examples, the FEP films were positioned to be within the top 10% of the ionomer interlayer (i.e. close to the glass-ionomer interface).

The glass used in the Examples was soda-lime glass; standard annealed (obtained from Guardian Industries, Inc., Galax VA, USA). Float glass is manufactured by floating the molten soda-lime-silica melt on a bath of molten metallic tin. The glass “tin” side is the glass that contacted the molten tin during manufacture and the glass “air” side is the opposite side that did not come into contact with the molten tin. Trace tin (Sn) impurities in the glass “tin” surface influence polymer-glass adhesion. Float glass is available from Guardian Industries, Inc., Galax VA, USA.

All glass was washed prior to fabrication of the laminates using soapy de-ionized water at 50° C. and rinsed thoroughly using de-ionized water. Generally, to produce soapy water, soap or detergent is added to water in an amount to form a lather when mixed.

Adhesion promoter was applied to the glass surface to increase glass-ionomer adhesion. The active ingredient in the adhesion promotion treatment is gamma-aminopropyltriethoxysilane (Silquest A-1100, available from Momentive Performance Materials, Inc., Waterford, NY USA). A solution of the following composition (weight %) was used: 2-propanol (92.00%), water (7.90%), acetic acid (0.01%), gamma-aminopropyltriethoxysilane (0.09%).

Laminate Fabrication: A pre-press assembly, in which the ionomer films, FEP films and glass were stacked in the desired order at room temperature, was placed into a disposable vacuum bag and held for 60 minutes under a vacuum of 25-30 inches of water to remove any air contained between the layers of the pre-press assembly. The pre-press assembly was loaded while still applying a vacuum to the bag into an air autoclave. The samples and bags were heated to 135° C. under an applied hydrostatic air pressure of 0.7 MPa. The vacuum to the bag was removed after reaching 135° C. and the laminates were held for 90 minutes in an air autoclave at an applied hydrostatic pressure of 0.7 MPa. The samples were then cooled at an approximate rate of 4° C./minute under constant pressure. After approximately 25 minutes of cooling, when the air temperature was less than about 50° C., the excess pressure was vented and the laminate was cooled to room temperature and removed from the autoclave.

The process used in the examples is similar to many standard industrial processes for the fabrication of laminated glass and resulted in materials with high clarity and minimal imperfections (bubbles etc.).

Examples of various laminate structures made are listed in Table 1 and described in the examples section below. Note that Table 1 shows the layup of the components prior to heating and autoclaving. Wherever the FEP films contained holes, the ionomer flowed during lamination to fill in the holes and create a fully interconnected polymer phases with no remaining voids.

### Test Methods

### Laminate Breakage: Ball-On-Ring

A key performance attribute of laminated safety glass is the behavior during and after glass breakage. Specifically, the tear and penetration resistance of a laminate are key to its safety performance. In order to evaluate the laminate breakage properties a ball-on-ring testing protocol was used.

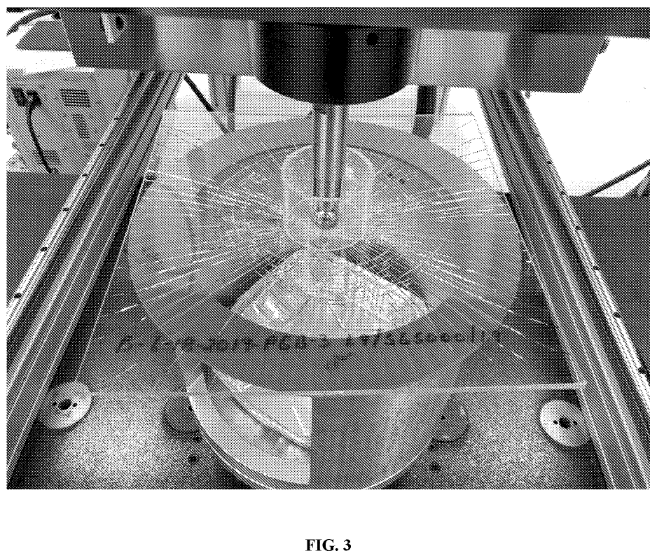

In this test, glass laminates were supported on a circular ring made from aluminum and loaded at its center using a hard metal ball (tungsten carbide). The supporting ring diameter=250 mm, the loading ball diameter=25.4 mm. The samples were loaded at 10 mm/sec and the tests were carried out at 23° C./50% RH. FIG. 22 is a picture testing geometry. Note that a thin (1 mm) rubber gasket was placed between the supporting ring and laminated glass sample to obviate contact breakage of the glass. An MTS Criterion M45 universal testing machine, with a 5 kN load cell operating in displacement control mode was used for the measurements. The force-displacement characteristic was recorded at a frequency of 100 Hz. Seven samples were tested for each treatment.

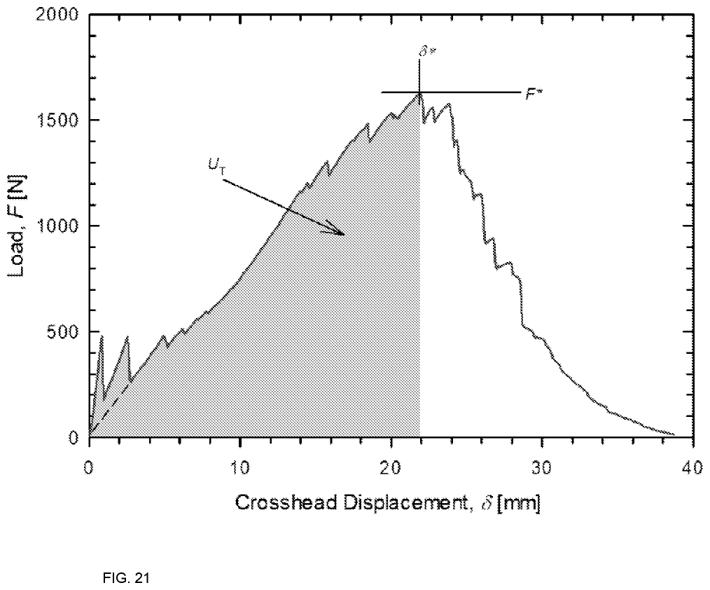

A typical load-displacement trace is shown in FIG. 21. The tear energy of the laminate, U_{T}, is defined as the area under the load-displacement curve up to the peak load, F* (δ*) at which a tear in the laminate initiates, U_{T}=∫₀^{δ*} F(δ).

Note that the first two peaks are removed before this calculation is made since these peaks result from the first-cracking of each glass ply. Thus, the tear energy represents to work done to create a first tear in the polymer interlayer during laminate deformation after first-cracking of each glass ply.

### Adhesion: Glass Loss During Ball-on-Ring Testing

Here we use the glass loss during ball-on-ring testing as a measure of polymer-glass adhesion. Test samples were weighed before and after ball-on-ring testing and changes in weight due to glass loss computed.

### EXAMPLES

### Comparative Example-1: Single Polymer Interlayer

FIG. 1 shows the laminate structure used for establishing the laminate toughness and post-glass breakage durability of laminated glass made with ionomer only.

### Comparative Example-2: Cohesive Continuous Debond Zone Treatments

FIG. 22 shows the schematic laminate structure used for establishing the laminate toughness and post-glass breakage durability of laminated glass made with SentryGlas® with two embedded continuous, planar FEP layers. Laminate layup details are given in Table 1 and the sample is designated as CC-1.

### Examples—Cohesive Discrete Debond Zone Treatments

FIG. 21 shows the schematic laminate structure used for establishing the laminate toughness and post-glass breakage durability of laminated glass made with ionomer with two embedded FEP layers. The FEP layers contained circular holes (2 mm diameter) located on a uniform square grid 10 mm×10 mm. Laminate layup details are given in Table 1 and the sample is designated as CD-1.

FIG. 21 shows the schematic laminate structure used for establishing the laminate toughness and post-glass breakage durability of laminated glass made with ionomer with two embedded FEP layers. The FEP layers contained circular holes (5 mm diameter) located on a uniform square grid 10 mm×10 mm. Laminate layup details are given in Table 1 and the sample is designated as CD-2.

TABLE 1
Example Laminate Layup Structures Prior to Autoclaving

| | Glass | Ionomer | FEP-50 | Ionomer | Ionomer | Ionomer | FEP-50 | Ionomer | Glass |
|---|---|---|---|---|---|---|---|---|---|
| Example | (mm) | [μm] | (13 μm) | [μm] | [μm] | [μm] | (13 μm) | [μm] | (mm) |
| CE-1 | 1.9 | 25 | None | 25 | 965 | 25 | None | 25 | 1.9 |
| CC-1 | 1.9 | 25 | No holes | 25 | 965 | 25 | No holes | 25 | 1.9 |
| CD-1 | 1.9 | 25 | 2 mm holes | 25 | 965 | 25 | 2 mm holes | 25 | 1.9 |
| | | | on 10 mm × | | | | on 10 mm × | | |
| | | | 10 mm | | | | 10 mm | | |
| | | | square grid | | | | square grid | | |
| CD-2 | 1.9 | 25 | 5 mm holes | 25 | 965 | 25 | 5 mm holes | 25 | 1.9 |
| | | | on 10 mm × | | | | on 10 mm × | | |
| | | | 10 mm | | | | 10 mm | | |
| | | | square grid | | | | square grid | | |

Performance results for the various examples are presented in Table 2. As can be seen, a superior combination of laminate tear energy and adhesion (low glass loss) may be attained using cohesive discrete debond zone treatments. The cohesive continuous debond zone treatment approach used in example CC-1 imparts improvements in laminate tear energy but at the expense in glass adhesion and glass retention during breakage.

TABLE 2
Laminate tear energy and glass loss behavior

| | Laminate Tear Energy, | Glass Loss During Ball-on-Ring |
|---|---|---|
| Example | U_{T} [J] | Test [g] |
| CE-1 | 19.4 | 7.4 |
| CC-1 | 25.4 | 209 |
| CD-1 | 28.3 | 10.9 |
| CD-2 | 30.3 | 6.9 |

### Continuous Debonding Zones

### Materials

The materials used in the examples are as follows:

The glass used in the Examples was soda-lime glass, standard annealed (obtained from Guardian Industries, Inc., Galax VA, USA).

Ionomer 1 (I1)—a partially neutralized ethylene acid dipolymer ionomer obtained from The Dow Company, Midland, MI (21.7% methacrylic acid, Na 26% neutralized, MI=1.8 @190° C.).

PVA: Polyvinyl alcohol, Elvanol® 90-50, CAS Number 9002-89-5, available from Kuraray America, Inc. 2625 Bay Area Blvd., Houston, TX 77058.

Trosifol® PVB Sheeting, available from Kuraray Americas was used as described herein to prepare samples for peel strength testing and impact testing described below.

A superior interlayer composite structure where the API is treated such that more robust adhesiveness to the substrate is created in a more dependable fashion so that a targeted adhesive level is created over the conventional art. The debonding occurs within a desired range for the underlying API to dissipate energy in a favorable manner when the composite structure is impacted and the like.

The adhesive properties of conventional interlayers, such as PVB, are highly influenced by the presence of moisture. Without being held to theory, it has been reported that the adhesiveness is largely provided by hydrogen-bonding between the hydroxyl groups within the polymer chains of the PVB interlayer and the silanol groups on the glass surface (as one example of a composite structure type). The presence of water reduces the adhesiveness by effectively competing with the interaction of the hydroxy groups of the PVB and the silanol groups on the glass surface. The present invention seeks to provide a more robust interfacial bonding mechanism than that obtained through the conventional means. This approach provides a reliable means for adjusting the debonding energy between the substrate and API for optimizing the total energy absorbing capability of the composite laminate structure.

### EXAMPLES

Functional silanes are used in the examples below, but titanates and zirconates may also be used individually or in combinations to achieve the desired adhesive effect.

Example MB-1: A masterbatch is created by taking PVB resin containing about 40 to 48 wt. % hydroxyl (MW 50,000) is imbibed with a combination of (3-Glycidoxypropyl)triethoxysilane at 0.05 weight % and 0.10% (3-Glycidoxypropyl)methyldiethoxysilane by tumbling combined together on a roller mill in a closed container for 4 hours. The contents are then compounded together in a twin-screw extruder at a melt temperature of 240 C.

Example MB-2: A masterbatch is created by taking PVB resin containing about 18 to 21 wt. % hydroxyl (Mowital B16H) is imbibed with Octyl/decyl glycidyl ether CAS Number 68609-96-1 (available from Sigma-Aldrich) at 0.5 weight % by tumbling together on a roller mill in a closed container for 4 hours. The contents are then compounded together in a twin-screw extruder at a melt temperature of 220 C.

Example S-1: The extruded masterbatch products that are cited above are each strand-cut and dried. The masterbatch materials are then dissolved in 2-propanol at 0.1 weight % and the solution made from MB-2 is slot-die coated (10-um wet-film thickness) onto both sides in a sequential operation of a moving-web of PVB interlayer sheeting (c.f. Trosifol® Type B550J—nominal thickness 0.76-mm). The moving web is then passed through a drier to remove the excess 2-propanol solvent. The solution made from MB-1 is then applied to the embossing roll by using a transfer roll and the excess solution is removed by a doctor blade. The embossing roll is heated (˜150 C) which facilitates the removal of the 2-propanol solvent. The embossing roll also provides the sheeting with a surface texture for de-airing purposes for eventual conversion into a glass laminate. Thus, during this coating transfer operation, the MB-1 material is transferred onto the outer-surface of the PVB sheeting as an overlay over the MB-2 material previously applied. This same steps are repeated such that both sides of the sheeting are so modified with the adhesion treatment.

Example S-2: A phyllosilicate with platelet size below 1 um is exfoliated using an ultrasonic probe at high intensity in a surfactant laden solution with water for 4 hours (5% wt. loading silicate/water). To this mixture is added a long-chain alkylalkoxysilane (c.f. dodecyltriethoxysilane, Gelest Product #SID4632.0) at 0.1% w/w and is stirred for 4 hours at 70° C. The resulting product is filtered using a 0.25 um filter medium and the filtrate is re-slurried three times with 90:10 v/v water/methanol to remove surfactant and excess unreacted silane/byproducts. The product is dried under nitrogen in a vacuum oven for 24 hours at 60° C.

A solution is created by taking MB-2 resin and dissolving into 2-propanol solvent at 0.4% w/w loading. To this mixture is added the silane-treated silica slowly with intense mixing (dispersion blade mixer at 4000 rpm) at a 0.05% loading. After mixing, this solution is then slot-die coated (10-um wet-film thickness) onto both sides in a sequential operation of a moving-web of PVB interlayer sheeting (c.f. Trosifol® Type B550J—nominal thickness 0.76-mm). The moving web is then passed through a drier to remove the excess 2-propanol solvent.

TABLE 2.1

| | | Mean Peel Strength, | | |
|---|---|---|---|---|
| | | γ [kJ/m²] | | |
| | | Sheet Moisture Level (wt. %) | | |
| Example | | 0.15 | 0.45 | 0.80 |
| C1 | Trosifol ® Type B550J | 8 | 5 | 2 |
| S-1 | Composite coated surface | 6 | 5 | 4 |
| S-2 | Composite coated surface | 5 | 5 | 4 |
| | (silica) | | | |

Traditional PVB sheeting is highly influenced by the level of moisture within the interlayer. A moderate adhesion level is generally the targeted goal to achieve a balance of durability/weathering (delamination resistance) and impact performance. Although, an optimum adhesion level is obtained at an intermediate moisture level (0.45%), the adhesion under dry conditions (0.15%) is very high and drops to a very low adhesion level at high moisture (0.8%). In the case for the sheeting that is treated with both solutions to form Example S-1, one can see the advantageous robustness of the debonding energy against moisture level. The impact performance of this treated API is improved over the conventional art as it exhibits less sensitivity to moisture. Primary debonding is found between the two layers of the solution coated layers of MB-1 and MB-2 materials. The embossed roll coating contains some disparities due to the roughness but does not detract from the functionality of the invention as a largely continuous layer is formed and transferred to the sheeting during the embossing step.

Similar benefits are found using Example S-2, whereby debonding occurs with the S-2 layer in a cohesive fashion and a fracture interface is created due to the treated-silica platelets contained with the S-2 coating. Any means which allows for the compositional placement of the materials above are within the scope of this invention. This can include transfer coating, co-lamination, spray or particle deposition, printing, and the like.

### Ionomer Sheet Preparation

Aqueous solutions were prepared for each of the above PVA materials by dissolving into demineralized water under stirring at 80° C. and then was allowed to cool to room temperature. Solutions were prepared at either 0.5% or 0.05% from the Elvanol® 90-50 PVA. Solutions containing silane also used Momentive A-1106 (aqueous solution), this additive was added to make a final 0.5% concentration of silane combined along with the PVA.

Nominal 0.9-mm ionomer sheeting or 0.76-mm PVB sheeting was then immersed into the respective solutions, held for 5 seconds, and then withdrawn and allowed to dry by hanging at ambient temperature and humidity. After one hour, these treated sheets were used to prepare the laminates below, for either impact testing (300-mm squares) or peel test samples as described below.

### Laminate Preparation Method

Glass laminates were prepared from each of the ionomer sheets and PVA layers by the following method. Annealed glass sheets (300×300×3 mm) were washed with a solution of trisodium phosphate (5 g/l) in de-ionized water at 50° C. for 5 min, then rinsed thoroughly with deionized water and dried. Three layers of each respective ionomer sheets (about 0.76 mm thick each) as listed in Table 1 were stacked together and placed between two lites of glass sheet (to yield an interlayer thickness of 2.28 mm). The moisture level of the ionomer sheet was kept at or below 0.08% by weight by minimizing contact time to the room environment (about 35% RH)

The moisture level of the ionomer sheet was measured using a coulometric Karl Fischer method (Metrohm Model 800) with a heating chamber temperature of 150° C. for the sample vials. The ionomer sheeting was cut into small pieces to fit into the sample vials weighing a total of 0.40 grams.

The pre-lamination assembly was then taped together with a piece of polyester tape in a couple locations to maintain relative positioning of each layer with the glass lites. A nylon fabric strip was placed around the periphery of the assembly to facilitate air removal from within the layers. The assembly was placed inside a nylon vacuum bag, sealed and then a connection was made to a vacuum pump. A vacuum was applied to allow substantial removal of air from within (air pressure inside the bag was reduced to below 50 millibar absolute). The bagged assembly was then heated in a convection air oven to 120° C. and held for 30 min. A cooling fan was then used to cool the assembly down to near room temperature and the assembly was disconnected from the vacuum source and the bag removed yielding a fully pre-pressed assembly of glass and interlayer.

The assembly was then placed into an air autoclave and the temperature and pressure were increased from ambient to 135° C. at 13.8 bar over 15 min. This temperature and pressure was held for 30 min and then the temperature was decreased to 40° C. at a cooling of about 2.5° C./min whereby the pressure was then dropped back to ambient (over 15 min) and the final laminates were removed from the autoclave.

### Sample Preparation

In these examples, adhesion, laminate breakage behavior, and durability after breakage have been studied on laminates fabricated from annealed float glass and a monolayer ionomer interlayer sold by Kuraray America, Inc. (Wilmington, DE, USA) under the trademark SENTRYGLAS®.” The ionomer is a partially neutralized ethylene acid ionomer consists of about 21.7% methacrylic acid, Na 26% neutralized, MI=1.8.

Float glass is manufactured by floating the molten soda-lime-silica melt on a bath of molten metallic tin. The glass “tin” side is the glass that contacted the molten tin during manufacture and the glass “air” side is the opposite side that did not come into contact with the molten tin. Trace tin (Sn) impurities in the glass “tin” surface influence polymer-glass adhesion. Float glass is available from Guardian Industries, Inc., Galax VA, USA.

All glass was washed prior to fabrication of the laminates using soapy de-ionized water at 50° C. and rinsed thoroughly using de-ionized water. Generally, to produce soapy water, soap or detergent is added to water in an amount to form a lather when mixed.

Laminate Fabrication: a pre-press assembly, in which the PVA layer, rigid substrate polymer interlayer and glass were stacked in the desired order at room temperature, was placed into a disposable vacuum bag and held for 60 minutes under a vacuum of 25-30 inches of water to remove any air contained between the layers of the pre-press assembly. The pre-press assembly was loaded while still applying a vacuum to the bag into an air autoclave. The samples and bags were heated to 135° C. under an applied hydrostatic air pressure of 0.7 MPa. The vacuum to the bag was removed after reaching 135° C. and the laminates were held for 90 minutes in an air autoclave at an applied hydrostatic pressure of 0.7 MPa. The samples were then cooled at an approximate rate of 4° C./minute under constant pressure. After approximately 25 minutes of cooling, when the air temperature was less than about 50° C., the excess pressure was vented and the laminate was cooled to room temperature and removed from the autoclave.

The process used in the examples is similar to many standard industrial processes for the fabrication of laminated glass and resulted in materials with high clarity and minimal imperfections (bubbles etc.).

### Test Methods—Adhesion

Adhesion is a key requirement for laminated glass. A standard peel test method was used to characterize adhesion in the samples described.

Laminates were prepared for adhesion tests following the approaches described with two important modifications. First, a 25.4 mm wide strip of a thin polyester release tape (25 mm×25 mm) was applied to one edge of one piece of glass prior to assembly of the glass and polymer components. This tape only lightly adheres to the glass and enables a strip of polymer to be gripped by the peel-testing fixture. Secondly, a thin release film (Teflon® 13 mm) was placed between the polymer and one of the glass pieces. This allows the removal of one piece of glass so that a strip of polymer can be peeled off one of the glass pieces. Prior to peel testing, a 40 mm wide strip of polymer was separated from the adjacent polymer by cutting two channels using a sharp knife. Care was taken to make sure the channels were deep enough to fully cut through the polymer and detach it from adjacent material.

A peel configuration of 90 degrees was used and run with an extension rate of 0.18 mm/s at 23° C. and 50% RH. An MTS Criterion M45 universal testing machine, with a 1 kN load cell operating in displacement control mode was used for the measurements. The force-displacement characteristic were recorded at a frequency of 1 Hz. Five samples were tested for each adhesion treatment and the peel force was recorded as a function of extension.

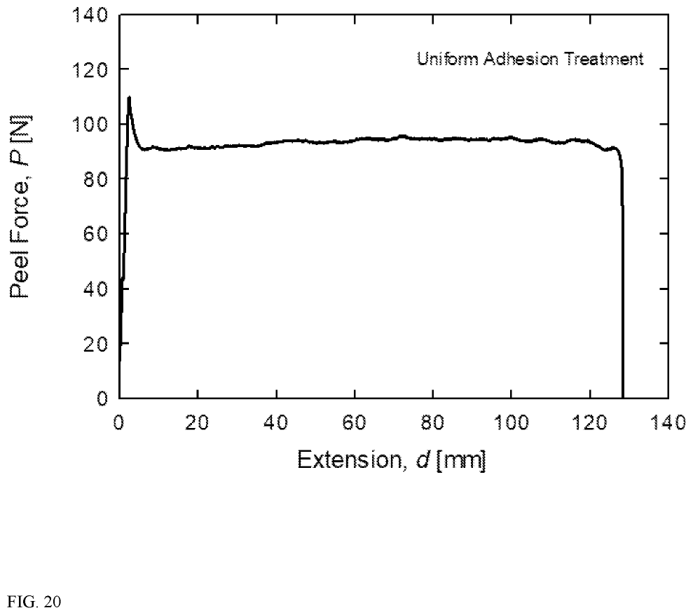

FIG. 20 shows a typical peel measurement. With uniform adhesion control methods, a steady-state peel force is attained after an interfacial crack initiates. The peel force demonstrates small fluctuations. The energy to create unit area of interface is defined as the peel strength, y, and for the 90 degree peel geometry is given by:

$$γ = \frac{P}{w}$$

Here, P is the peel force and w is the peel arm width. Using units of Newtons and mm, this yields a peel strength in units of kJ/m². The mean peel strength has been determined by fitting a horizontal line to the steady-state peel force response.

In the case of treatments with complex microstructures, the peel force often exhibits significant fluctuations associated with debonding and separation of the different treatment components from the polymer matrix and/or rigid substrate under mechanical loading. Extrema in the peel force fluctuations are a measure of the peel strengths of the various components and correspond to the energy to separate the components under loading. Even in the case of significant peel force fluctuations, the mean peel strength is still determined by fitting a horizontal line to the peel response, thence extracting the mean peel strength.

### Test Methods—Ball Drop Impact Testing

A conventional impact test widely used to test the laminates in the safety glazing industry is the five-pound (2.27-kg) steel ball drop test. This test is defined in American National Standard Z26.1-1983 Section 5.26 Penetration Resistance, Test 26. The purpose of this test is to determine whether the glazing material has satisfactory penetration resistance. For automotive windshields, a minimum performance level is set at eight out of ten samples passing a twelve foot (3.66-m) ball drop without the ball penetrating the sample within 5 seconds of the impact. The test method calls for controlling laminate temperature between 77 to 104° F. (25 to 40° C.). The laminates (separated to provide air circulation) were placed in a controlled temperature oven, a minimum of 2 hours prior to impact to equilibrate to 23° C.+/−2° C. Rather than dropping the five-pound ball (2.27-kg) from 12 feet (3.66-m), a variety of drop heights ranging from 2.44-m to 6.71-m were used to assess the “mean” support height (the height at which it is estimated that 50% of the samples would be penetrated). At each various drop impact height, the length of any tear in the laminate and interlayer was also measured and by testing multiple samples at each drop height (avg. of 3 laminates), the height necessary to create a tear of 2.54-cm and 12.7-cm was also computed.

### Test Methods—Haze Measurement

Laminates prepared above were then immersed into room temperature demineralized water for 1 hour followed by placing the laminates into a chamber adjusted to −20° C. for 16 hours. Laminates were then removed and allowed to warm back to room temperature (23° C.+/−2° C.) for 7 hours. The process was repeated for a total of 10 cycles and then the degree of debonding/delamination was observed by visual inspection. Image analysis was performed on the laminates to quantify the extent of the debonding if present. The laminates were thoroughly cleaned using WINDEX glass cleaner (S.C. Johnson & Son, Inc.) and lint-less cloths and were inspected to ensure that they were free of bubbles and other defects which might otherwise interfere with making valid optical measurements. The laminates were then evaluated by means of a Haze-gard Plus hazemeter (Byk-Gardner) to obtain a measurement of percent haze. The measurement of haze followed the practice outlined in American National Standard (ANSI Z26.1-1966) “Safety Code for Safety Glazing Materials for Glazing Motor Vehicles Operating on Land Highways”. Test section 5.17 and 5.18 along with FIGS. 5 and 6 in such standard detail the appropriate method and instrumental setup to measure the haze level of a glazing material. The Haze-gard Plus hazemeter meets the proper criteria for this standard was used in all forthcoming measurements. Haze standards which are traceable to the National Bureau of Standards (now NIST) were used to ensure that the instrument was well-calibrated and operating properly.

### Test Methods—Peel Strength Measurement

To allow for measurement of peel strength, some samples were prepared as above with the following exceptions.

Annealed glass was scribed, cut into 100 mm×300 mm rectangular-shaped pieces, and then washed per the procedure described earlier. Thin polyester tape (25 μm thickness×25 mm width) with silicone adhesive was applied to the glass surface on the ‘side-of-interest’ (air or tinside) in two parallel strips providing a uniform 25 mm wide bonding area in between. This procedure allows for the creation of a very well-defined bonding area without the need to cut through the polymer layer to create a peel strip as is conventionally performed in standard peel strength methodologies. Over top of the interlayer specimen, a thin 4-mil sheet of FEP film was placed over the plastic sheeting prior to placing the second piece of glass on top to provide a relatively flat surface for the lamination step and to act as a release layer for removal of the top piece of glass. All lamination steps were then carried out as stated above. Afterwards, 90 degree angle peel strength measurements were made on a variety of samples produced by the process above via a mechanical testing device (INSTRON® Model 1122, Instron Industrial Products, Norwood, MA USA). The peels were conducted at a crosshead speed of 1-cm/min. rate under standard laboratory conditions (nominal 23° C. and 50% RH. The data was collected via the computer software (INSTRON Bluehill III software, Instron Industrial Products, Norwood, MA USA) and an average force level was computed for each of the treated regions of the peel strip.

### Discrete Debonding Zones

### Materials

The materials used in the examples are as follows:

The glass used in the Examples was soda-lime glass, standard annealed (obtained from Guardian Industries, Inc., Galax VA, USA).

Ionomer—a partially neutralized ethylene acid dipolymer ionomer obtained from The Dow Company, Midland, MI (21.7% methacrylic acid, Na 26% neutralized, MI=1.8 @190° C.).

The adhesion promotion used was gamma-aminopropyltriethoxysilane (Silquest A-1100, available from Momentive Performance Materials, Inc., Waterford, NY USA).

Fluorinated-ethylene-propylene (FEP) films (DuPont Teflon® FEP-50) used was 13 microns in thickness and purchased from American Durafilm Co, Inc., 55 Boynton Rd, Holliston MA 01746.

### Sample Preparation

In these examples, laminate breakage behavior and glass-polymer adhesion during breakage have been studied on laminates fabricated from annealed float glass and an ionomer interlayer sold by Kuraray America, Inc. (Wilmington, DE, USA) under the trademark SENTRYGLAS®. The ionomer is a partially neutralized ethylene acid dipolymer ionomer obtained from The Dow Company, Midland, MI (21.7% methacrylic acid, Na 26% neutralized, MI=1.8 @190° C.).

Discrete cohesive debonding zones were created by embedding fluorinated-ethylene-propylene (FEP) films into the ionomer. The FEP film (DuPont Teflon® FEP-50) used was 13 microns in thickness and purchased from American Durafilm Co, Inc., 55 Boynton Rd, Holliston MA 01746. Holes of either 2 mm diameter or 5 mm diameter were cut into some FEP films on a 10 mm×10 mm uniform square grid pattern using a laser-cutter (BOSSLASER, Model LS-1416 608 Trestle Point, Sanford FL 32771). In all examples, the FEP films were positioned to be within the top 10% of the ionomer interlayer (i.e. close to the glass-ionomer interface).

The glass used in the Examples was soda-lime glass; standard annealed (obtained from Guardian Industries, Inc., Galax VA, USA). Float glass is manufactured by floating the molten soda-lime-silica melt on a bath of molten metallic tin. The glass “tin” side is the glass that contacted the molten tin during manufacture and the glass “air” side is the opposite side that did not come into contact with the molten tin. Trace tin (Sn) impurities in the glass “tin” surface influence polymer-glass adhesion. Float glass is available from Guardian Industries, Inc., Galax VA, USA.

All glass was washed prior to fabrication of the laminates using soapy de-ionized water at 50° C. and rinsed thoroughly using de-ionized water. Generally, to produce soapy water, soap or detergent is added to water in an amount to form a lather when mixed.

Adhesion promoter was applied to the glass surface to increase glass-ionomer adhesion. The active ingredient in the adhesion promotion treatment is gamma-aminopropyltriethoxysilane (Silquest A-1100, available from Momentive Performance Materials, Inc., Waterford, NY USA). A solution of the following composition (weight %) was used: 2-propanol (92.00%), water (7.90%), acetic acid (0.01%), gamma-aminopropyltriethoxysilane (0.09%).

Laminate Fabrication: A pre-press assembly, in which the ionomer films, FEP films and glass were stacked in the desired order at room temperature, was placed into a disposable vacuum bag and held for 60 minutes under a vacuum of 25-30 inches of water to remove any air contained between the layers of the pre-press assembly. The pre-press assembly was loaded while still applying a vacuum to the bag into an air autoclave. The samples and bags were heated to 135° C. under an applied hydrostatic air pressure of 0.7 MPa. The vacuum to the bag was removed after reaching 135° C. and the laminates were held for 90 minutes in an air autoclave at an applied hydrostatic pressure of 0.7 MPa. The samples were then cooled at an approximate rate of 4° C./minute under constant pressure. After approximately 25 minutes of cooling, when the air temperature was less than about 50° C., the excess pressure was vented and the laminate was cooled to room temperature and removed from the autoclave.

The process used in the examples is similar to many standard industrial processes for the fabrication of laminated glass and resulted in materials with high clarity and minimal imperfections (bubbles, etc.).

Examples of various laminate structures made are listed in Table 1 and described in the examples section below. Note that Table 1 shows the layup of the components prior to heating and autoclaving. Wherever the FEP films contained holes, the ionomer flowed during lamination to fill in the holes and create a fully interconnected polymer phases with no remaining voids.

### Test Methods

### Laminate Breakage: Ball-on-Ring

A key performance attribute of laminated safety glass is the behavior during and after glass breakage. Specifically, the tear and penetration resistance of a laminate are key to its safety performance. In order to evaluate the laminate breakage properties a ball-on-ring testing protocol was used.

In this test, glass laminates were supported on a circular ring made from aluminum and loaded at its center using a hard metal ball (tungsten carbide). The supporting ring diameter=250 mm, the loading ball diameter=25.4 mm. The samples were loaded at 10 mm/sec and the tests were carried out at 23° C./50% RH. FIG. 22 is a picture of testing geometry. Note that a thin (1 mm) rubber gasket was placed between the supporting ring and laminated glass sample to obviate contact breakage of the glass. An MTS Criterion M45 universal testing machine, with a 5 kN load cell operating in displacement control mode was used for the measurements. The force-displacement characteristic was recorded at a frequency of 100 Hz. Seven samples were tested for each treatment.

A typical load-displacement trace is shown in FIG. 21. The tear energy of the laminate, U_{T}, is defined as the area under the load-displacement curve up to the peak load, F* (δ*) at which a tear in the laminate initiates, U_{T}=∫₀^{δ*} F(δ).

Note that the first two peaks are removed before this calculation is made since these peaks result from the first-cracking of each glass ply. Thus, the tear energy represents to work done to create a first tear in the polymer interlayer during laminate deformation after first-cracking of each glass ply.

### Adhesion: Glass Loss During Ball-On-Ring Testing

Here we use the glass loss during ball-on-ring testing as a measure of polymer-glass adhesion. Test samples were weighed before and after ball-on-ring testing and changes in weight due to glass loss computed.

### EXAMPLES

### Comparative Example-1: Single Polymer Interlayer

FIG. 1 shows the laminate structure used for establishing the laminate toughness and post-glass breakage durability of laminated glass made with ionomer only. Laminate layup details are given in Table 4.1 and the sample is designated as CE-1.

### Examples—Cohesive Discrete Debond Zone Treatments

A superior interlayer composite structure where the API is treated such that more robust adhesiveness to the substrate is created in a more dependable fashion so that a targeted adhesive level is created over the conventional art. The debonding occurs within a desired range for the underlying API to dissipate energy in a favorable manner when the composite structure is impacted and the like.

The adhesive properties of conventional interlayers, such as PVB, are highly influenced by the presence of moisture. Without being held to theory, it has been reported that the adhesiveness is largely provided by hydrogen-bonding between the hydroxyl groups within the polymer chains of the PVB interlayer and the silanol groups on the glass surface (as one example of a composite structure type). The presence of water reduces the adhesiveness by effectively competing with the interaction of the hydroxy groups of the PVB and the silanol groups on the glass surface. The present invention seeks to provide a more robust interfacial bonding mechanism than that obtained through the conventional means. This approach provides a reliable means for adjusting the debonding energy between the substrate and API for optimizing the total energy absorbing capability of the composite laminate structure.

### EXAMPLES

Functional silanes are used in the examples below, but titanates and zirconates may also be used individually or in combinations to achieve the desired adhesive effect.

Example MB-1: A masterbatch is created by taking PVB resin containing about 40 to 48 wt. % hydroxyl (MW 50,000) is imbibed with a combination of (3-Glycidoxypropyl)triethoxysilane at 0.05 weight % and 0.10% (3-Glycidoxypropyl)methyldiethoxysilane by tumbling combined together on a roller mill in a closed container for 4 hours. The contents are then compounded together in a twin-screw extruder at a melt temperature of 240 C.

Example MB-2: A masterbatch is created by taking PVB resin containing about 18 to 21 wt. % hydroxyl (Mowital B16H) is imbibed with Octyl/decyl glycidyl ether CAS Number 68609-96-1 (available from Sigma-Aldrich) at 0.5 weight % by tumbling together on a roller mill in a closed container for 4 hours. The contents are then compounded together in a twin-screw extruder at a melt temperature of 220 C.

Example S-1: The extruded masterbatch products that are cited above are each strand-cut and dried. The masterbatch materials are then dissolved in 2-propanol at 0.1 weight % and the solution made from MB-2 is transfer printed onto the embossing roll in a position 90 degrees forward of the sheeting embossing nip position. The transfer printing consists of dots that are 2-mm circles and with a spacing such that 50% of the surface is covered with the printed dots. The solvent dries due to the elevated temperature of the embossing roll (˜150 C). At the 45 degree position, a solution made from MB-1 is transfer roll coated as a solid film layer onto the moving embossing roller ahead of the embossing nip position. Again, the solvent is removed by the heat of the embossing roll. These two deposits are than thermally transferred to the web of PVB interlayer sheeting (c.f. Trosifol® Type B550J—nominal thickness 0.76-mm) passing through the embossing nips. The embossing roll also provides the sheeting with a surface texture for de-airing purposes for eventual conversion into a glass laminate. Thus, during this coating transfer operation, the MB-1 material is transferred onto the outer-surface of the PVB sheeting as an overlay over the MB-2 material (discrete pattern of dots) previously applied. This same steps are repeated such that both sides of the sheeting are so modified with the adhesion treatment.

TABLE 4.1

| | | Mean Peel Strength, | | |
|---|---|---|---|---|
| | | γ [kJ/m²] | | |
| | | Sheet Moisture Level (wt. %) | | |
| Example | | 0.15 | 0.45 | 0.80 |
| C1 | Trosifol ® Type B550J | 8 | 5 | 2 |
| S-1 | Composite dot coated surface | 6 | 5 | 4 |

Traditional PVB sheeting is highly influenced by the level of moisture within the interlayer. A moderate adhesion level is generally the targeted goal to achieve a balance of durability/weathering (delamination resistance) and impact performance. Although, an optimum adhesion level is obtained at an intermediate moisture level (0.45%), the adhesion under dry conditions (0.15%) is very high and drops to a very low adhesion level at high moisture (0.8%). In the case for the sheeting that is treated with the dots/continuous layer solutions to form Example S-1, one can see the advantageous robustness of the debonding energy against moisture level. The impact performance of this treated API is improved over the conventional art as it exhibits less sensitivity to moisture. The embossed roll coating contains some disparities due to the roughness but does not detract from the functionality of the invention as a largely continuous layer is formed and transferred to the sheeting during the embossing step.

Similar benefits are found using Example S-2, whereby debonding occurs with the near vicinity of the S-1 discrete dots in a cohesive fashion and a fracture interface is created due to the lower cohesive fracture energy of the MB-1 layer. Any means which allows for the compositional placement of the materials above are within the scope of this invention. This can include transfer coating, co-lamination, spray or particle deposition, printing, and the like.

### Continuous Debonding Zones

### Materials

The materials used in the examples are as follows:

The glass used in the Examples was soda-lime glass, standard annealed (obtained from Guardian Industries, Inc., Galax VA, USA).

Ionomer 1 (I1)—a partially neutralized ethylene acid dipolymer ionomer obtained from The Dow Company, Midland, MI (21.7% methacrylic acid, Na 26% neutralized, MI=1.8 @190° C.).

PVA: Polyvinyl alcohol, Elvanol® 90-50, CAS Number 9002-89-5, available from Kuraray America, Inc. 2625 Bay Area Blvd. Houston, TX 77058.

Trosifol® PVB Sheeting, available from Kuraray Americas was used as described herein to prepare samples for peel strength testing and impact testing described below.

### Ionomer Sheet Preparation

Aqueous solutions were prepared for each of the above PVA materials by dissolving into demineralized water under stirring at 80° C. and then was allowed to cool to room temperature. Solutions were prepared at either 0.5% or 0.05% from the Elvanol® 90-50 PVA. Solutions containing silane also used Momentive A-1106 (aqueous solution), this additive was added to make a final 0.5% concentration of silane combined along with the PVA.

Nominal 0.9-mm ionomer sheeting or 0.76-mm PVB sheeting was then immersed into the respective solutions, held for 5 seconds and then withdrawn and allowed to dry by hanging at ambient temperature and humidity. After one hour, these treated sheets were used to prepare the laminates below, for either impact testing (300-mm squares) or peel test samples as described below.

Laminate Preparation Method

Glass laminates were prepared from each of the ionomer sheets and PVA layers by the following method. Annealed glass sheets (300×300×3 mm) were washed with a solution of trisodium phosphate (5 g/l) in de-ionized water at 50° C. for 5 min, then rinsed thoroughly with deionized water and dried. Three layers of each respective ionomer sheets (about 0.76 mm thick each) as listed in Table 1 were stacked together and placed between two lites of glass sheet (to yield an interlayer thickness of 2.28 mm). The moisture level of the ionomer sheet was kept at or below 0.08% by weight by minimizing contact time to the room environment (about 35% RH).

The moisture level of the ionomer sheet was measured using a coulometric Karl Fischer method (Metrohm Model 800) with a heating chamber temperature of 150° C. for the sample vials. The ionomer sheeting was cut into small pieces to fit into the sample vials weighing a total of 0.40 grams.

The pre-lamination assembly was then taped together with a piece of polyester tape in a couple locations to maintain relative positioning of each layer with the glass lites. A nylon fabric strip was placed around the periphery of the assembly to facilitate air removal from within the layers. The assembly was placed inside a nylon vacuum bag, sealed and then a connection was made to a vacuum pump. A vacuum was applied to allow substantial removal of air from within (air pressure inside the bag was reduced to below 50 millibar absolute). The bagged assembly was then heated in a convection air oven to 120° C. and held for 30 min. A cooling fan was then used to cool the assembly down to near room temperature and the assembly was disconnected from the vacuum source and the bag removed yielding a fully pre-pressed assembly of glass and interlayer.

The assembly was then placed into an air autoclave and the temperature and pressure were increased from ambient to 135° C. at 13.8 bar over 15 min. This temperature and pressure was held for 30 min and then the temperature was decreased to 40° C. at a cooling of about 2.5° C./min whereby the pressure was then dropped back to ambient (over 15 min) and the final laminates were removed from the autoclave.

Sample Preparation

In these examples, adhesion, laminate breakage behavior, and durability after breakage have been studied on laminates fabricated from annealed float glass and a monolayer ionomer interlayer sold by Kuraray America, Inc. (Wilmington, DE, USA) under the trademark “SENTRYGLAS®.” The ionomer is a partially neutralized ethylene acid ionomer consists of about 21.7% methacrylic acid, Na 26% neutralized, MI=1.8.

Float glass is manufactured by floating the molten soda-lime-silica melt on a bath of molten metallic tin. The glass “tin” side is the glass that contacted the molten tin during manufacture and the glass “air” side is the opposite side that did not come into contact with the molten tin. Trace tin (Sn) impurities in the glass “tin” surface influence polymer-glass adhesion. Float glass is available from Guardian Industries, Inc., Galax VA, USA.

All glass was washed prior to fabrication of the laminates using soapy de-ionized water at 50° C. and rinsed thoroughly using de-ionized water. Generally, to produce soapy water, soap or detergent is added to water in an amount to form a lather when mixed.

Laminate Fabrication: a pre-press assembly, in which the PVA layer, rigid substrate polymer interlayer and glass were stacked in the desired order at room temperature, was placed into a disposable vacuum bag and held for 60 minutes under a vacuum of 25-30 inches of water to remove any air contained between the layers of the pre-press assembly. The pre-press assembly was loaded while still applying a vacuum to the bag into an air autoclave. The samples and bags were heated to 135° C. under an applied hydrostatic air pressure of 0.7 MPa. The vacuum to the bag was removed after reaching 135° C. and the laminates were held for 90 minutes in an air autoclave at an applied hydrostatic pressure of 0.7 MPa. The samples were then cooled at an approximate rate of 4° C./minute under constant pressure. After approximately 25 minutes of cooling, when the air temperature was less than about 50° C., the excess pressure was vented and the laminate was cooled to room temperature and removed from the autoclave.

The process used in the examples is similar to many standard industrial processes for the fabrication of laminated glass and resulted in materials with high clarity and minimal imperfections (bubbles etc.).

### Test Methods—Adhesion

Adhesion is a key requirement for laminated glass. A standard peel test method was used to characterize adhesion in the samples described.

Laminates were prepared for adhesion tests following the approaches described with two important modifications. First, a 25.4 mm wide strip of a thin polyester release tape (25 mm×25 mm) was applied to one edge of one piece of glass prior to assembly of the glass and polymer components. This tape only lightly adheres to the glass and enables a strip of polymer to be gripped by the peel-testing fixture. Secondly, a thin release film (Teflon® 13 mm) was placed between the polymer and one of the glass pieces. This allows the removal of one piece of glass so that a strip of polymer can be peeled off one of the glass pieces. Prior to peel testing, a 40 mm wide strip of polymer was separated from the adjacent polymer by cutting two channels using a sharp knife. Care was taken to make sure the channels were deep enough to fully cut through the polymer and detach it from adjacent material.

A peel configuration of 90 degrees was used and run with an extension rate of 0.18 mm/s at 23° C. and 50% RH. An MTS Criterion M45 universal testing machine, with a 1 kN load cell operating in displacement control mode was used for the measurements. The force-displacement characteristic were recorded at a frequency of 1 Hz. Five samples were tested for each adhesion treatment and the peel force was recorded as a function of extension.

FIG. 20 shows a typical peel measurement. With uniform adhesion control methods, a steady-state peel force is attained after an interfacial crack initiates. The peel force demonstrates small fluctuations. The energy to create unit area of interface is defined as the peel strength, y, and for the 90 degree peel geometry is given by:

$$γ = \frac{P}{w}$$

Here, P is the peel force and w is the peel arm width. Using units of Newtons and mm, this yields a peel strength in units of kJ/m². The mean peel strength has been determined by fitting a horizontal line to the steady-state peel force response.

In the case of treatments with complex microstructures, the peel force often exhibits significant fluctuations associated with debonding and separation of the different treatment components from the polymer matrix and/or rigid substrate under mechanical loading. Extrema in the peel force fluctuations are a measure of the peel strengths of the various components and correspond to the energy to separate the components under loading. Even in the case of significant peel force fluctuations, the mean peel strength is still determined by fitting a horizontal line to the peel response, thence extracting the mean peel strength.

Test Methods—Ball Drop Impact Testing

A conventional impact test widely used to test the laminates in the safety glazing industry is the five-pound (2.27-kg) steel ball drop test. This test is defined in American National Standard Z26.1-1983 Section 5.26 Penetration Resistance, Test 26. The purpose of this test is to determine whether the glazing material has satisfactory penetration resistance. For automotive windshields, a minimum performance level is set at eight out of ten samples passing a twelve foot (3.66-m) ball drop without the ball penetrating the sample within 5 seconds of the impact. The test method calls for controlling laminate temperature between 77 to 104° F. (25 to 40° C.). The laminates (separated to provide air circulation) were placed in a controlled temperature oven, a minimum of 2 hours prior to impact to equilibrate to 23 C+/−2 C. Rather than dropping the five-pound ball (2.27-kg) from 12 feet (3.66-m), a variety of drop heights ranging from 2.44-m to 6.71-m were used to assess the “mean” support height (the height at which it is estimated that 50% of the samples would be penetrated). At each various drop impact height, the length of any tear in the laminate and interlayer was also measured and by testing multiple samples at each drop height (avg. of 3 laminates), the height necessary to create a tear of 2.54-cm and 12.7-cm was also computed.

Test Methods—Haze Measurement

Laminates prepared above were then immersed into room temperature demineralized water for 1 hour followed by placing the laminates into a chamber adjusted to −20° C. for 16 hours. Laminates were then removed and allowed to warm back to room temperature (23° C.+/−2° C.) for 7 hours. The process was repeated for a total of 10 cycles and then the degree of debonding/delamination was observed by visual inspection. Image analysis was performed on the laminates to quantify the extent of the debonding if present. The laminates were thoroughly cleaned using WINDEX glass cleaner (S.C. Johnson & Son, Inc.) and lint-less cloths and were inspected to ensure that they were free of bubbles and other defects which might otherwise interfere with making valid optical measurements. The laminates were then evaluated by means of a Haze-gard Plus hazemeter (Byk-Gardner) to obtain a measurement of percent haze. The measurement of haze followed the practice outlined in American National Standard (ANSI Z26.1-1966) “Safety Code for Safety Glazing Materials for Glazing Motor Vehicles Operating on Land Highways”. Test section 5.17 and 5.18 along with FIGS. 5 and 6 in such standard detail the appropriate method and instrumental setup to measure the haze level of a glazing material. The Haze-gard Plus hazemeter meets the proper criteria for this standard was used in all forthcoming measurements. Haze standards which are traceable to the National Bureau of Standards (now NIST) were used to ensure that the instrument was well-calibrated and operating properly.

Test Methods—Peel Strength Measurement

To allow for measurement of peel strength, some samples were prepared as above with the following exceptions.

Annealed glass was scribed, cut into 100 mm×300 mm rectangular-shaped pieces and then washed per the procedure described earlier. Thin polyester tape (25 um thickness×25 mm width) with silicone adhesive was applied to the glass surface on the ‘side-of-interest’ (air or tinside) in two parallel strips providing a uniform 25 mm wide bonding area in between. This procedure allows for the creation of a very well-defined bonding area without the need to cut through the polymer layer to create a peel strip as is conventionally performed in standard peel strength methodologies. Over top of the interlayer specimen, a thin 4-mil sheet of FEP film was placed over the plastic sheeting prior to placing the second piece of glass on top to provide a relatively flat surface for the lamination step and to act as a release layer for removal of the top piece of glass. All lamination steps were then carried out as stated above. Afterwards, 90 degree angle peel strength measurements were made on a variety of samples produced by the process above via a mechanical testing device (INSTRON® Model 1122, Instron Industrial Products, Norwood, MA USA). The peels were conducted at a crosshead speed of 1-cm/min. rate under standard laboratory conditions (nominal 23° C. and 50% RH. The data was collected via the computer software (INSTRON Bluehill III software, Instron Industrial Products, Norwood, MA USA) and an average force level was computed for each of the treated regions of the peel strip.

Examples of the Invention—Cohesive—Continuous Treatments

Continuous adhesion treatments were then characterized by the peel strength test described above and also by impact with a 2.27-kg steel ball. Impact testing for the specific combinations of glass/polymer orientations and with various cohesive—continuous treatments. Table 4.2 lists the samples made with cohesive treatments. EX1-01 through EX1-30 are all examples utilizing ionomer interlayer (IO-1) and examples EX1-31 through EX1-42 contain plasticized PVB interlayer. Examples EX1-01 through EX-05 are control samples with a glass orientation whereby the interlayer is bonded to the air-side of each of the glass lites. This is denoted as a ‘TAAT’ orientation. Examples EX1-05 through EX1-08 are similar samples but bonded to the tin-side of each of the glass lites (denoted as ‘ATTA’ glass orientation). The adhesion level assigned to each of the laminated glass groupings was based on the data derived from a peel measurement from a surrogate sample possessing the same treatment condition as had been applied to the interlayer contained within the ball-drop laminates and with the interlayer being bonded to the respective side of the glass (air-side or tin-side). The ionomer interlayer is known to generally possess higher adhesion to the tin-side of the glass than the air-side (reference available from Kuraray “SentryGlas®” Lamination Guide”). This was found also to be the case for these measurements (air-side adhesion was 1.97 kJ/m\hat{ }2 and tin-side adhesion was 3.44 kJ/m²). Substantial tears in the interlayer resulted from impact drop heights, especially for the tin-side laminated samples: Example EX1-03 had a tear length of 7.6-cm and EX1-08 had a tear length of 26.5-cm, both impacted from a drop height of 4.88-m.

Examples EX1-09 through EX1-13 were constructed from an ionomer interlayer which had been dip-coated into a solution of PVA in demineralized water at a concentration of 0.5 wt. %. Notably, none of these samples formed any tears due to the ball impact test, at any of the drop heights tested. Drop height level was increased beyond the previous sample sequences to 6.10-m (EX1-13). Surprisingly, even at this much higher impact energy level, no tear was observed in the impacted laminate. Another performance aspect that was measured for each ball drop sample was the quantity of glass loss that resulted from the impact event. Glass loss beyond a certain level could jeopardize the safety and integrity aspects of the glass laminate. The series of samples, EX01-09 through EX01-13, despite of having zero interlayer tear after impact, the glass loss was much higher than in any of the control series of laminates (EX1-01 through EX1-08). The next series of samples (EX1-14 through EX1-18) were prepared in a similar way as the previous (EX1-09 through EX1-13) but a silane compound was incorporated also in the PVA/water solution (PVA at 0.5 wt. % and silane at 0.2 wt. %). As with the PVA/water only set, no interlayer tearing was found to occur, even at the higher energy drop height of 6.10-m (EX1-18), but also the glass loss (82.94-gms. compared with EX1-13 at a glass loss of 1304.76-gms.) was reduced to a level considered to be safe and the glass laminates across this series still had good integrity and durability performance. Examples EX1-19 through EX1-30 were prepared using a PVA/water solution concentration of 0.05%. EX1-19 through EX1-24 were made using ATTA glass orientation and EX1-25 through EX1-30 were made using TAAT glass orientation. The adhesion level was found to be higher than the series prepared at 0.5 wt. % PVA concentration. No tears were found in this series, even at the higher impact drop heights, however glass loss was much higher than the PVA/silane sample set. Surprisingly, the adhesion level found between the air-side (0.159-kJ/m²) and the tin-side (0.157-kJ/m²) was nominally ‘the same’, and well-within experimental error. This is a surprising finding, since the conventional ionomer interlayer would have significantly higher adhesion to the tin-side. This behavior is highly advantageous, since the inventive art overcomes the typical factors that create variability that is inherent in conventional glass lamination processes. Many of these factors are well-known, such as, different glass compositions, variety of glass washing techniques, moisture variations in the interlayer, different processing and lamination conditions (e.g. autoclave temperature and cycle time), etc. The cohesive treatment has provided a means to supply a composite interlayer whereby the adhesion (as measured by the peel test) is controlled ‘within’ the composite structure and can be designed to be less sensitive or nearly insensitive to the substrate to which it is bonded. It was found that substantial transfer of the PVA or PVA/silane treatment layer (either in a continuous treatment manner or one with discreteness present) was transferred to the glass interfacial surface through the course of a debonding event. A debonding event can be either through a measurement of peel strength within a peel test framework or through an impact event whereby some portion of energy is transferred from the striking force into the debonding between the polymer interlayer (API and any included treatments) and the glass or rigid substrate. Specifically, measurements of the thickness of any transference of a treatment layer onto the glass surface was performed by an atomic force microscope (AFM). These measurements were performed using a Nanosurf Core AFM model equipped with a Dyn190AI-10 cantilever and running in phase contrast mode. Various locations on each peel test sample were surveyed and it was found that significant portions of the PVA or PVA/silane treatment layer or discrete region was found to be adhered to the glass surface. Comparison between the treatment layer thickness as applied to the API substrate to the thickness of what was detected as being transferred to the glass was quite similar and consistent. This suggests that in these cases, the debonding zone was reasonably in line with being cohesive but primary at or near the interface between the treatment layer and the underlying API. The measured thickness of the PVA treatment deposit as transferred to the glass represented for Examples 9 through 13 which had been prepared from dip coating a 0.5% (w/w) PVA/water solution was found to be in the range of 1.3 to 2.7 microns. The measured thickness represented for Examples 19-30 by AFM was in the range of 0.63 to 0.41 microns having been prepared from dip coating into a 0.05% (w/w) PVA/water solution. The measured thickness for the PVA treatment deposit as transferred from a dip coated sample into a 0.005% (w/w) PVA/water solution was found to be in the range of 12 to 89 nanometers. Impact samples from the latter solution were not prepared, but the peel strength was found to be modulated to a lower value between about 28 to 72% of that found in with the control ionomer sample without said treatment.

Examples EX1-31 through EX1-42 were prepared from commercial plasticized PVB sheeting (Trosifol® brand from Kuraray). All laminated glass samples were prepared using TAAT glass orientation. Samples EX1-31 through EX1-34 were controls with drop heights ranging from 1.83-m through 3.66-m. Samples EX1-35 through EX1-38 utilized the same PVB sheeting but were first dipped into a PVA/water solution at 0.5 wt. % PVA concentration. Samples EX1-39 through EX1-42 were prepared by treated by dipping into a PVA/silane/water solution at 0.5 wt. % PVA concentration and 0.2 wt. % of silane. Comparison of sample EX1-34 with EX1-37 and EX1-40 all impacted from a drop height of 3.66-m resulted in tear lengths of 4.3-cm, 0.0-cm, and 0.4-cm respectively. It is obvious that the samples with the PVA or PVA/silane treatment show less interlayer tear length. This is also supported by samples EX1-38 and EX1-42 where greater drop heights were utilized (4.88-m) and which yielded tear lengths of 1.2-cm and 4.3-cm respectively. Glass loss for the PVA and PVA/silane treated PVB interlayer samples were all found to be reasonably low and quite similar in magnitude as found for the control group.

A superior interlayer composite structure where the API is treated such that more robust adhesiveness to the substrate is created in a more dependable fashion so that a targeted adhesive level is created over the conventional art. The debonding occurs within a desired range for the underlying API to dissipate energy in a favorable manner when the composite structure is impacted and the like.

The adhesive properties of conventional interlayers, such as PVB, are highly influenced by the presence of moisture. Without being held to theory, it has been reported that the adhesiveness is largely provided by hydrogen-bonding between the hydroxyl groups within the polymer chains of the PVB interlayer and the silanol groups on the glass surface (as one example of a composite structure type). The presence of water reduces the adhesiveness by effectively competing with the interaction of the hydroxy groups of the PVB and the silanol groups on the glass surface. The present invention seeks to provide a more robust interfacial bonding mechanism than that obtained through the conventional means. This approach provides a reliable means for adjusting the debonding energy between the substrate and API for optimizing the total energy absorbing capability of the composite laminate structure.

TABLE 4.2

| | | | Drop | | Tear | |
|---|---|---|---|---|---|---|
| Example | Glass | Interlayer | Height | Glass | Length | Adhesion |
| No. | Orientation | ID | (m) | Loss (g) | (cm) | (kJ/m²) |
| EX1-01 | TAAT | IO-1 | 2.44 | 5.9 | 0.0 | 1.46 |
| EX1-02 | TAAT | IO-1 | 3.66 | 43.8 | 3.8 | 1.46 |
| EX1-03 | TAAT | IO-1 | 4.88 | 80.2 | 7.6 | 1.46 |
| EX1-04 | TAAT | IO-1 | 6.10 | 105.7 | 25.4 | 1.46 |
| EX1-05 | ATTA | IO-1 | 3.05 | 12.8 | 0.0 | 2.94 |
| EX1-06 | ATTA | IO-1 | 3.66 | 16.3 | 5.2 | 2.94 |
| EX1-07 | ATTA | IO-1 | 4.27 | 58.5 | 22.3 | 2.94 |
| EX1-08 | ATTA | IO-1 | 4.88 | 59.5 | 26.5 | 2.94 |
| EX1-09 | TAAT | 1O-1 w/0.5% PVA | 1.83 | 802.9 | 0.0 | 0.29 |
| EX1-10 | TAAT | 1O-1 w/0.5% PVA | 2.44 | 913.0 | 0.0 | 0.29 |
| EX1-11 | TAAT | 1O-1 w/0.5% PVA | 3.66 | 1055.2 | 0.0 | 0.29 |
| EX1-12 | TAAT | 1O-1 w/0.5% PVA | 4.88 | 1219.8 | 0.0 | 0.29 |
| EX1-13 | TAAT | 1O-1 w/0.5% PVA | 6.10 | 1304.76 | 0.0 | 0.29 |
| EX1-14 | TAAT | 1O-1 w/0.5% PVA/Silane | 1.83 | 9.9 | 0.0 | 0.94 |
| EX1-15 | TAAT | 1O-1 w/0.5% PVA/Silane | 2.44 | 62.6 | 0.0 | 0.94 |
| EX1-16 | TAAT | 1O-1 w/0.5% PVA/Silane | 3.66 | 205.9 | 0.0 | 0.94 |
| EX1-17 | TAAT | 1O-1 w/0.5% PVA/Silane | 4.88 | 103.1 | 0.0 | 0.94 |
| EX1-18 | TAAT | 1O-1 w/0.5% PVA/Silane | 6.10 | 82.94 | 0.0 | 0.94 |
| EX1-19 | ATTA | 1O-1 w/0.05% PVA | 1.22 | 2.63 | 0.0 | 0.16 |
| EX1-20 | ATTA | 1O-1 w/0.05% PVA | 1.83 | 210.85 | 0.0 | 0.16 |
| EX1-21 | ATTA | 1O-1 w/0.05% PVA | 2.44 | 109.6 | 0.0 | 0.16 |
| EX1-22 | ATTA | 1O-1 w/0.05% PVA | 3.66 | 1154.4 | 0.0 | 0.16 |
| EX1-23 | ATTA | 1O-1 w/0.05% PVA | 4.88 | 1316.6 | 0.0 | 0.16 |
| EX1-24 | ATTA | 1O-1 w/0.05% PVA | 6.10 | 1237.36 | 0.0 | 0.16 |
| EX1-25 | TAAT | 1O-1 w/0.05% PVA | 1.22 | 273.23 | 0.0 | 0.16 |
| EX1-26 | TAAT | 1O-1 w/0.05% PVA | 1.83 | 605.09 | 0.0 | 0.16 |
| EX1-27 | TAAT | 1O-1 w/0.05% PVA | 2.44 | 137.32 | 0.0 | 0.16 |
| EX1-28 | TAAT | 1O-1 w/0.05% PVA | 3.66 | 243.95 | 0.0 | 0.16 |
| EX1-29 | TAAT | 1O-1 w/0.05% PVA | 4.88 | 367.28 | 0.0 | 0.16 |
| EX1-30 | TAAT | 1O-1 w/0.05% PVA | 6.10 | 684.88 | 0.0 | 0.16 |
| EX1-31 | TAAT | PVB control | 1.83 | 2.14 | 0.0 | 4.99 |
| EX1-32 | TAAT | PVB control | 2.44 | 11.20 | 0.6 | 4.99 |
| EX1-33 | TAAT | PVB control | 3.05 | 8.66 | 0.3 | 4.99 |
| EX1-34 | TAAT | PVB control | 3.66 | 17.21 | 4.3 | 4.99 |
| EX1-35 | TAAT | PVB w/0.5% PVA | 1.83 | 4.84 | 0.0 | 0.87 |
| EX1-36 | TAAT | PVB w/0.5% PVA | 2.44 | 4.84 | 0.0 | 0.87 |
| EX1-37 | TAAT | PVB w/0.5% PVA | 3.66 | 22.55 | 0.0 | 0.87 |
| EX1-38 | TAAT | PVB w/0.5% PVA | 4.88 | 20.87 | 1.2 | 0.87 |
| EX1-39 | TAAT | PVB w/0.5% PVA/Silane | 2.44 | 6.56 | 0.0 | 1.46 |
| EX1-40 | TAAT | PVB w/0.5% PVA/Silane | 3.66 | 8.81 | 0.4 | 1.46 |
| EX1-41 | TAAT | PVB w/0.5% PVA/Silane | 4.27 | 18.35 | 4.3 | 1.46 |
| EX1-42 | TAAT | PVB w/0.5% PVA/Silane | 4.88 | 19.94 | 4.3 | 1.46 |

### EXAMPLES

Functional silanes are used in the examples below, but titanates and zirconates may also be used individually or in combinations to achieve the desired adhesive effect.

Example MB-1: A masterbatch is created by taking PVB resin containing about 40 to 48 wt % hydroxyl (MW 50,000) is imbibed with a combination of (3-Glycidoxypropyl)triethoxysilane at 0.05 weight % and 0.10% (3-Glycidoxypropyl)methyldiethoxysilane by tumbling combined together on a roller mill in a closed container for 4 hours. The contents are then compounded together in a twin-screw extruder at a melt temperature of 240° C. The extruded masterbatch product is then strand-cut and dried

Example SOL-2: A phyllosilicate with platelet size below 1 um is exfoliated using an ultrasonic probe at high intensity in a surfactant laden solution with water for 4 hours (5% wt. loading silicate/water). To this mixture is added a long-chain alkylalkoxysilane (c.f. dodecyltriethoxysilane, Gelest Product #SID4632.0) at 0.1% w/w and is stirred for 4 hours at 70° C. The resulting product is filtered using a 0.25 μm filter medium and the filtrate is re-slurried three times with 90:10 v/v water/methanol to remove surfactant and excess unreacted silane/byproducts. The product is dried under nitrogen in a vacuum oven for 24 hours at 60° C. A solution is created by taking the treated silica resin and suspending into 2-propanol solvent at 0.4% w/w loading with intense mixing (dispersion blade mixer at 4000 rpm) at a 0.05% loading. After mixing, this solution is then slot-die coated (10-μm wet-film thickness) onto both sides in a sequential operation of a moving-web of PVB interlayer sheeting (c.f. Trosifol® Type B550J—nominal thickness 0.76-mm). The moving web is then passed through a drier to remove the excess 2-propanol solvent.

Example S-1: A solution of MB-1 is made by dissolving 0.1 weight % into 2-propanol is slot-die coated (10-um wet-film thickness) onto both sides in a sequential operation of a moving-web of PVB interlayer sheeting (c.f. Trosifol® Type B550J—nominal thickness 0.76-mm). The moving web is then passed through a drier to remove the excess 2-propanol solvent. Thus, during these two coating operations, the MB-1 material is transferred onto the outer-surface of the PVB sheeting as an overlay over the SOL-2 material previously applied. These same steps are repeated such that both sides of the sheeting are so modified with the adhesion treatment.

TABLE 5.1

| | | Mean Peel Strength, | | |
|---|---|---|---|---|
| | | γ [kJ/m²] | | |
| | | Sheet Moisture Level (wt. %) | | |
| Example | | 0.15 | 0.45 | 0.80 |
| C1 | Trosifol ® Type B550J | 8 | 5 | 2 |
| S-1 | Composite coated surface | 6 | 5 | 4 |

Traditional PVB sheeting is highly influenced by the level of moisture within the interlayer. A moderate adhesion level is generally the targeted goal to achieve a balance of durability/weathering (delamination resistance) and impact performance. Although, an optimum adhesion level is obtained at an intermediate moisture level (0.45%), the adhesion under dry conditions (0.15%) is very high and drops to a very low adhesion level at high moisture (0.8%). In the case for the sheeting that is treated with both solutions to form Example S-1, one can see the advantageous robustness of the debonding energy against moisture level. The impact performance of this treated API is improved over the conventional art as it exhibits less sensitivity to moisture. Primary debonding is found within the layer of SOL-2 being deposited from the coating solution.

Having now fully described this invention, it will be appreciated by those skilled in the art that the same can be performed within a wide range of equivalent parameters, concentrations, and conditions without departing from the spirit and scope of the invention and without undue experimentation.

1: A composite adhesive polymeric interlayer (CAPI) comprising:
(I) a first stack comprising a first top adhesive polymeric interlayer (TAPI) and a bulk adhesive polymeric interlayer (BAPI) adhered to each other; or
(II) a second stack comprising a first a submicron-thick superbonding layer and a BAPI adhered to each other; or
(III) a third stack comprising a first submicron-thick superbonding layer, a first TAPI layer, and a BAPI; wherein the first submicron-thick superbonding layer adheres to the first TAPI layer on one side; the first TAPI layer adheres to the first superbonding layer on one side and the BAPI layer on the other side;
wherein each of the CAPI, the TAPI, the BAPI and the sub-micron superbonding layer comprise a first surface and a second surface;
wherein the TAPI comprises a first polymeric material and the BAPI comprises a second polymeric material;
wherein the TAPI and/or the BAPI comprise discrete and/or continuous debonding zones;
wherein, the first submicron-thick superbonding layer substantially covers the respective TAPI or the BAPI surface;
wherein the cohesive debonding zones comprise a first debonding zone that is discrete or continuous and having a maximum mean peel strength;
wherein the cohesive debonding zones comprise a second cohesive debonding zone that is discrete or continuous with a minimum mean peel strength greater than about 0.01 kJ/m²; and
wherein the maximum mean peel strength is at least about 2 times greater than the minimum mean peel strength.

2: The CAPI as recited in claim 1, wherein:
the debonding zones are located within 10% thickness of the CAPI from the first and/or the second surface of the CAPI, and
the first debonding zone and the second debonding zone are within the 10% thickness of the API proximate to the first surface.

3: The CAPI as recited in claim 1, wherein one of the first or second debonding zones comprises the first polymeric material or the second polymeric material, and the other of the first and second debonding zones comprises a first material chemically and/or physically different from the first polymeric material and/or the second polymeric material.

4: The CAPI as recited in claim 3, wherein the first material is characterized by:
(i) a molecular weight different than that of the first polymeric material and/or the second polymeric material,
(ii) a crystallinity different than that of the first polymeric material and/or the second polymeric material,
(iii) a density different than that of the first polymeric material and/or the second polymeric material,
(iv) a glass transition temperature different than that of the first polymeric material and/or the second polymeric material,
(v) a melt flow index different than that of the first polymeric material and/or the second polymeric material,
(vi) a Young's modulus different than that of the first polymeric material and/or the second polymeric material, or
(vii) a combination of one or more of said characteristics.

5: The CAPI as recited in claim 1, wherein at least one of the first debonding zone and the second debonding zone is coplanar to the CAPI, the TAPI, or the BAPI.

6: The CAPI as recited in claim 1, wherein the first debonding zone and the second debonding zone are discrete, and are located in one plane or in more than one plane.

7: The CAPI as recited in claim 1, wherein the cohesive discrete debonding zones are distributed in an ordered pattern.

8: The CAPI as recited in claim 1, wherein the cohesive discrete debonding zones are distributed stochastically.

9: The CAPI as recited in claim 1, wherein at least one of the first debonding zone or the second debonding zone is characterized by:
(i) a regular shape,
(ii) a stochastic/random shape,
(iii) one-dimensional patterns, and/or
(iv) a cluster of regular, random, and/or one-dimensional patterns.

10: The CAPI as recited in claim 9, wherein the effective diameter of the regular shaped discrete debonding zone, the random shaped discrete debonding zone, or the cluster discrete zone is from about 1 multiple to about 150,000,000-multiples of the thickness of the discrete debonding zone.

11: The CAPI as recited in claim 1, wherein the weight content of one of said first and second debonding zones as a percentage of the total of the API is in the range of from about 0.00001% to about 30%.

12: The CAPI as recited in claim 1, wherein the first debonding zone with maximum mean peel strength has a mean peel strength that is from about 2 times to about 250 times greater than a mean peel strength of the second debonding zone with minimum mean peel strength.

13: The CAPI as recited in claim 1, wherein the API comprises at least two zones, wherein at least one of the zones has a mean peel strength of from about 0.01 to about 12.0 kJ/m².

14: The CAPI as recited in claim 1, wherein the first polymeric material or the second polymeric material comprises a polyvinylacetal, an ionomer, a thermoplastic elastomer, an ethyl vinylacetate, or combinations thereof.

15: The CAPI as recited in claim 1, wherein the first material comprises a polyvinylacetal, an ionomer, a thermoplastic elastomer, a silane, an ethyl vinylacetate, a fluoropolymer, a polyvinyl-alcohol, or combinations thereof.

16: The CAPI as recited in claim 13, wherein at least one of the cohesive debonding zones comprises the ionomer, wherein the ionomer resin is a sodium-neutralized ethylene-α,β-unsaturated carboxylic acid copolymer.

17: The CAPI as recited in claim 13, wherein the polyvinylacetal is a polyvinylbutyral.

18: The CAPI as recited in claim 14, wherein the second debonding zone is the first polymeric material or the second polymeric material, and the first polymeric material or the second polymeric material is an ionomer resin.

19: The CAPI as recited in claim 14, wherein the first debonding zone is the first polymeric material or the second polymeric material, and the first polymeric material or the second polymeric material is a polyvinylacetal.

20: The CAPI as recited in claim 18, wherein the first material is an adhesion modifying agent.

21-38. (canceled)
